(19) United States
(12) Patent Application Publication
(10) Pub. No.: US 2012/0020343 A1
(43) Pub. Date: Jan. 26, 2012

(54) GATEWAY CONNECTION METHOD, GATEWAY CONNECTION CONTROL SYSTEM, AND USER EQUIPMENT

(75) Inventors: Ryuji Sugizaki, Tokyo (JP); Shinkichi Ikeda, Kanagawa (JP); Keigo Aso, Kanagawa (JP); Genadi Velev, Darmstadt (DE); Jens Bachmann, Oberursel (DE)

(73) Assignee: PANASONIC CORPORATION, Osaka (JP)

(21) Appl. No.: 13/201,042

(22) PCT Filed: Jan. 29, 2010
(86) PCT No.: PCT/JP2010/000551

§ 371 Date: Oct. 10, 2011

(30) Foreign Application Priority Data
Feb. 13, 2009 (JP) 2009-031883
Mar. 13, 2009 (JP) 2009-061990
Aug. 24, 2009 (JP) 2009-193595

(51) Int. Cl. H04W 40/00; H04W 12/06

(52) U.S. Cl. 370/338

(57) ABSTRACT

Disclosed is a technique in which when mobile terminal having multiple communication interfaces attaches to an access network, the mobile terminal can connect to a desired PGW quickly in a short time even if a PGW different from the desired PGW is allocated. According to the technique, when a mobile terminal (UE) 1 performs bootstrapping (BS) processing on an access network (N3G access (3)), the address of another communication interface (home prefix) already connected to the desired PGW (T-PGW′5b) is notified to a connection destination PGW (I-PGW 5a). If the I-PGW does not manage the address, processing is so performed that BS processing will be started from the T-PGW managing the address to the mobile terminal. Further, if the mobile terminal is connected to an I-PGW undesired on the N3G access, a request is made for reuse of a key exchanged with the I-PGW upon switching the connection from the I-PGW to the desired T-PGW.

### TECHNICAL FIELD

The present invention relates to a gateway connection method, a gateway connection control system, and a mobile terminal, in which when a communication node performing communication using IP (Internet Protocol) connects to a PGW (PDN Gateway), its access point is controlled. Particularly, it relates to a gateway connection control system, and a mobile terminal, which are applied when a mobile terminal (user equipment: hereinafter abbreviated as UE) in mobile IPv6 (Mobility support for IPv6, which is abbreviated as MIPv6 below) is connected to a PGW managing information on the UE in an environment where multiple communication interfaces (hereinafter abbreviated as IFs) are maintained.

### BACKGROUND ART

Conventionally, MIPv6 has been known as a technique for ensuring migration transparency of UE in an IP network (for example, see Non-Patent Document 3 or Non-Patent Document 4 cited below). FIG. 1 shows an example of the structure of a communication network using MIPv6. In FIG. 1, this system includes UE 1 (also called a mobile node (MN) in MIPv6), a PGW 5 (also called home agent (HA) in MIPv6 terminology and corresponding to I-PGW 5a or T-PGW 5b to be described later) for managing position information (also called care-of address (CoA)) on the UE 1, an AAA (Authentication, authorization and Accounting) server 8a as a UE authentication server for determining whether to give permission for the UE 1 to use each access network, a HSS (Home Subscriber Server) 8b as a user information data server, and a DNS (Domain Name System) server 9 for holding a pair of the URI (Universal Resource Identifier) of the PGW 5 and an IP address.

The AAA server 8a and the HSS 8b may be physically or logically implemented on the same machine, and the AAA server 8a and the HSS 8b may be collectively called an AAA/HSS 8 below for the sake of convenience. Further, in FIG. 1, the DNS server 9 can be accessed from a core network 4 or each access network (3GPP access network 2 or Non-3GPP access network 3 to be described later) though the mode of connection to the DNS server 9 is unspecified.

In FIG. 1, the UE 1 notifies the PGW 5 of a home address (hereinafter abbreviated as HoA) valid on a home link and a CoA acquired in a destination network as a foreign link using a binding update (hereinafter abbreviated as BU) message. The PGW 5 registers and holds, in a binding cache (abbreviated as BC), a correspondence between both notified addresses (HoA, CoA) to intercept packets addressed to the HoA of the UE 1 so that it can forward the packets to the CoA of the corresponding UE 1. The UE 1 notifies the PGW 5 of the CoA using a BU message periodically or when the CoA is changed. This enables the UE 1 to always receive packets addressed to the HoA of the UE 1 regardless of whether within or outside of the home link.

Non-Patent Document 1 cited below discloses a method for allocation of a PGW 5 in the standardization project for mobile communication systems (3rd Generation Partnership Project, abbreviated as 3GPP below). According to the technique disclosed in Non-Patent Document 1, for example in FIG. 1, when attaching to a new access network, the UE 1 acquires the IP address of a PGW 5 managing position information of the UE 1 in the new access network from the DNS server 9 based on an URI indicative of the PGW 5 accommodating the UE 1.

At this time, it may be possible that there exists a PGW 5 with which the UE 1 has already connected through the same or a different communication interface (i.e., a PGW 5 holding a binding cache entry of the UE 1). However, despite such a condition, a PGW 5 different from the PGW 5 with which the UE 1 has already connected may be presented by the DNS server 9. In such a case, for example, the advantages expected when the UE 1 uses multiple CoAs may not be achieved in various aspects such as to make it difficult to synchronize data received through different communication interfaces.

As a method to solve such a problem, Non-Patent Document 1 discloses a method for reallocation of the PGW 5 (a PDN GW reallocation procedure). In the PDN GW reallocation procedure disclosed in Non-Patent Document 1, though the UE 1 once starts a connection to a different PGW 5 presented by the DNS server 9, the address of the PGW 5 already connected is notified from the network side to the UE 1 based on information provided by the AAA/HSS 8 during the connection processing, so that the UE 1 can reconnect to the notified PGW 5 (the PGW 5 already connected).

In this specification, when the UE 1 attaches to a new access network, the PGW 5 presented by the destination access network is called an I-PGW (Initial PGW) 5a while the PGW 5 already connected through another access network before the UE 1 attaches to the new access network is called a T-PGW (target PGW) 5b to distinguish therebetween. The T-PGW 5b is the PGW 5 to which the UE 1 originally wants to connect upon attachment to the new access network. Even when attaching to the new access network, since the UE 1 has the T-PGW 5b as its access point, it has the advantage of being able to enjoy the benefits of using multiple CoAs for communication.

The use of the PDN GW reallocation procedure disclosed in Non-Patent Document 1 allows the AAA/HSS 8 to allocate the T-PGW 5a even when it is different from the PGW 5 presented by the destination access network, enabling the UE 1 to unify PGWs 5 irrespective of the destination access network.

The PDN GW reallocation procedure disclosed in Non-Patent Document 1 uses a bootstrapping (hereinafter abbreviated as BS) procedure for establishing security association (hereinafter abbreviated as SA) to protect packet communication between the UE 1 and the PGW 5. For example, the BS procedure is described in Non-Patent Document 2 cited below. The detailed operation will be described with reference to FIG. 12.

FIG. 12 is a sequence diagram for describing the BS procedure in the prior art. FIG. 12 shows an example of the BS procedure in the system structure shown in FIG. 1. In FIG. 12, the UE 1 cooperates with a PGW 5 presented by the DNS server 9 to perform the BS. In this case, an interaction occurs between the AAA server 8a that permits connection to the core network 4 and the HSS 8b managing identification information (hereinafter called PGW Identity) on the PGW 5 accommodating the UE 1 if any or the access point name (hereinafter abbreviated as APN).

First, the UE 1 performs a PGW discovery procedure to acquire the address of the PGW 5 (corresponding to the I-PGW 5a in FIG. 1) (step S9001). In this case, if the UE 1 holds the APN of a PDN (Packet Domain Network, which is not shown in FIG. 12) the connection of which has been established through the PGW 5 (corresponding to the T-PGW 5b in FIG. 1, which is not shown in FIG. 12) already connected, the UE 1 makes an inquire to the DNS server 9 about the address of the PGW 5 (T-PGW 5b). Specifically, the UE 1 includes the APN of the T-PGW 5b held by itself in a query message, and sends the query message to the DNS server 9. The DNS server 9 searches for the PGW 5 based on the APN sent from the UE 1 and notifies the UE 1 of the PGW 5, but depending on the network conditions (for various reasons such as the loading conditions, the operator's settings, or the fact that a DNS database does not have dynamic information based on the current state of the UE 1), the address of a different PGW 5 (I-PGW 5a) may be returned to the UE 1 instead of the address of the T-PGW 5b desired by the UE 1.

The UE 1 starts establishing SA with the address of the PGW 5 (corresponding to the I-PGW 5a here) received from the DNS server 9 (initiation of IKE_SA_INIT sequence, step S9002). Through the IKE_SA_INIT sequence, IKE SA (IKE Security Association) including a shared key used in subsequent BS processing between the UE 1 and the PGW 5 is generated. Next, the UE 1 uses the generated IKE SA to send the PGW 5 a protected IKE_AUTH Request message (step S9003). The IKE_AUTH Request message includes the identifier of the UE 1 (e.g., NAI: Network Access Identifier) and the like. Based on the parameters in the acquired IKE_AUTH Request message, the PGW 5 generates an authentication request message (Authentication-Request/Identity) for the UE 1 and sends it to the AAA server 8a (step S9004).

Based on a user profile, authentication vector (AV), and the like acquired from the HSS 8b, the AAA server 8a authenticates the UE 1 (step S9005), determines whether the UE 1 is to be permitted to connect to the core network 4 through the PGW 5, and notifies the PGW 5 of the result using an EAP-Request/AKA-Challenge message (step S9006). If it is determined that the UE 1 is attachable to the network, the EAP-Request/AKA-Challenge message sent in step S9006 will include challenge information necessary to establish SA used from then on between the PGW 5 and the UE 1. The PGW 5 sends the UE 1 an IKE_AUTH Response message including the EAP-Request/AKA-Challenge message acquired from the AAA server 8a (step S9007). Subsequently, response information corresponding to the challenge information is sent from the UE 1 to the AAA server 8a (steps S9008 and S9009), and a master key (MSK, which is also called a key or key information) necessary to establish SA or its keying material is distributed to the PGW 5 (steps S9010 and S9011). Using this MSK, SA between the UE 1 and the PGW 5 is established (steps S9012 to S9014). Then, using the established SA, BU/BA (Binding Acknowledgement) exchange between the UE 1 and the PGW 5 is protected from then on (steps S9015 to S9017).

In the operation shown in FIG. 12, the HSS 8b can notify the PGW 5 (I-PGW 5a), on which the UE 1 starts performing the BS in step S9006, of a different PGW 5 (corresponding to the T-PGW 5b) via the AAA server 8a. At this time, the PGW 5 (T-PGW 5b) completes the subsequent BS processing with the UE 1 (to step S9014), and then notifies the UE 1 of the address of the PGW 5 (corresponding to the T-PGW 5b), which is notified from the HSS 8b, during binding processing performed with the UE 1 (specifically through a BA message sent in step S9016) (step S9016). Thus, the UE 1 receiving the address of the PGW 5 (T-PGW 5b) to which the UE 1 originally wants to connect sends a BU in which the lifetime is set to 0 to break the binding to the PGW 5 (I-PGW 5a) (step S9017), and starts BS processing and binding processing (BU/BA exchange) again to connect to the PGW 5 (T-PGW 5b) notified. Specifically, the UE 1 performs processing beginning from step S9002 in FIG. 12 on the T-PGW 5b again.

### PRIOR ART DOCUMENT

### Non-Patent Document

Non-Patent Document 1: 3GPP TS 23.402 V8.4.0, December 2008.
Non-Patent Document 2: 3GPP TS 33.402 V8.2.1, December 2008.
Non-Patent Document 3: Mobility Support in IPv6, RFC3775, June 2004.
Non-Patent Document 4: Mobile IPv6 support for dual stack Hosts and Routers (DSMIPv6), draft-ietf-mext-nemo-v4traversal-06, November 2008.
Non-Patent Document 5: Proxy Mobile IPv6, RFC5213, August 2008.
Non-Patent Document 6: Mobile IPv6 Bootstrapping in Split Scenario, RFC5026, October 2007.
Non-Patent Document 7: Internet Key Exchange (IKEv2) Protocol, RFC4306, December 2005.
Non-Patent Document 8: The Extensible Authentication Protocol-Internet Key Exchange Protocol version 2 (EAP-IKEv2) Method, RFC5106, January 2008.

However, in the aforementioned prior art, it takes considerable time until the UE 1 eventually completes the connection to the PGW 5 (corresponding to the T-PGW 5b) with which the UE 1 is already connected. This is caused by the fact that the UE 1 has to perform BS processing, which requires considerable time to generate an encrypted authentication key, with a PGW 5 (corresponding to the I-PGW 5a) to which the UE 1 does not originally intend to connect.

Further, in the aforementioned prior art, it requires an enormous number of messages until the connection to the PGW 5 (corresponding to the T-PGW 5b) already connected with the UE 1 is eventually completed as well as the considerable time required. This is caused by the fact that the PGW 5 (corresponding to the I-PGW 5a), to which the UE 1 does not originally intend to connect, exchanges enormous number of messages during a period from the acquisition of the address of the PGW 5 (T-PGW 5b) originally desired by the UE 1 to connect until transmission of the address to the UE 1. This results in the waste of messages exchanged with the PGW 5 (I-PGW 5a) originally unintended, and hence placing burden on the network for the wasted messages.

### SUMMARY OF THE INVENTION

In view of the above problems, it is an object of the present invention to provide a gateway connection method, a gateway connection control system, and a mobile terminal, which enable UE to switch to a desired PGW 5 in a short time with reduced consumption of resources in a system even when a PGW 5 (I-PGW 5a) different from the PGW 5 (T-PGW 5b) already connected and originally desired to connect is allocated in an access network to be newly connected or as a handover destination.

In order to attain the above object, the gateway connection method of the present invention is a gateway connection method for connecting a mobile terminal to a desired gateway in a communication system including the mobile terminal attachable to a plurality of access networks through a plurality of communication interfaces, and a plurality of gateways accommodating the mobile terminal to perform mobility management, the method comprising:

a step of detecting by the mobile terminal, that the address of a second gateway is acquired from a DNS server when attaching to a different access network after connecting with a first gateway via a home link;

a step of making an inquiry from the mobile terminal, to the second gateway about accommodation status of the mobile terminal in response to the result of the detection step;

a step of checking by the second gateway, for the accommodation status of the mobile terminal;

a step of sending by the second gateway, a connection instruction to the first gateway when determining that the mobile terminal is not accommodated;

a step of sending by the second gateway, a waiting instruction to the mobile terminal; and

a step of starting by the first gateway, connection processing to the mobile terminal.

Thus, even if a PGW different from a PGW already connected and originally desired to connect in an access network as a new attachment or handover destination is allocated to a mobile terminal, the PGW is made to check for the accommodation status of the mobile terminal in the PGW early in the connection so that a judgment can be made as to whether it is the PGW really desired by the mobile terminal to connect early while eliminating the need to release the state of an AAA server, enabling establishment of a connection with the desired the PGW 5 in a short time.

In order to attain the above object, the gateway connection control system of the present invention is a gateway connection control system including a mobile terminal attachable to a plurality of access networks through a plurality of communication interfaces, and a plurality of gateways accommodating the mobile terminal to perform mobility management, wherein

the mobile terminal detects that the address of a second gateway is acquired from a DNS server when attaching to a different access network after connecting with a first gateway via a home link,

the mobile terminal makes an inquiry to the second gateway about accommodation status of the mobile terminal in response to the result of the detection step,

the second gateway checks for the accommodation status of the mobile terminal,

the second gateway sends a connection instruction to the first gateway when determining that the mobile terminal is not accommodated,

the second gateway sends a waiting instruction to the mobile terminal, and

the first gateway starts connection processing to the mobile terminal,

whereby the mobile terminal is connected to a desired gateway.

Thus, even if a PGW 5 different from a PGW already connected and originally desired to connect in an access network as a new attachment or handover destination is allocated to mobile terminal, the PGW is made to check for the accommodation status of the mobile terminal in the PGW early in the connection so that a judgment can be made as to whether it is the PGW really desired by the mobile terminal to connect early while eliminating the need to release the state of an AAA server, enabling establishment of a connection with the desired the PGW 5 in a short time.

In order to attain the above object, the mobile terminal of the present invention is a mobile terminal attachable to a plurality of access networks through a plurality of communication interfaces and capable of connecting to a desired gateway among a plurality of gateways when connecting to a communication system including the plurality of gateways accommodating the mobile terminal to perform mobility management, the mobile terminal comprising:

means for detecting that the address of a second gateway is acquired from a DNS server when attaching to a different access network after connecting with a first gateway via a home link;

means for making an inquiry to the detected second gateway about accommodation status of the mobile terminal;

means for receiving a waiting instruction from the second gateway when the second gateway checks for the accommodation status of the mobile terminal and it is determined that the second gateway does not accommodate the mobile terminal; and

means for performing connection processing which the first gateway has started based on a connection instruction with the mobile terminal, the connection instruction being sent from the second gateway to the first gateway when the second gateway checks for the accommodation status of the mobile terminal and it is determined that the second gateway does not accommodate the mobile terminal.

Thus, even if a PGW 5 different from a PGW already connected and originally desired to connect in an access network as a new attachment or handover destination is allocated to a mobile terminal, the PGW is made to check for the accommodation status of the mobile terminal in the PGW early in the connection so that a judgment can be made as to whether it is the PGW really desired by the mobile terminal to connect early while eliminating the need to release the state of an AAA server, enabling establishment of a connection with the desired the PGW 5 in a short time.

In order to attain the above object, the gateway connection method of the present invention is also a gateway connection method for connecting a mobile terminal to a desired gateway in a communication system including the mobile terminal attachable to a plurality of access networks through a plurality of communication interfaces, and a plurality of gateways accommodating the mobile terminal to perform mobility management, the method comprising:

a step of detecting by the mobile terminal, that the address of a second gateway is acquired from a DNS server when attaching to a different access network after connecting with a first gateway via a home link;

a step of starting by the mobile terminal, connection processing to the second gateway in response to the result of the detection step, and exchanging with the second gateway, key information created by performing mutual authentication with an authentication server;

a step of notifying by the second gateway, the mobile terminal of the address of the first gateway after completion of exchange of the key information;

a step of starting by the mobile terminal, connection processing to the first gateway;

a step of acquiring by the first gateway, from the authentication server, the key information created by the mutual authentication; and

a step of reusing by the mobile terminal, the key information created by the mutual authentication to connect to the first gateway.

Thus, even if a PGW different from a PGW already connected and originally desired to connect in an access network as a new attachment or handover destination is allocated to a mobile terminal, key information created upon connection with the PGW different from the desired PGW is reused upon connection to the desired PGW, enabling establishment of a connection with the desired the PGW in a short time.

In order to attain the above object, there is also provided a gateway connection control system including a mobile terminal attachable to a plurality of access networks through a plurality of communication interfaces, and a plurality of gateways accommodating the mobile terminal to perform mobility management, wherein

the mobile terminal detects that the address of a second gateway is acquired from a DNS server when attaching to a different access network after connecting with a first gateway via a home link,

the mobile terminal starts connection processing to the second gateway in response to the result of the detection step and exchanges, with the second gateway, key information created by performing mutual authentication with authentication server,

the second gateway notifies the mobile terminal of the address of the first gateway after completion of exchange of the key information,

the mobile terminal starts connection processing to the first gateway,

the first gateway acquires, from the authentication server, the key information created by the mutual authentication, and

the mobile terminal reuses the key information created by the mutual authentication to connect to the first gateway.

Thus, even if a PGW different from a PGW already connected and originally desired to connect in an access network as a new attachment or handover destination is allocated to a mobile terminal, key information created upon connection with the PGW different from the desired PGW is reused upon connection to the desired PGW, enabling establishment of a connection with the desired the PGW in a short time.

In order to attain the above object, the mobile terminal of the present invention is also a mobile terminal attachable to a plurality of access networks through a plurality of communication interfaces and capable of connecting to a desired gateway among a plurality of gateways when connecting a communication system including the plurality of gateways accommodating the mobile terminal to perform mobility management, the mobile terminal comprising:

means for detecting that the address of a second gateway is acquired from a DNS server when attaching to a different access network after connecting with a first gateway via a home link;

means for starting connection processing to the second gateway and exchanging, with the second gateway, key information created by performing mutual authentication with authentication server;

means for receiving the address of the first gateway from the second gateway after completion of exchange of the key information to start connection processing to the first gateway; and

means for reusing the key information created by the mutual authentication to connect to the first gateway that acquired the key information from the authentication server.

Thus, even if a PGW different from a PGW already connected and originally desired to connect in an access network as a new attachment or handover destination is allocated to a mobile terminal, key information created upon connection with the PGW different from the desired PGW is reused upon connection to the desired PGW, enabling establishment of a connection with the desired the PGW in a short time.

According to the present invention, PGWs 5 managing CoAs of a mobile terminal using multiple CoAs can be unified securely and quickly. As a result, the mobile terminal has the advantage of being able to enjoy the benefits of communication using multiple CoAs securely and quickly. Also, according to the present invention, even if a PGW different from a PGW already connected and originally desired to connect in an access network as a new attachment or handover destination is allocated to a mobile terminal, the PGW is made to check for the accommodation status of the mobile terminal in the PGW early in the connection so that a judgment can be made as to whether it is the PGW really desired by the mobile terminal to connect early while eliminating the need to release the state of an AAA server, enabling establishment of a connection with the desired the PGW in a short time. Further, according to the present invention, even if a PGW different from a PGW already connected and originally desired to connect in an access network as a new attachment or handover destination is allocated to a mobile terminal, key information created upon connection with the PGW different from the desired PGW is reused upon connection to the desired PGW, enabling establishment of a connection with the desired the PGW in a short time.

### BRIEF DESCRIPTION OF THE DRAWINGS

FIG. 1A diagram showing an example of the configuration of a communication system shared between first to fourth embodiments of the present invention and the prior art.

FIG. 2 A sequence chart for describing an example of the operation of a gateway connection method according to a first embodiment of the present invention.

FIG. 3 A diagram showing an example of the configuration of a mobile terminal (UE) according to the first to fourth embodiments of the present invention.

FIG. 4 A flowchart showing an example of a processing flow of the mobile terminal (UE) according to the first embodiment of the present invention.

FIG. 5A A diagram showing an example of the format of an IKE_AUTH Request message sent from the mobile terminal (UE) to a PGW (I-PGW) according to the first embodiment of the present invention.

FIG. 5B A diagram showing an example of the format of an IKE_AUTH Response message as a response message sent from the PGW (I-PGW) to the mobile terminal (UE) according to the first embodiment of the present invention.

FIG. 6A A diagram showing an example of a Home Prefix confirmation request message sent from the PGW (I-PGW) to an AAA server according to the first embodiment of the present invention.

FIG. 6B A diagram showing an example of a Home Prefix confirmation request return message sent from the AAA server to a PGW (T-PGW) according to the first embodiment of the present invention.

FIG. 7A A diagram showing an example of a first IKE_SA_INIT message sent from the PGW (T-PGW) to the mobile terminal (UE) according to the first embodiment of the present invention.

FIG. 7B A diagram showing an example of a second IKE_SA_INIT message sent from the mobile terminal (UE) to the PGW (T-PGW) according to the first embodiment of the present invention.

FIG. 8 A diagram showing an example of the configuration of a PGW according to the first to fourth embodiments of the present invention.

FIG. 9 A flowchart showing an example of a processing flow of the PGW according to the first embodiment of the present invention.

FIG. 10 A diagram showing an example of the AAA server according to the first to fourth embodiments of the present invention.

FIG. 11 A flowchart showing an example of a processing flow of the AAA server according to the first embodiment of the present invention.

FIG. 12 A sequence chart for describing an example of the operation of the prior art.

FIG. 13 A sequence chart for describing an example of the operation of a gateway connection method according to a second embodiment of the present invention.

FIG. 14 A first sequence chart for describing an example of the operation of a gateway connection method according to a third embodiment of the present invention.

FIG. 15 A second sequence chart for describing an example of the operation of the gateway connection method according to the third embodiment of the present invention.

FIG. 16 A flowchart showing an example of a processing flow of the mobile terminal (UE) according to the third embodiment of the present invention.

FIG. 17A A diagram showing an example of the format of an IKE_AUTH Request message sent from the mobile terminal (UE) to the PGW (T-PGW) according to the third embodiment of the present invention.

FIG. 17B A diagram showing an example of the format of an IKE_AUTH Response message sent from the PGW (T-PGW) to the mobile terminal (UE) according to the third embodiment of the present invention.

FIG. 17C A diagram showing another example of the format of the IKE_AUTH Response message sent from the PGW (T-PGW) to the mobile terminal (UE) according to the third embodiment of the present invention.

FIG. 18A A diagram showing an example of the format of an Authentication-Request message sent from the PGW (T-PGW) to the mobile terminal (UE) according to the third embodiment of the present invention.

FIG. 18B A diagram showing an example of the format of an Authentication-Answer message sent from the AAA server to the PGW (I-PGW/T-PGW) according to the third embodiment of the present invention.

FIG. 19 A diagram showing an example of the format of a BS_Identity notification message sent from the AAA server to the PGW (T-PGW) according to the third embodiment of the present invention.

FIG. 20 A first sequence chart for describing an example of the operation of a gateway connection method according to a fourth embodiment of the present invention.

FIG. 21 A second sequence chart for describing an example of the operation of the gateway connection method according to the fourth embodiment of the present invention.

FIG. 22 A flowchart showing an example of a processing flow of the mobile terminal (UE) according to the fourth embodiment of the present invention.

FIG. 23A A flowchart showing an example of a processing flow of the PGW as an I-PGW according to the fourth embodiment of the present invention.

FIG. 23B A flowchart showing an example of a processing flow of the PGW as a T-PGW according to the fourth embodiment of the present invention.

FIG. 24 A third sequence chart for describing an example of the operation of the gateway connection method according to the fourth embodiment of the present invention.

FIG. 25 A fourth sequence chart for describing an example of the operation of the gateway connection method according to the fourth embodiment of the present invention.

FIG. 26 A flowchart showing an example of a processing flow of the mobile terminal (UE) according to the fourth embodiment of the present invention.

FIG. 27 A flowchart showing an example of a processing flow of the PGW according to the fourth embodiment of the present invention.

### DESCRIPTION OF EMBODIMENTS

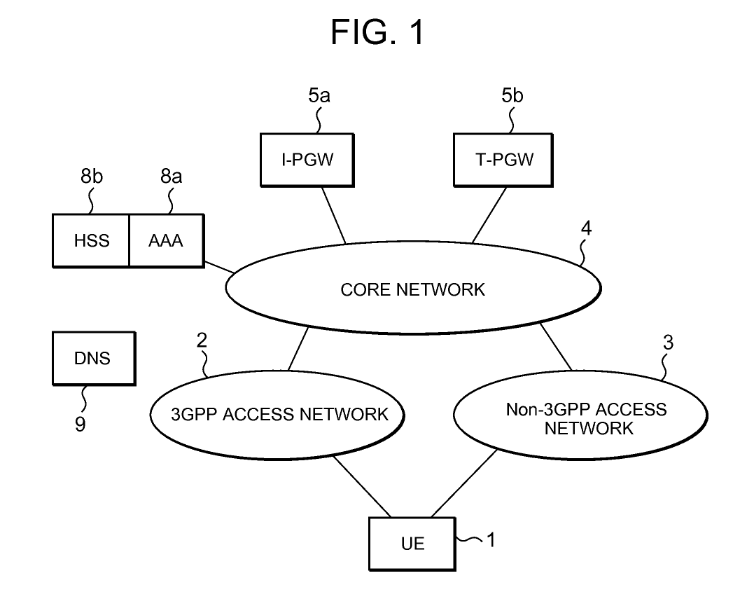

First to fourth embodiments of the present invention will now be described with reference to the accompanying drawings. Referring first to FIG. 1, a system structure common to the first to fourth embodiments of the present invention will be described. FIG. 1 is a diagram showing an example of the system structure common to the first to fourth embodiments of the present invention. The communication system shown in FIG. 1 has at least UE 1, a core network 4 to which the UE 1 is to attach, a T-PGW 5b accommodating the UE 1 and managing the home prefix or home address of the UE 1, position information (CoA), and the like, an AAA server 8a for performing access authentication on the UE 1 to the core network 4, an HSS 8b managing and storing the identifier (identity) of a T-PGW 5a, with which the UE 1 is connected, and an APN, a DNS server 9 for providing the address of a PGW 5 in response to a request from the UE 1, a 3GPP access network 2 (hereinafter also called 3G access 2), and a Non-3GPP access network 3 (hereinafter also called N3G access 3).

The UE 1 has at least two or more communication interfaces, where one communication interface can be connected to the 3G access 2 and the other can be connected to the N3G access 3. Note that the multiple communication interfaces may be connected to the 3G access 2 or the N3G access 3 at the same time. The UE 1 is attached to the core network 4 so that it can attach to either of the I-PGW 5a and the T-PGW 5b through each access network (3G access 2 or N3G access 3). The UE 1 is also connectable to the DNS server 9 through at least the N3G access 3. The UE 1 is further connectable to the DNS server 9 from the 3G access 2. In this case, however, since there can be a case where another DNS server 9 different from the DNS server 9 connectable via the N3G access 3 is provided in the 3G access 2, it is not always true that the same result can be obtained from a DNS query via the 3G access 2 and a DNS query via the N3G access 3.

Though not shown in FIG. 1, a serving GW (Serving GW) and a device unique to a 3GPP system, such as MME, SGSN, or GGSN, are provided in the 3G access 2 to support a function used by the UE 1 to connect to a PGW 5. Likewise, though not shown in FIG. 1, a communication node (such as an access router or MAG for distributing CoAs to the UE 1) is also provided in the N3G access 3 to support the function necessary for the UE 1 to connect to the PGW 5.

In the communication system having the above-mentioned structure, it is assumed that the UE 1 establishes a connection with the T-PGW 5b through the 3G access 2 and the core network 4. Here, for example, since a PMIP (see Non-Patent Document 5 cited above) is used in the connection via the 3G access 2, the UE 1 cannot know the address of the T-PGW 5b (see Non-Patent Document 1). On the other hand, the HSS 8b manages, in a database, the address of the T-PGW 5b together with the identifier of the UE 1 for the purposes of appropriate connection management of the UE 1 and state management of the networks.

### First Embodiment

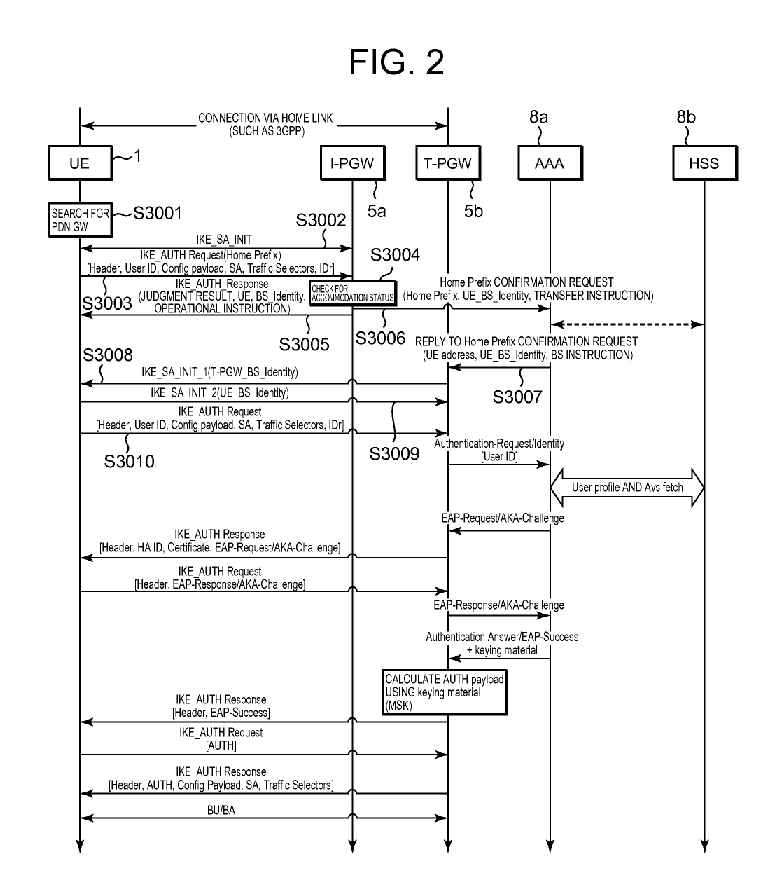

An example of the system operation according to the first embodiment of the present invention will be described with reference to FIG. 2. FIG. 2 is a sequence diagram for describing an example of the system operation according to the first embodiment of the present invention. Shown in FIG. 2 is an example of a processing sequence performed among at least the UE 1, the I-PGW 5a presented by the DNS server 9 when the UE 1 is attached to the N3G access 3, the T-PGW 5b already connected with the UE 1 via the 3G access 2, the AAA server 8a performing access authentication of the UE 1 to the core network 4, and the HSS 8b holding and managing subscription information on the UE 1 and the like.

The UE 1 is attached to the N3G access 3 to establish a new connection or perform a handover, and decides to establish an MIPv6 (or DSMIP) connection with the PGW 5 through the core network 4. First, the UE 1 builds a home agent name (FQDN: Fully Qualified Domain Name) by a standard method (e.g., the method described in Non-Patent Document 6 cited above) from the APN as the identifier of the destination network PDN, a HA-APN for identifying the PGW 5, or the like to acquire the address of the destination PGW 5, and makes an inquiry to the DNS server 9. The DNS server 9 sends an appropriate PGW address back to the UE 1 (step S3001: Search for PDN GW). The UE 1 starts BS processing to the PGW address acquired. Specifically, an IKE_SA_INIT procedure is performed on the PGW address acquired in step S3001 (step S3002: IKE_SA_INIT).

Here, it is assumed that the UE 1 acquires, in step S3001, the address of the I-PGW 5a different from the T-PGW 5b already connected and starts BS processing between the UE 1 and the I-PGW 5a.

Here, although the UE 1 desires to connect to the T-PGW 5b already connected, the UE 1 cannot check whether the PGW address presented by the DNS server 9 is the address of the T-PGW 5b. This is because the connection via the 3G access uses, for example, a PMIP, and hence the UE 1 cannot know the address of the T-PGW 5b. The UE 1 knows that a desired PGW address cannot occasionally get upon acquiring a PGW address through the DNS. Further, in the N3G access 3, since it is apparent that there is no means for acquiring any other PGW address (the address of the T-PGW 5b), a request is made at the beginning of IKE authentication processing performed after IKE_SA_INIT in step S3002 to check whether the PGW 5 (here, the I-PGW 5a) starting the BS processing is a desired PGW 5 (i.e., the T-PGW 5b).

Specifically, the UE 1 adds a Home Prefix held by the UE 1 (allocated upon connection via the 3G access 2) to an IKE_AUTH Request message to be sent after completion of the IKE_SA_INIT procedure in step S3002, and sends the IKE_AUTH Request message (step S3003: IKE_AUTH Request). When receiving the IKE_AUTH Request message, the I-PGW 5a extracts the Home Prefix from the message and checks whether it is a home prefix already registered in a binding cache inside its own node (accommodation status) (step S3004: CHECK FOR ACCOMMODATION STATUS).

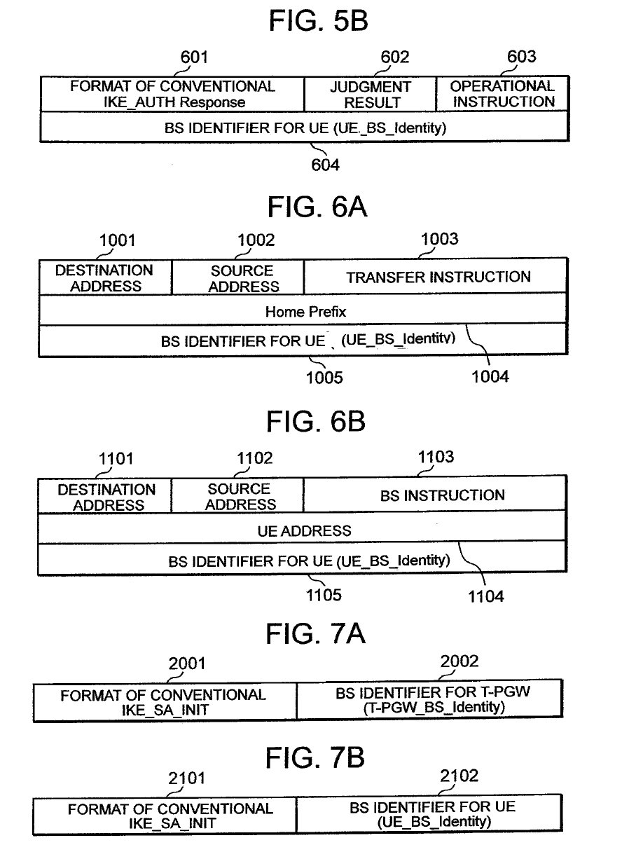

FIG. 5A is a diagram showing an example of the format of the IKE_AUTH Request message sent from the UE 1 to the I-PGW 5a in step S3003 of FIG. 2. The UE 1 provides a Home Prefix field 502 in addition to a conventional standard IKE_AUTH Request message 501 so that the home prefix held by the UE 1 can be inserted into the Home Prefix field 502 and notified. Alternatively, the home prefix may be notified to the I-PGW 5a by describing the home prefix in a Configuration Payload with a MIP6_HOME_PREFIX attribute set in a standard IKE_AUTH Request message.

Although the addition of the home prefix to the IKE_AUTH Request message implies a confirmation request for the accommodation status, an accommodation status confirmation flag (not shown in FIG. 5A) may further be added as well as the addition of the home prefix to the IKE_AUTH Request message to request the I-PGW 5a to confirm the accommodation status explicitly. This enables the I-PGW 5a to perform processing for confirming the accommodation status of the UE 1 in the binding cache managed in its own node without fail and hence to notify the UE 1 of more reliable results. The addition of the accommodation status confirmation flag also enables the PGW 5 accommodating the UE 1 to integrate the connections into the same PGW 5 (T-PGW 5b) under an operational condition that the PGWs 5 are individual PGWs (T-PGW 5a and I-PGW 5b) but the home prefix whose distribution to the UE 1 is managed by each PGW 5 is the same.

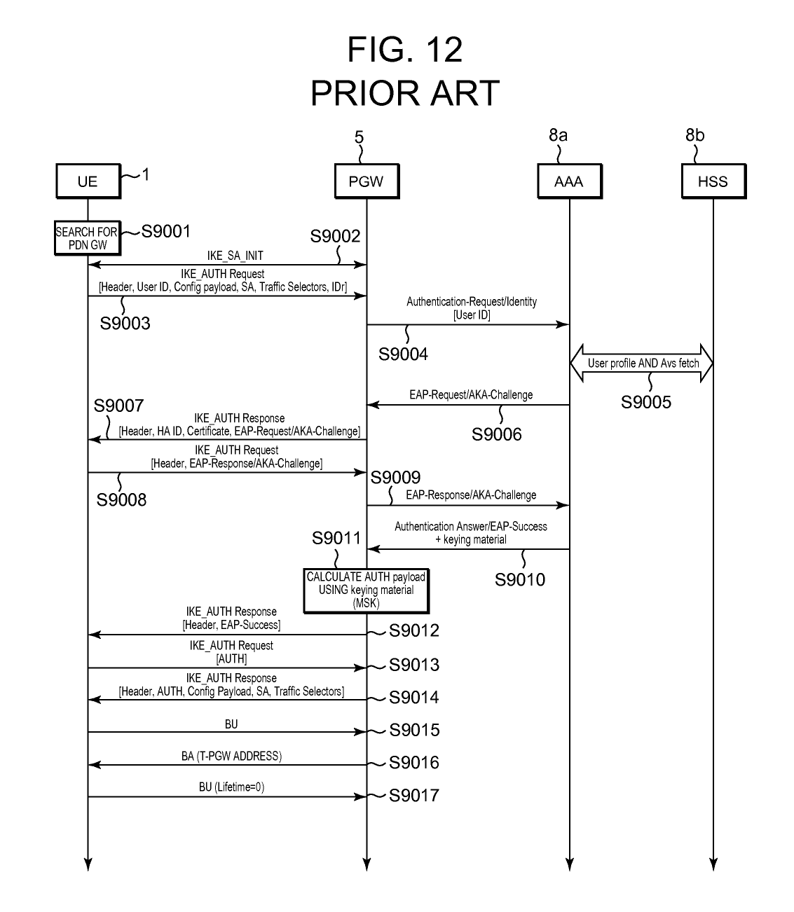

Here, it is assumed in step S3001 that the UE 1 acquires the address of the I-PGW 5a different from the T-PGW 5b already connected, but a case can also be considered where the UE 1 acquires the address of the T-PGW 5 already connected. In this case, since the home prefix sent from the UE 1 is registered in the binding cache and the PGW 5 connected with the UE 1 is the I-PGW 5a (i.e., the I-PGW 5a and the T-PGW 5b are the same), predetermined BS processing is continuously performed. In other words, processing after receiving the IKE_AUTH Request message in step S9003 of FIG. 12 is performed.

When the home prefix sent from the UE 1 is not registered in the binding cache, since the I-PGW 5a is not the T-PGW 5b to which the UE 1 desires to connect, the I-PGW 5a sends the UE 1a response message (e.g., IKE_AUTH Response message) to the IKE_AUTH Request message by including therein an accommodation status result (judgment result), an identifier UE_BS_Identity for identifying that the BS is performed, and operational instructions (step S3005: IKE_AUTH_Response). In the judgment result, the accommodation status indicating whether the home prefix of the UE 1 exists in the binding cache of its own node is described. The UE_BS_Identity is information for correctly receiving BS processing to be described later from the T-PGW 5b, which is, for example, a numeric value or the like specified by the I-PGW 5a and the applications of which will be described later. The IKE_SA_INIT_1 message can be sent from the T-PGW 5b to the UE 1 without using both UE_BS_Identity and T-PGW_BS_Identity. Since this makes it unnecessary to transfer the UE_BS_Identity or the T-PGW_BS_Identity among the I-PGW 5a, the T-PGW 5b, and the UE 1, there is a method of making effective use of communication resources. In the operational instructions, a specifier is stored to urge the UE 1 not to reconnect or complete the processing even if the BS is completed unsuccessfully because BS processing from the T-PGW 5b to be described later is performed.

Here, when the I-PGW 5a follows a GTP (GPRS Tunneling Protocol) based on the 3GPP standard, a management table based on the GTP may also be checked in addition to checking the above-mentioned binding cache for the accommodation status (or without checking the binding cache). This ensures that the accommodation status of the UE 1 can be detected without omission, enabling prevention of error detection.

Further, it can be considered that the PMIP or the GTP is used to connect between the UE 1 and the T-PGW 5b via the 3G access. On the other hand, since the MIP or the DSMIP is used in the current connection via the N3G access, bootstrapping toward the I-PGW 5a is started. Depending on the operation form of the core network 4, it is conceivable that a database for managing the position of the UE 1 used in the PMIP or the GTP (e.g., PMIP binding cache) and a database for managing the position of the same UE 1 used in DSMIP/MIP (e.g., MIP binding cache) are managed and operated individually. It is also conceivable that respective position management functions (for GTP, PM IP, and DSMIP/MIP) are performed in logically or physically different apparatuses. In such a case, it is desired that the I-PGW 5a should check the PMIP binding cache managed by the I-PGW 5a (or managed by another node to be managed by the I-PGW 5a or managed by still another node placed in the same domain as the I-PGW 5a) and the GTP position management database in addition to checking the management database (MIP binding cache) used in the DSMIP/MIP when checking whether the home prefix sent from the UE 1 is registered in the binding cache.

FIG. 5B is a diagram showing an example of the format of IKE_AUTH Response message as a response message sent from the I-PGW 5a to the UE 1 in step S3005 of FIG. 2. The I-PGW 5a provides a judgment result field 602, an operational instruction field 603, and a UE_BS_Identity field 604 in addition to a conventional standard IKE_AUTH Response message 601 so that respectively predetermined values can be notified to the UE 1. Alternatively, the judgment results may be notified to the UE 1 by adding a Notify Payload that abides by a standard IKEv2 protocol (see Non-Patent Document 7 cited above) to a standard IKE_AUTH Response message to describe the judgment results therein. The response message may be any message other than the IKE_AUTH Response message as long as it can transfer predetermined information.

Note that the I-PGW 5a may perform an operation equivalent to that in a case where the above home prefix sent from the UE 1 is not registered in the binding cache on condition that it is determined that a home prefix different from that requested by the UE 1 is allocated according to a standard home prefix allocation mechanism.

The UE 1 that received the response message not only refers to the judgment result field to confirm that it is highly possible that the I-PGW 5a is not the PGW 5 desired by the UE 1, but also refers to the operational instruction field to confirm that BS processing from the desired T-PGW 5b is continuously started, and stores the value (UE_BS_Identity) described in the UE_BS_Identity field. Here, even when it is judged that the BS is completed unsuccessfully, since it becomes apparent that BS processing from the desired T-PGW 5b is started subsequently, it is controlled not to search for or reconnect to another PGW 5 or complete the BS processing to enter a sleep mode. Note that if it is apparent that a BS processing request from the T-PGW 5b can be received later, it may transit to the sleep mode to reduce the power consumption. When the UE 1 confirmed from the judgment result that the UE 1 does not connect to a desired PGW 5, the UE 1 can determine that the BS processing from the desired T-PGW 5b is continuously started, and this can ensure effective use of the communication band by omitting the operational instruction field.

Further, the I-PGW 5a sends a Home Prefix confirmation request message to the AAA server 8a (step S3006: Home Prefix confirmation request). The Home Prefix confirmation request message includes at least information such as the User ID (NAI or the like) of the UE 1, the Home Prefix, the same UE_BS_Identity as that notified to the UE 1, a UE address (CoA), and a transfer instruction. The transfer instruction is to instruct the AAA server 8a to cause the T-PGW 5b to perform BS processing to the UE 1 when the message is received and hence the PGW 5 (T-PGW 5b) managing and holding the home prefix of the UE 1 is identified, and this is particularly effective in extending a conventional Authentication-Request/Identity message and using the extended Authentication-Request/Identity message as the Home Prefix confirmation request message.

The I-PGW 5a may also send the Home Prefix confirmation request message via unicast or multicast to all devices including the T-PGW 5b instead of sending Home Prefix confirmation request message to the AAA server 8a to send the BS instruction to the T-PGW 5b. Similarly, when the I-PGW 5a knows the address of the T-PGW 5b or when the I-PGW 5a is clear on some addresses of the T-PGW 5b, the I-PGW 5a may also send the Home Prefix confirmation request message via unicast or multicast.

The I-PGW 5a can send the IKE_AUTH Response message (sent in step S3005 of FIG. 2) and the Home Prefix confirmation request message (sent in step S3006 of FIG. 2) according to the present invention in no particular order. In other words, in the above description, the IKE_AUTH Response is sent first and the Home Prefix confirmation request message is sent later, but they may be sent in reverse order. For example, the order of sending them may be decided in view of a network delay. For example, the Home Prefix confirmation request may be sent first when the processing load placed on the network side device is high, or the IKE_AUTH Response may be sent first so that BS processing from the T-PGW 5b will not be transmitted to the UE 1 prior to the IKE_AUTH Response to take into account that the state transition of the UE 1 takes place normally.

FIG. 6A is a diagram showing an example of the Home Prefix confirmation request message sent from the I-PGW 5a to the AAA server 8a in step S3006 of FIG. 2. The I-PGW 5a lists the address of the AAA server 8a in a destination address field 1001, its own address in a source address field 1002, a value (e.g., “1” or TRUE) in a transfer instruction field 1003 to give a transfer instruction, a value of the home prefix of the UE 1 in a Home Prefix field 1004, a value of the same UE_BS_Identity as that notified to the UE 1 in a UE_BS_Identity field 1005, and the address (CoA) of the UE 1 in a UE address field 1006, and sends the Home Prefix confirmation request message to the AAA server 8a. A conventional Authentication-Request/Identity message can be extended and used as the Home Prefix confirmation request message. The Home Prefix confirmation request message may also include the User ID of the UE 1. In this case, the T-PGW 5b connected with the UE 1 can be searched for more reliably and a decision on whether to perform switching processing according to the present invention on the UE 1 can be controlled in association with the authentication of the UE 1, enabling the operator to take it as a new billing service.

The AAA server 8a that received the Home Prefix confirmation request message detects the T-PGW 5b accommodating the UE 1 based on the identifiers such as the User ID and the Home Prefix, and sends a Home Prefix confirmation request return message to the T-PGW 5b detected (step S3007: Reply to Home Prefix confirmation request).

Listed in the Home Prefix confirmation request return message are at least the User ID, the UE address, the UE_BS_Identity, and the BS specifier. In the UE address, the same address of the UE 1 listed in the Home Prefix confirmation request message is described. In the BS specifier, a value for instructing the T-PGW 5b that BS processing is started on the address of the UE 1 listed in the UE address is described (e.g., “1” or TRUE).

FIG. 6B is a diagram showing an example of the Home Prefix confirmation request return message sent from the AAA server 8a to the T-PGW 5b in step S3007 of FIG. 2. The AAA server 8a lists the address of the T-PGW 5b in a destination address field 1101, its own address in a source address field 1102, a value (e.g., “1” or TRUE) in a BS instruction field 1103 to give instruction on the start of BS processing, the address of the UE 1 (a copy of the value acquired from the Home Prefix confirmation request message) in a UE address field 1104, and the value acquired from the Home Prefix confirmation request message in a UE_BS_Identity field 1105, and sends the Home Prefix confirmation request return message to the T-PGW 5b. The Home Prefix confirmation request message may also include the User ID of the UE 1. In this case, the T-PGW 5b can identify the UE 1 more reliably.

In the UE address, the address the UE 1 acquires in the 3G access 2, i.e., the home address or the home prefix may be described. This may be described by the UE 1, or by the AAA server 8a or the HSS 8b when receiving the Home Prefix confirmation request message or when sending the Home Prefix confirmation request return message. This enables the UE 1 to start BS processing to be described later more reliably via the 3G access 2 already connected (For example, this is effective when NAT (Network Address Translation) to be described later is provided in the N3G access 3). Here, when the home prefix is described as the UE address, the T-PGW 5b may start BS processing on a predetermined address of the home prefix by unicast, multicast, or anycast, or broadcast the entire home prefix to start BS processing.

The I-PGW 5a may also send the Home Prefix confirmation request message to the HSS 8b. In this case, the AAA server 8a does not need to acquire the state of the UE 1 from the HSS 8b, enabling reduction in processing time. When the Home Prefix confirmation request message is sent to the HSS server 8b, the operation performed by the AAA server 8a in the above description is performed by the HSS 8b, and the Home Prefix confirmation request return message is forwarded directly from SS 8b to the T-PGW 5b or indirectly through a node.

Further, the I-PGW 5a may send the Home Prefix confirmation request message over a range in which the I-PGW 5a is transmittable, or perform any of broadcast transmission, multicast transmission, unicast transmission, and anycast transmission (particularly transmission to a home agent anycast address built based on the home prefix of the UE 1) to PGWs 5 located within a predetermined range. This can reduce the number of messages forwarded via the AAA server 8a or the HSS 8b, and hence reduce not only the load on the AAA server 8a or the HSS 8b but also the number or messages processed in the entire system especially in the case of unicast communication.

When sending an instruction directly to the T-PGW 5b, the I-PGW 5a acquires the address of the T-PGW 5b from the AAA server 8a in advance. At this time, the AAA server 8a may perform authentication processing on the UE 1 for the reason that the address of the T-PGW 5b is to be acquired for the UE 1. The message for the direct instruction may be the Home Prefix confirmation request message or the Home Prefix confirmation request return message.

Thus, since the I-PGW 5a sends the Home Prefix confirmation request message (or the Home Prefix confirmation request return message in some cases) to the AAA server 8a or the HSS 8b, or directly to the T-PGW 5b, the I-PGW 5a does not need to perform processing on the UE 1 from then on. In other words, the state or the resources of the UE 1 can be released, and hence processing on another terminal can be started immediately. Thus, according to the present invention, since switching to a desired PGW 5 can be detected and performed promptly, effective use of PGW resources can be made. Incidentally, in the conventional techniques, the I-PGW 5a cannot release the resources of the I-PGW 5a and the state for the UE 1 unless step S9017 of FIG. 12 is completed (to be exact, there is a need to complete SA established between the UE 1 and the I-PGW 5a after step S9017).

The T-PGW 5b that received the Home Prefix confirmation request return message confirms from the User ID and the like that the UE 1 is the one accommodated by itself, further confirms that the BS specifier is an instruction given to start BS processing to the UE 1, and sends a first IKE_SA_INIT message to the UE address to start the BS processing (step S3008: IKE_SA_INIT_1). The first IKE_SA_INIT message includes at least the identifier T-PGW_BS_Identity generated by the T-PGW 5b to identify that the BS is to be performed.

FIG. 7A is a diagram showing an example of the first IKE_SA_INIT message sent from the T-PGW 5b to the UE 1 in step S3008 of FIG. 2. The T-PGW 5b provides a T-PGW BS identifier field (T-PGW_BS_Identity field) 2002 after a conventional standard IKE_SA_INIT message 2001 (IKE_SA_INIT message first sent from Initiator to Responder), and at least the T-PGW BS identifier T-PGW_BS_Identity to identify that the BS acquired by the T-PGW 5b is to be performed is described therein and the first IKE_SA_INIT message is sent.

The UE 1 that received the first IKE_SA_INIT message from the T-PGW 5b confirms the value in the T-PGW_BS_Identity field of the message, and performs a predetermined verification to be described later using the value of the UE_BS_Identity previously acquired from the I-PGW 5a (the UE_BS_Identity included in the IKE_AUTH_Response received in step S3005). If the verification result is successful, the UE 1 recognizes that it is a BS processing request from the T-PGW 5b requested, and sends an IKE_SA_INIT message as a response (step S3009: IKE_SA_INIT_2). At this time, the UE 1 includes the previously acquired UE_BS_Identity in the IKE_SA_INIT message to be sent, and sends the IKE_SA_INIT message. Thus, the fact that the IKE_SA_INIT message is a response from the UE 1 making a request for triggering the BS processing is presented to the T-PGW 5b, enabling confirmation that BS processing is performed between correct nodes.

FIG. 7B is a diagram showing an example of the second IKE_SA_INIT message sent from the UE 1 to the T-PGW 5b in step S3009 of FIG. 2. The UE 1 includes at least the BS identifier UE_BS_Identity for the UE, previously acquired from the I-PGW 5a to identify that the BS is to be performed, after the conventional standard IKE_SA_INIT (IKE_SA_INIT message first sent from Initiator to Responder), and sends the second IKE_SA_INIT message. Any IKE_SA_INIT messages may be used as the IKE_SA_INIT messages exchanged between the UE 1 and the T-PGW 5b in steps S3008 and S3009 as long as the BS_Identity identifiers (T-PGW_BS_Identity and UE_BS_Identity) respectively sent can be exchanged correctly.

If both authenticate or confirm each other using the above-mentioned BS_Identity identifiers, conventional standard processing will be performed as the subsequent BS processing (remaining IKE_SA_INIT and processing in step S3010 and following steps) so that the establishment of SA between the UE 1 and the T-PGW 5b can be achieved.

The UE 1 may set a timer to wait for receiving the IKE_SA_INIT from the T-PGW 5b for the purpose of facilitating recovery when the IKE_SA_INIT_1 message from the T-PGW 5b shown in step S3008 cannot be received. For example, the timer is set for a predetermined value and started when the UE 1 receives the IKE_AUTH Response message according to the present invention. The UE 1 may set any value for the timer, or another network device such as the I-PGW 5a may specify a value through an IKE_AUTH Response message or the like.

Next, a method of using the UE_BS_Identity and the T-PGW_BS_Identity will be described in detail. Information used as the UE_BS_Identity or T-PGW_BS_Identity is, for example, a hash value generated based on a value shared between the UE 1 and the PGW 5, a value generated at random, or the address of the I-PGW 5a, but the information is not limited thereto as long as the information is a value (code) recognizable by the UE 1 and the PGW 5.

In the sequence show in FIG. 2, the UE_BS_Identity is generated by the I-PGW 5a, and sent to the UE 1 (step S3005 in FIG. 2) and sent via the AAA server 8a or directly to the T-PGW 5b (step S3006 in FIG. 2). The T-PGW 5b generates T-PGW_BS_Identity corresponding to the received UE_BS_Identity, and sends the UE 1 an IKE_SA_INIT_1 message including the generated T-PGW_BS_Identity (step S3008 in FIG. 2). The UE 1 that received the IKE_SA_INIT message derives the T-PGW_BS_Identity corresponding to the UE_BS_Identity previously acquired from the I-PGW 5a (UE_BS_Identity included in the IKE_AUTH Response received in step S3005 of FIG. 2), and compares it with the T-PGW_BS_Identity (T-PGW_BS_Identity included in the IKE_SA_INIT_1 received in step S3008 of FIG. 2) received from the T-PGW 5b. If the results of comparison of both are the same, the UE 1 can recognize that the IKE_SA_INIT message including the Home Prefix is the BS processing request from the T-PGW 5b made as a result of transmission to the I-PGW 5a. As a method of causing the UE 1 to derive the T-PGW_BS_Identity corresponding to the UE_BS_Identity, the hash value determined from the UE_BS_Identity may be used as the T-PGW_BS_Identity, or table information indicative of a correspondence between the UE_BS_Identity and the T-PGW_BS_Identity may be used. In this case, the table information can be acquired from an information server in the 3G network or may be preset in the UE 1 by the operator. Further, the UE 1 may make an inquiry to the information server to acquire the T-PGW_BS_Identity corresponding to the UE_BS_Identity. In the case of using the hash function, since both the UE_BS_Identity and the T-PGW_BS_Identity use a sophisticated encryption algorithm, security can be increased.

In the above description, the UE_BS_Identity is generated by the I-PGW 5a and the T-PGW_BS_Identity is generated by the T-PGW 5b. However, for example, both the UE_BS_Identity and the T-PGW_BS_Identity may be generated by the I-PGW 5a. In this case, the I-PGW 5a sends the UE_BS_Identity to the UE 1 and the T-PGW_BS_Identity corresponding to the UE_BS_Identity via the AAA server 8a or directly to the T-PGW 5b. The T-PGW 5b sends the UE 1 the IKE_SA_INIT_1 message including the T-PGW_BS_Identity received so that the UE 1 can check whether it is the BS processing request from the T-PGW 5b.

Further, the UE_BS_Identity and/or the T-PGW_BS_Identity may be generated by a device other than the I-PGW 5a, such as the UE 1, the T-PGW 5b, or the AAA/HSS 8, i.e., or each BS_Identity may be generated by a different device.

Further, the UE_BS_Identity and the T-PGW_BS_Identity can be set to the same value to perform BS processing. In this case, the UE 1 compares the BS_Identity (the BS_Identity included in the IKE_AUTH Response received in step S3005 of FIG. 2) acquired in advance from the I-PGW 5a with the BS_Identity (the BS_Identity included in the IKE_SA_INIT_1 received in step S3008 of FIG. 2) acquired from the IKE_SA_INIT message, and when both are identical, the UE 1 recognizes it as the BS processing request from the T-PGW 5b. Likewise, the T-PGW 5b compares the BS_Identity notified from the AAA/HSS 8 with the BS_Identity notified from the UE 1, and when both are identical, the T-PGW 5b recognizes it as a response from the desired the UE 1. Then, if both the UE_BS_Identity and the T-PGW_BS_Identity are sent to the UE 1 and the T-PGW 5b, the UE 1 can know the T-PGW_BS_Identity corresponding to the UE_BS_Identity. However, as mentioned above, if the UE 1 and the PGW 5 have a table for allowing them to acquire a common BS_Identity from any BS_Identity, both the BS_Identity identifiers do not need sending. Similarly, if a device other than the UE 1 and the PGW 5 has the above table and the UE 1 and the PGW 5 can access the table, both the BS_Identity identifiers do not need sending. Instead of the above table, a fixed value unmodifiable by an instruction from the operator or an operation of the user may be set as the BS identifier irrespective of the UE 1 or the PGW 5.

Methods of generating the UE_BS_Identity and/or the T-PGW_BS_Identity, other than that using the sophisticated encryption algorithm, include a method of using a shared key generated in the IKE_SA_INIT message, a method of using any function (e.g., random function), and a method of specifying them as an index to use existing values. Each use method will be described in detail below.

When the method of using the shared key generated in the IKE_SA_INIT message is employed, since a known value is shared between the UE 1 and the I-PGW 5a, new BS_Identity does not need generating. Alternatively, the shared key may be set as the UE_BS_Identity so that the T-PGW_BS_Identity will be newly generated. Thus, when the generated shared key is used, the time required to newly generate BS_Identity identifiers can be reduced.

The method of generating the UE_BS_Identity and/or T-PGW_BS_Identity using any function (e.g., random function) may also be employed. Use of a sophisticated encryption algorithm such as the hash function can reduce the time required for BS_Identity generation.

When the method of specifying the identifiers as an index to use existing values is employed, if ‘H’ is specified for the UE_BS_Identity as an example, the specifications will be so defined that the UE 1, the T-PGW 5b, or the like can determine that the UE_BS_Identity is “HPLMN ID.” Since this technique is not to generate the BS_Identity, it has the advantage of easy implementation and shorter processing time though lower security than the above schemes.

All the above-mentioned use methods may be applied to both the UE_BS_Identity and the T-PGW_BS_Identity, or a different use method may be employed for each BS_Identity. What is commonly followed by the respective use methods is that the UE 1 and the T-PGW 5b can confirm both BS_Identity identifiers.

When NAT (Network Address Translator) is provided in the N3G access 3 to which the UE 1 is to attach, this may cause a problem that the first IKE_SA_INIT message (the IKE_SA_INIT_1 message in step S3008 of FIG. 2) for BS processing started from the T-PGW 5b does not reach the UE 1, and as a result, the UE 1 fails in connection to the T-PGW 5b. However, in a conventional BS processing method, the UE 1 can detect the presence or absence of NAT in the initial step of BS processing (for example, see Non-Patent Document 7). Similarly, the I-PGW 5a can also detect the presence or absence of NAT in the same step. Therefore, this problem can be solved by the following two methods.

In the first method, the I-PGW 5a detecting that NAT is provided in the N3G access 3 includes, in the Home Prefix confirmation request message (e.g., using the transfer instruction field or the like), an instruction to perform BS processing from the T-PGW 5b via the 3G access 2. This instruction is carried over into the Home Prefix confirmation request return message (e.g., using the BS instruction field or the like), and forwarded to the T-PGW 5b. At this time, any one of the I-PGW 5a, the AAA server 8a, and the HSS 8b (or all the nodes) describes the home prefix of the UE 1 in the UE address, and this makes the above explicit instruction unnecessary, thereby enabling effective use of processing and message resources. The description of the above explicit instruction makes it unnecessary to describe the home prefix in the UE address, thereby enabling effective use of resources as well.

The T-PGW 5b starts BS processing in response to receiving the above instruction or to the home prefix described in the UE address. When receiving the above explicit instruction, the T-PGW 5b starts BS processing to the home prefix of the UE 1 held and managed by itself without referring to the address described in the UE address. Further, if the home address of the UE 1 is clear, BS processing to the home address may be started. Note that when detecting NAT, the I-PGW 5a may notify, in the IKE_AUTH Response (the IKE_AUTH Response sent in step S3005 of FIG. 2), the UE 1 to wait until BS processing from the T-PGW 5b comes via the 3G access 2. This enables the UE 1 to perform processing, such as to cause the communication interface to connect to the 3G access 2 to shift to an active mode autonomously if it is in an idle mode, and hence to prepare to be able to receive the start of the BS processing from the T-PGW 5b (specifically, the IKE_SA_INIT message) instantly, thereby enabling further speeding up of the connection.

In the second method, the UE 1 detecting that NAT is provided makes a request, in the IKE_AUTH Request (in step S3003 of FIG. 2), the I-PGW 5a to start BS processing via the 3G access 2. Upon receipt of this, the I-PGW 5a executes the above-mentioned first method.

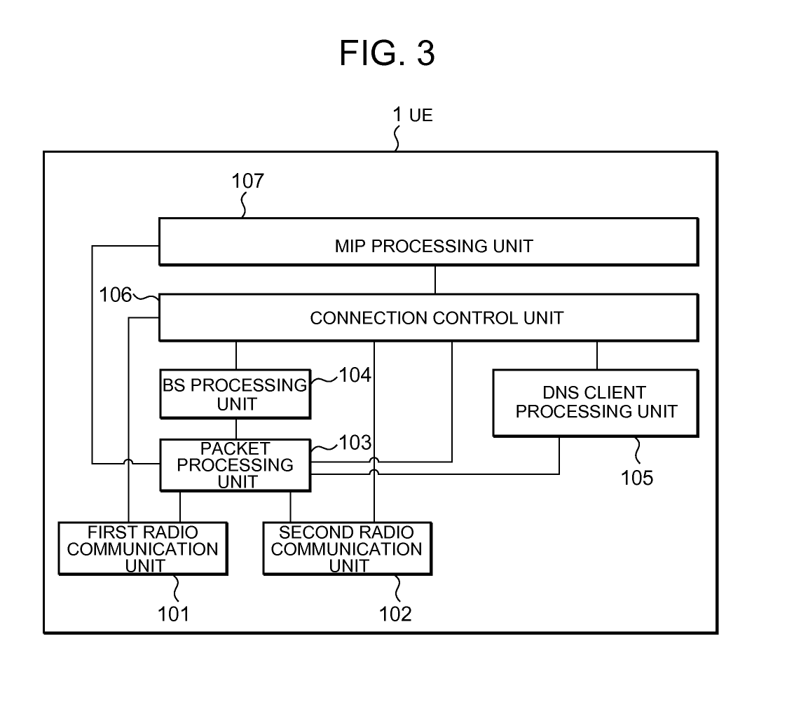

Next, a configuration of the mobile terminal (UE 1) for carrying out the present invention will be described. Referring to FIG. 3, the configuration of the UE 1 according to the first embodiment of the present invention will be described.

FIG. 3 is a diagram showing an example of the configuration of the UE 1 according to the first embodiment of the present invention.

In FIG. 3, the UE 1 has at least a first radio communication unit 101 and a second radio communication unit 102, which perform communication processing to connect an access network (3G access 2 or N3G access 3), respectively, to perform communication processing at lower layers, a packet processing unit 103 for performing packet communication processing such as IP at higher levels than the first and second radio communication units 101 and 102, a BS processing unit 104 for performing BS (bootstrap) processing between the UE 1 and a PGW 5, a DNS client processing unit 105 for sending a query message to the DNS server 9 to acquire predetermined address information from the result received as the response, a connection control unit 106 for performing processing that is a characteristic feature of the present invention, and a MIP processing unit 107 for performing mobility management processing on a PGW 5, such as BU/BA exchange, based on DSMIP or MIPv6. The first and second radio communication units 101 and 102 may connect to either the 3G access 2 or the N3G access 3, or one radio communication unit (e.g., the first radio communication unit 101) may connect to both the 3G access 2 and the N3G access 3 at the same time. In the first embodiment of the present invention, description will be made by taking as an example a case where the UE 1 has two radio communication units, and one radio communication unit (first radio communication unit 101) is connected to the 3G access 2 and the other radio communication unit (second radio communication unit 102) is connected to the N3G access 3.

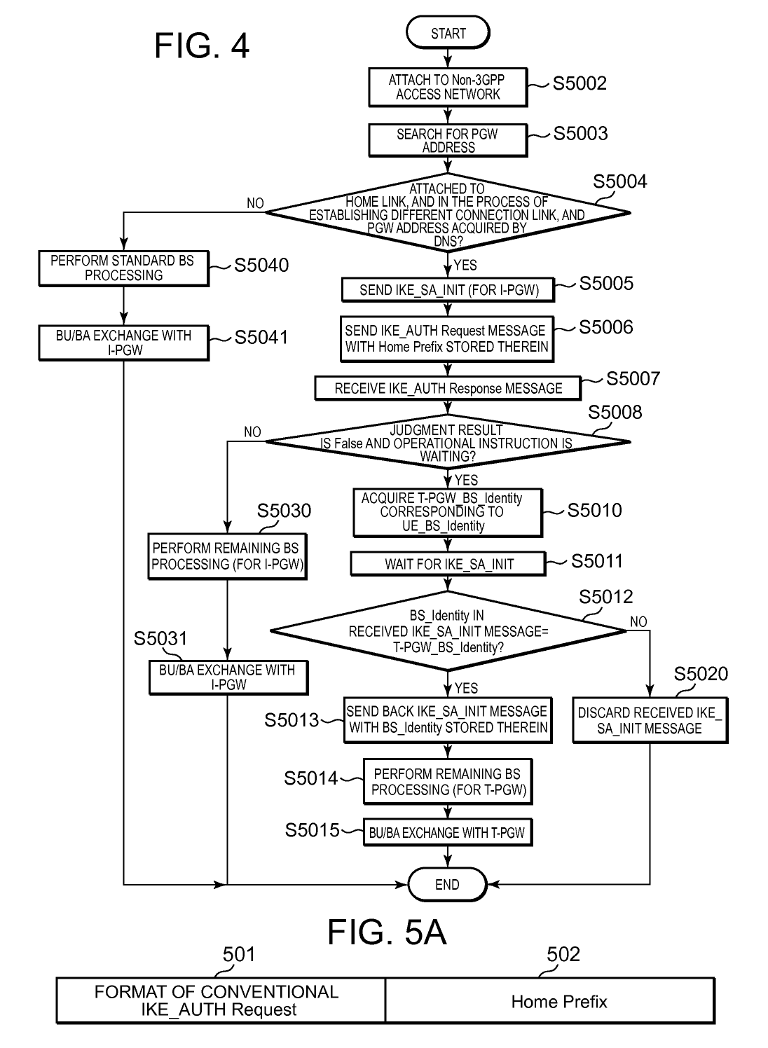

Referring next to FIG. 4, a detailed description will be made of a processing flow of the UE 1 having the configuration shown in FIG. 3, focusing on processing related to the connection control unit 106 for performing processing that is the characteristic feature of the present invention. It is assumed that the UE 1 is already attached to the 3G access 2 (home link) through the first radio communication unit 101, and is connecting with the T-PGW 5b.

FIG. 4 is a flowchart showing an example of the processing flow of the UE 1 according to the first embodiment of the present invention. The connection control unit 106 according to the present invention first instructs the second radio communication unit 102 to start establishing a connection to start processing for attachment to the N3G access 3 (step S5002). The second radio communication unit 102 performs an attach procedure according to a connection procedure in the N3G access 3. After completion of attachment to the N3G access 3, the DNS client processing unit 105 is instructed to start searching to search for the address of a PGW 5 to connect via the N3G access 3 (step S5003). At this time, the connection control unit 106 builds a home agent name (FQDN) by a standard method (e.g., the method disclosed in Non-Patent Document 6) from an APN as the identifier of a destination network PDN or a HA-APN for identifying the PGW 5 to acquire the address of the PGW 5 as the connection destination, and notifies the DNS client processing unit 105 of the home agent name. The DNS client processing unit 105 sends a DNS query with the notified home agent name described to the DNS server 9 via the packet processing unit 103 and the second radio communication unit 102. The DNS client processing unit 105 receives a DNS response as the response to the DNS query via the second radio communication unit 102 and the packet processing unit 103, and transfers a PGW address acquired from the DNS response to the connection control unit 106.

Here, the connection control unit 106 judges whether the situation meets three requirements that the UE 1 is already attached to the home link via the first radio communication unit 101 (via the 3G access 2), that the UE 1 has established a different connection link based on DSMIP or MIPv6 and is trying to connect with the PGW 5, and that the address of the connection destination PGW is acquired by the DNS (step S5004). If any one of the requirements is not met, the connection control unit 106 instructs the BS processing unit 104 to start standard BS processing on the PGW address acquired. The BS processing unit 104 performs standard BS processing, for example, as shown from step S9002 to S9014 in FIG. 12 (step S5040), and then performs BU/BA exchange with the PGW 5 (I-PGW 5a) based on DSMIP or MIPv6 (step S5041).

On the other hand, if all the requirements are met, the connection control unit 106 instructs the BS processing unit 104 to start BS processing on the acquired PGW address according to the present invention. The BS processing unit 104 starts IKE_SA_INIT processing as a procedure for establishing IKE SA on the PGW address (the address of the I-PGW 5a) notified from the connection control unit 106 (step S5005). After completion of the IKE_SA_INIT processing and the IKE SA is established, the BS processing unit 104 lists the Home Prefix acquired at the time of attachment to the home link in an IKE_AUTH Request message, and sends the IKE_AUTH Request message (step S5006). This enables the PGW 5 as the destination of the IKE_AUTH Request message to confirm the accommodation status of its own node, and hence confirm whether the PGW 5 with which the UE 1 is to connect already accommodates the UE 1, i.e., whether the PGW 5 is already connected via the home link.

Note that since the conventional standard IKE_AUTH Request message has a field for the home prefix, the field can be used in the present invention. However, in this case, a flag or a specifier may be explicitly provided to indicate the confirmation of the accommodation status to avoid disruption in the processing performed by the PGW 5 (disruption caused when the PGW 5 is not be able to distinguish between the conventional standard BS processing and the BS processing according to the present invention properly). Such a flag or specifier can be explicitly provided even if there is no field for the home prefix.

The IKE_AUTH Request message is sent from the BS processing unit 104 to the PGW 5 through the packet processing unit 103 and the second radio communication unit 102. After the confirmation of the accommodation status, the PGW 5 sends the UE 1 an IKE_AUTH Response message as the response to the IKE_AUTH Request message, and the IKE_AUTH Response message is transferred to the BS processing unit 104 through the second radio communication unit 102 and the packet processing unit 103 (step S5007). The BS processing unit 104 notifies the connection control unit 106 of parameters (at least the judgment result, UE_BS_Identity, and the operational instruction) described in the IKE_AUTH Response to evaluate the judgment result and the operational instruction in the connection control unit 106 (step S5008).

If the judgment result is not a value indicative of at least a failure (e.g., code such as “0” or FALSE), the connection control unit 106 instructs the BS processing unit 104 to continue to perform the remaining BS processing based on the conventional standard BS procedure. The BS processing unit 104 performs the remaining BS processing, i.e., from steps S9008 to S9014 shown in FIG. 12 (step 5030), and then performs BU/BA exchange with the PGW 5 based on DSMIP or MIPv6 (step S5031).

On the other hand, if the judgment result is a value indicative of a failure and the operational instruction is a value indicative of “waiting” (e.g., code indicative of a state such as “Wait”), the connection control unit 106 independently generates T-PGW_BS_Identity corresponding to the UE_BS_Identity notified through the IKE_AUTH Response (e.g., it performs a has calculation using the UE_BS_Identity as the original data) or acquires T-PGW_BS_Identity corresponding to the UE_BS_Identity from the database (step S5010).

The details of the UE_BS_Identity and the T-PGW_BS_Identity are described above in the description of the communication system according to the present invention and redundant description will be omitted. Here, the description will be made with respect to a case where both the UE_BS_Identity and the T-PGW_BS_Identity exist and the communication system and the mobile terminal operate on the precondition that they exist, but even if either of them is not defined depending on the method of using the BS_Identity mentioned above, the UE 1 can select or modify the operation appropriately.

Here, in response to the fact that the operational instruction indicates “waiting,” the connection control unit 106 detects that BS processing from the PGW 5 (T-PGW 5b) with which the UE desires to connect is to be started, and makes the BS processing unit 104 capable of receiving IKE_SA_INIT from the outside (step S5011). At this time, the connection control unit 106 can clear or rest the state and data related to the BS processing with the PGW 5 (I-PGW 5a) already started by the BS processing unit 104. This eliminates the need to retain the state and data related to the connection with the I-PGW 5a unnecessary anymore, enabling effective use of resources. Further, in case that BS processing from the T-PGW 5b results in a failure (due to the operator's determination or lack of a resource on the network side resource), the state data related to the connection with the I-PGW 5a may be retained. In this case, if the UE must result in establishing a connection with the I-PGW 5a, the procedure can be resumed in the middle of the BS processing (since at least IKE SA is retained, it is enough to begin with the IKE_AUTH Request).

The BS processing for the UE 1 is eventually started at the T-PGW 5b, and the first IKE_SA_INIT message (noted as step S3008: IKE_SA_INIT_1 in FIG. 2) is delivered to the UE 1. The first IKE_SA_INIT message from the T-PGW 5b is transferred to the BS processing unit 104 through the second radio communication unit 102 and the packet processing unit 103. When confirm that it is the IKE_SA_INIT message from the T-PGW 5b, the BS processing unit 104 transfers the T-PGW_BS_Identity included in the message to the connection control unit 106. The connection control unit 106 evaluates whether the T-PGW_BS_Identity acquired is the same as that generated or acquired based on the UE_BS_Identity included in the IKE_AUTH Response previously received in step S5007 (i.e., whether it is the same value, the same attribute, or falls within a range of predetermined threshold values, or the identity is verified through a predetermined function) (step S5012). In the flow shown in FIG. 4, processing is described when the T-PGW_BS_Identity is included in the IKE_SA_INIT message and the evaluation is made by determining a correlation with the UE_BS_Identity included in the IKE_AUTH Response message. However, using various methods according to the above-mentioned methods of using the BS_Identity, it can be determined whether the received IKE_SA_INIT message is a BS processing request from the T-PGW 5b.

If it is not evaluated in the processing step S5012 that both are the same (they have a correlation), the connection control unit 106 determines that the BS processing comes from an unintended PGW 5 or another node, and instructs the BS processing unit 104 to discard or reject the received IKE_SA_INIT message. Then the BS processing unit 104 discards or rejects the message according to the instruction (step S5020).

On the other hand, if it is evaluated in the processing step S5012 that both are the same (they have a correlation), the connection control unit 106 instructs the BS processing unit 104 to store the UE_BS_Identity in the second IKE_SA_INIT message (IKE_SA_INIT_2 sent in step S3009 of FIG. 2) to be sent as a response, and send the second IKE_SA_INIT message (step S5013). The BS processing unit 104 sends the T-PGW 5b the second IKE_SA_INIT message with the UE_BS_Identity stored therein according to the instruction. The T-PGW 5b that received the IKE_SA_INIT message uses the UE_BS_Identity stored in the message to verify whether the response comes from the intended UE 1, and upon completion of the verification correctly, subsequent BS processing is continuously performed with the T-PGW 5b (step S5014). Upon completion of all the BS processing operations, the connection control unit 106 instructs the MIP processing unit 107 to perform BU/BA exchange with the T-PGW 5b based on DSMIP or MIPv6. Then the MIP processing unit 107 performs BU/BA exchange with the T-PGW 5b (step S5015).

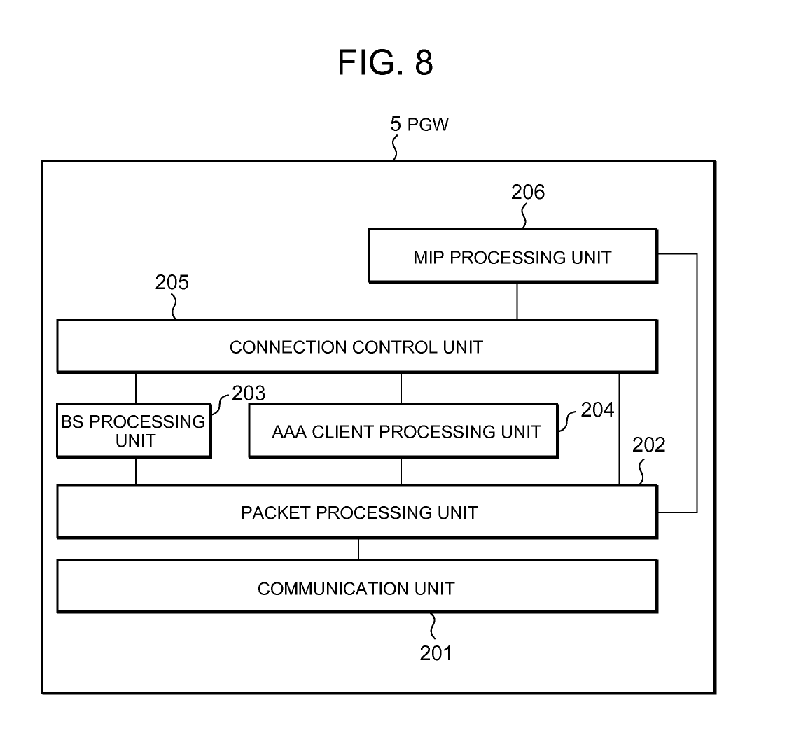

Next, a configuration of the PGW 5 for carrying out the present invention will be described. Referring to FIG. 8, the configuration of the PGW 5 according to the first embodiment of the present invention will be described. FIG. 8 is a diagram showing an example of the configuration of the PGW 5 according to the first embodiment of the present invention.

In FIG. 8, the PGW 5 has at least a communication unit 201 for attaching to the core network 4 to perform communication processing at lower layers, a packet processing unit 202 for performing packet communication processing such as IP at higher levels than the communication unit, a BS processing unit 203 for performing bootstrap processing between the UE 1 and the PGW 5, an AAA client processing unit 204 for acquiring a query message to the AAA server 8a and a BS instruction to the UE 1, a connection control unit 205 for performing processing that is a characteristic feature of the present invention, and a MIP processing unit 206 for performing mobility management processing on the PGW 5, such as BU/BA exchange, based on DSMIP or MIPv6.

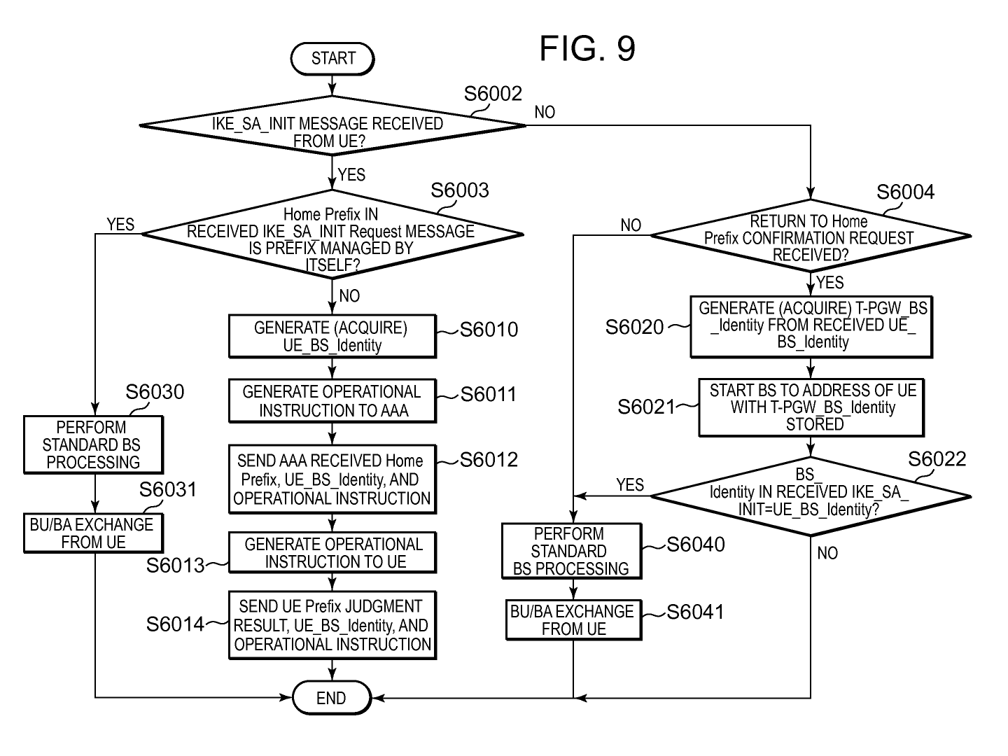

Referring next to FIG. 9, a detailed description will be made of a processing flow of the PGW 5 having the configuration shown in FIG. 8, focusing on processing related to the connection control unit 205 for performing processing that is the characteristic feature of the present invention. It is assumed that the PGW 5 is already attached to the 3G access 2 (home link) through the communication unit 201. It is also assumed that the PGW 5 on which the UE 1 first tries to perform an attach procedure is the I-PGW 5a.

FIG. 9 is a flowchart showing an example of the processing flow of the PGW 5 according to the first embodiment of the present invention. The PGW 5 according to the present invention waits for BS from the UE 1 to establish SA with the UE 1. When the UE 1 starts the attach procedure with the I-PGW 5a according to a connection procedure, an IKE_SA_INIT message is sent from the UE 1 (step S6002). After that, when receiving an IKE_AUTH Request message (including the Home Prefix of the UE 1) as the next step, the I-PGW 5a checks whether the Home Prefix stored in the message is registered in a binding cache of the I-PGW 5a (step S6003).

PMIP or GTP protocol is used for connection between the UE 1 and the T-PGW 5b via the 3G access, whereas MIP or DSMIP is used for this connection via the N3G access. Therefore, bootstrapping processing is started toward the I-PGW 5a. Depending on the operation of the core network 4, it is contemplated that a database (e.g., a PMIP binding cache) for managing the position of the UE 1 used in PMIP or GTP and a database (e.g., a MIP binding cache) for managing the position of the UE 1 used in DSMIP/MIP are individually controlled and operated, respectively. It is also contemplated that the respective (GTP, PMIP and DSMIP/MIP) position management functions are executed on logically or physically different devices. In such a case, when checking whether the home prefix sent from the UE 1 is registered in a binding cache, it is desired that the I-PGW 5a should check not only the management database (MIP binding cache) used in DSMIP/MIP, but also the PMIP binding cache managed by the I-PGW 5a (or managed by another node to be managed by the I-PGW 5a, or managed by another node located in the same domain as the I-PGW 5a) and the position management database for GTP.

At this time, if the Home Prefix is not registered in the binding cache of the I-PGW 5a, the I-PGW 5a generates (acquires) UE_BS_Identity (step S6010). There are the several methods of generating the UE_BS_Identity as mentioned above. Then, the I-PGW 5a generates an operational instruction to cause the T-PGW 5b managing the Home Prefix stored in the IKE_SA_INIT message to instruct the UE 1 to perform BS (step S6011). Then, the Home Prefix received through the IKE_SA_INIT message, the generated UE_BS_Identity, and the operational instruction are sent to the AAA server 8a (step S6012). The T-PGW 5b may be searched for and specified by the AAA server 8a or the HSS 8b or by the I-PGW 5a.

The I-PGW 5a also generates an operational instruction to the UE 1 to be sent to the UE 1 separately from that to the AAA server 8a (step S6013). Then, a Prefix judgment result (e.g., False or ‘1’) indicating that the Home Prefix is different, the generated UE_BS_Identity, and the operational instruction to the UE 1 are sent to the UE 1 (step S6014). Here, the transmission processing of the operational instruction (transmission to the UE 1) in steps S6013 and S6014 is performed after the transmission processing of the operational instruction (transmission to the AAA server 8a) in steps S6011 and S6012, but the order of these transmission processing operations is not particularly limited, and they may be performed in any order or in parallel.

On the other hand, if the Home Prefix stored in the IKE_AUTH Request message is registered in the binding cache of the I-PGW 5a (step S6003), standard BS processing is performed (step S6030), and after SA is established, BA to BU sent from the UE 1 is exchanged (step S6031).

Further, when the PGW 5 works as the T-PGW 5b rather than the I-PGW 5a, the T-PGW 5b receives a Home Prefix confirmation request return message rather than the IKA_SA_INIT message (step S6004). In this case, the T-PGW 5b generates (acquires) T-PGW_BS_Identity from the UE_BS_Identity received (step S6020). Then, the T-PGW 5b sends the UE 1 an IKE_SA_INIT_1 message with the generated T-PGW_BS_Identity stored therein (step S6021). When receiving an IKE_SA_INIT_2 message expected to be a return message of the IKE_SA_INIT_1 message, the T-PGW 5b uses the UE_BS_Identity (the UE_BS_Identity included in the Home Prefix confirmation request return message received in step S6004) transferred from the AAA server 8a to check it against the BS_Identity stored in the IKE_SA_INIT_2 message (step S6022). If both match, standard BS processing is continuously performed to establish SA between the UE 1 and the T-PGW 5b (step S6040). Then, after the SA is established, BA to BU sent from the UE 1 is exchanged (step S6041).

Note that, depending on the method of using BS_Identity, T-PGW_BS_Identity and any other kind of value may be included in the Home Prefix confirmation request return message received in step S6004. In such a case, these values can be used in the same manner to check the BS_Identity included in the IKE_SA_INIT_2 message.

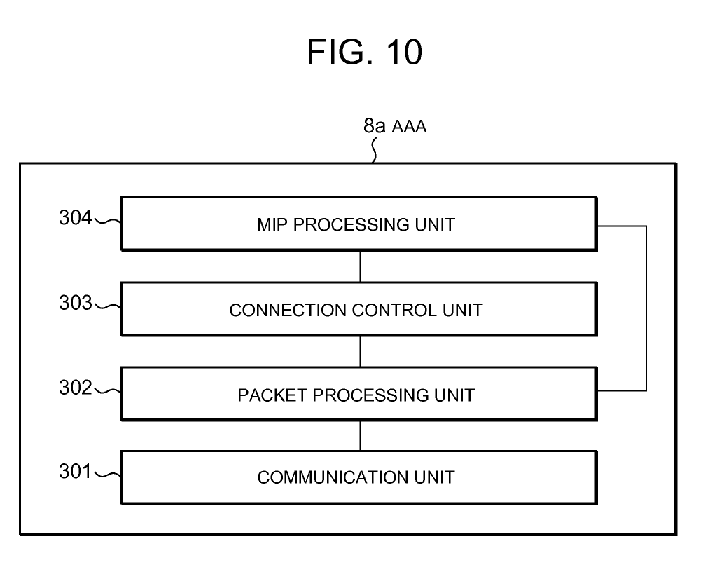

Next, a configuration of the AAA server 8a for carrying out the present invention will be described. The configuration of the AAA server 8a according to the first embodiment of the present invention will be described below with reference to FIG. 10. FIG. 10 is a diagram showing an example of the configuration of the AAA server 8a according to the first embodiment of the present invention. As mentioned above, the AAA server 8a and the HSS 8b may be physically or logically implemented on the same machine. For example, the configuration shown in FIG. 10 may implemented in the HSS 8b.

In FIG. 10, the AAA server 8a has at least a communication unit 301 for attaching to the core network 4 to perform communication processing at lower layers, a packet processing unit 302 for performing packet communication processing such as IP at higher levels than the communication unit, a connection control unit 303 for performing processing that is a characteristic feature of the present invention, and an authentication/authorization processing unit 304 for performing authentication/authorization processing on the UE 1 corresponding to a protocol such as DSMIP or MIPv6.

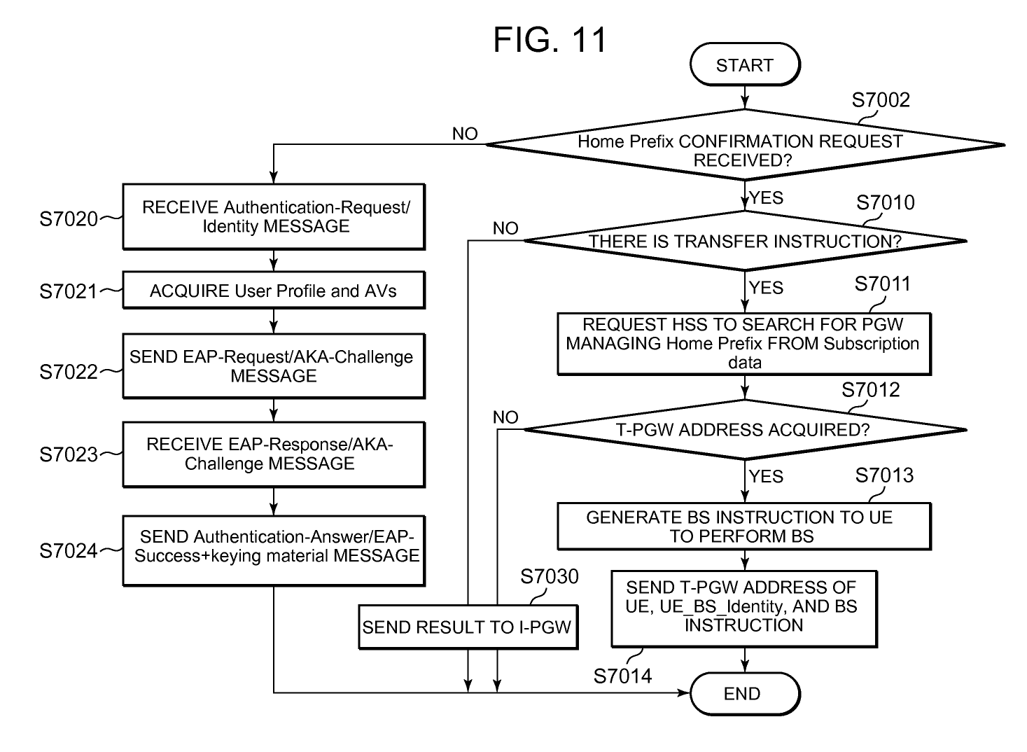

Referring next to FIG. 11, a detailed description will be made of a processing flow of the AAA server 8a having the configuration shown in FIG. 10, focusing on processing related to the connection control unit 303 for performing processing that is the characteristic feature of the present invention. It is assumed that the AAA server 8a is already connected to the core network 4 through the communication unit 301. It is also assumed that the PGW 5 on which the UE 1 first tries to perform an attach procedure is the I-PGW 5a.

FIG. 11 is a flowchart showing an example of the processing flow of the AAA server 8a according to the first embodiment of the present invention. The AAA server 8a according to the present invention waits for a Home Prefix confirmation request message sent from the PGW 5. When the UE 1 starts the attach procedure with the I-PGW 5a according to a connection procedure, the Home Prefix confirmation request message is sent from the I-PGW 5a (step S7002). The AAA server 8a that received this message checks whether an operational instruction is stored in the Home Prefix confirmation request message, and further checks whether the operational instruction is a transfer instruction (step S7010). If the operational instruction is the transfer instruction, the AAA server 8a makes an inquiry to the HSS 8b about whether the Home Prefix stored in the Home Prefix confirmation request message is registered in Subscription data contained in the HSS 8b. In receipt of the query message, the HSS 8b refers to the Subscription data to check whether the target Home Prefix is registered. If registered, the HSS 8b sends the address of the T-PGW 5b managing the target Home Prefix back to the AAA server 8a (step S7011). The AAA server 8a checks whether the address of the T-PGW 5b is stored in the message sent back from the HSS 8b (step S7012). If the address of the T-PGW 5b is stored, a BS instruction to instruct the UE 1 to perform BS is generated (step S7013). Then, the address of the UE 1, the UE_BS_Identity sent from the I-PGW 5a, and the BS instruction generated in step S7013 are sent to the T-PGW 5b (step S7014).

If the address of the T-PGW 5b is not stored in the message sent back from the HSS 8b (step S7012), or if the transfer instruction is not stored in the Home Prefix confirmation request message (step S7010), the result (e.g., False or ‘1’) is sent back to the I-PGW 5a (step S7030).

Further, if an Authentication-Request/Identity message is received from the PGW 5 instead of the Home Prefix confirmation request message (step S7020), a User Profile and AVs (Authentication Vectors) are requested to the HSS 8b and acquired according to the Authentication-Request/Identity message (step S7021). After acquiring the User Profile and AVs, the AAA server 8a sends an EAP-Request/AKA-Challenge message back to the PGW 5 (step S7022). Then, the AAA server 8a receives an EAP-Response/AKA-Challenge message as a return message of the EAP-Request/AKA-Challenge message (step S7023), and sends an Authentication-Answer/EAP-Success+Keying material message as its return message back to the PGW 5 (step S7024).

### Second Embodiment

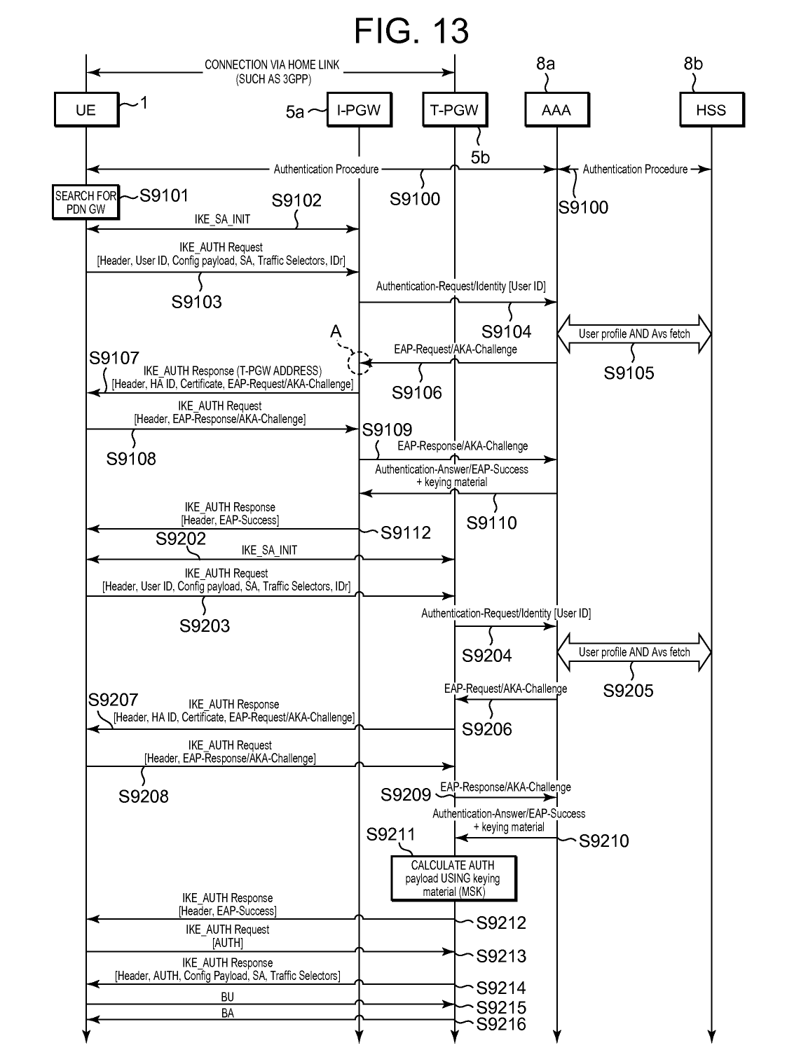

Next, an example of the system operation in a second embodiment of the present invention will be described in detail with reference to FIG. 13. FIG. 13 is a sequence diagram for describing an example of the system operation in the second embodiment of the present invention. FIG. 13 is composed of at least the UE 1, the I-PGW 5a with which the UE 1 does not originally intend to connect, the T-PGW 5b originally desired by the UE 1 to connect, the AAA server 8a as the UE authentication server for determining whether to permit the UE 1 to use each access network, and the HSS 8b as the user information data server.

The following will describe an example of the system operation in the second embodiment of the present invention shown in FIG. 13 in comparison with the prior art. Steps S9101 to S9105 in the processing flow of the second embodiment of the present invention are the same as steps S9001 to S9005 (shown in FIG. 12) of the PDN GW reallocation procedure in the conventional technique.

In the PDN GW reallocation procedure (processing flow shown in FIG. 12) in the conventional technique, the I-PGW 5a receives an EAP-Request/AKA-Challenge message to acquire the address of the T-PGW 5b (step S9006 in FIG. 12). In this case, the existence (address) of the T-PGW 5b is actually notified to the UE 1 at the time of BU/BA exchange performed after SA is established between the UE 1 and the I-PGW 5a (step 9016 in FIG. 12).

On the other hand, in the second embodiment of the present invention, when acquiring the address of the T-PGW 5b at point A shown in FIG. 13 (when the I-PGW 5a receives the EAP-Request/AKA-Challenge message in step S9106 from the AAA server 8a), the I-PGW 5a inserts the address of the T-PGW 5b into an IKE_AUTH Response message, for example (or any other message may be used), to be sent to the UE 1 in step S9107 to notify the UE 1 of the address of the T-PGW 5b acquired in step S9106.

Here, in the second embodiment of the present invention, the address of the T-PGW 5b is notified to the UE 1 while the UE 1 is authenticating the connection with the I-PGW 5a. This is because, when the UE 1 attaches to the N3G access 3, access authentication (step S9100 in FIG. 13) is already performed by the core network 4, and hence the permission to notify the UE 1 of the address of the T-PGW 5b is decided on security of the authentication result.

Thus, according to the second embodiment of the present invention, the UE 1 can grasp the address of the T-PGW 5b at an earlier stage than that in the conventional technique (e.g., at the stage when the address of the T-PGW 5b is extracted from the IKE_AUTH Response message), and hence can recognize that it tries to connect with a PGW 5 (I-PGW 5a) different from the desired the PGW 5 (T-PGW 5b). As a result, the UE 1 can start processing for performing BS again (steps S9202 to S9214: Standard BS) with the T-PGW 5b rather than the I-PGW 5a at an earlier stage than that in the conventional technique so that the UE 1 and the T-PGW 5b can perform BU/BA exchange after SA is established between the UE 1 and the T-PGW 5b (steps S9215 and S9216).

However, when the IKE_AUTH Response message is sent to the UE 1 in step S9107, the AAA server 8a is waiting for response information after sending challenge information for the UE 1, holding the state related to the UE 1 to no small extent. Therefore, as shown in FIG. 13, the UE 1 may need to confirm the completion of BS processing being performed by sending a message corresponding to the IKE_AUTH Request or the like in step S9108 to release the AAA server 8a from waiting and receiving a message corresponding to the IKE_AUTH Response or the like in step S9112 (steps S9108 to S9112).

The UE 1 can perform processing for connection with the T-PGW 5b in steps S9202 to S9216 in parallel with the processing for releasing the AAA server 8a from waiting in steps S9108 to S9112 in order not to delay the connection with the T-PGW 5b due to the processing for releasing the AAA server 8a from waiting. This can reduce the time required to establish SA between the UE 1 and the T-PGW 5b by an amount of time until the message corresponding to the IKE_AUTH Response as a return message to release the AAA server 8a from waiting.

### Third Embodiment

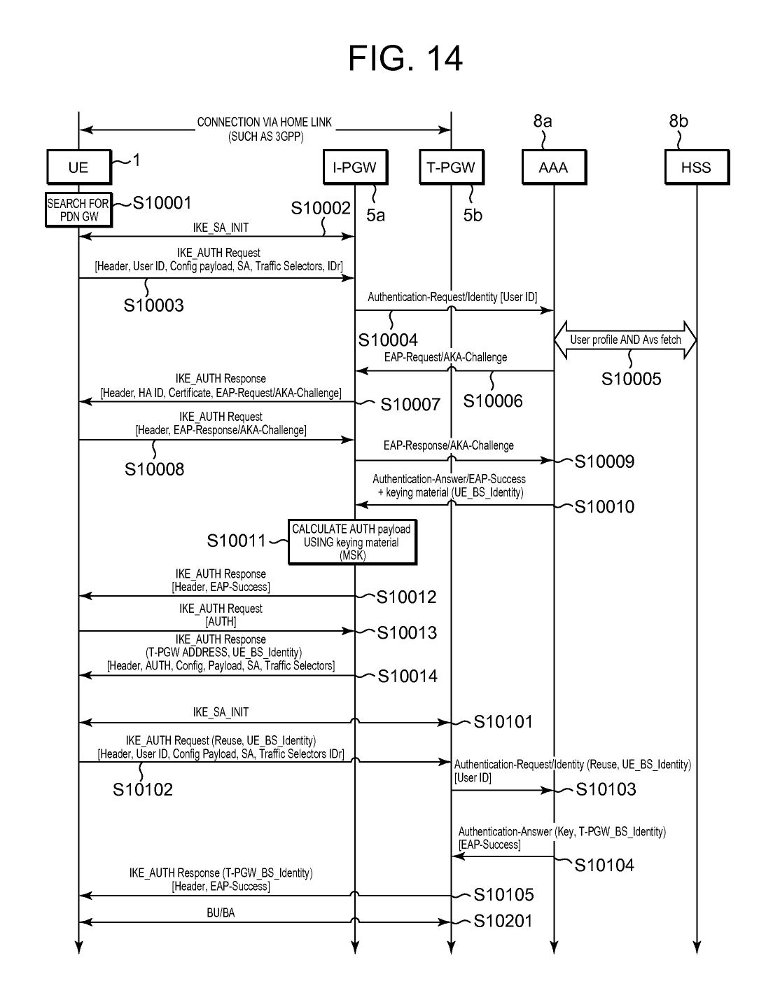

Next, an example of the system operation in a third embodiment of the present invention will be described in detail with reference to FIGS. 14 to 16. FIG. 14 is a first sequence diagram for describing an example of the system operation in the third embodiment of the present invention. Shown in FIG. 14 is an example of a processing sequence performed among at least the UE 1, the I-PGW 5a with which the UE 1 does not originally intend to connect, the T-PGW 5b originally desired by the UE 1 to connect, the AAA server 8a as the UE authentication server for determining whether to permit the UE 1 to use each access network, and the HSS 8b as the user information data server.

In the third embodiment of the present invention, description will be made of a PGW switching method when the address of the T-PGW 5b is notified after completion of exchange of the IKE_AUTH message, i.e., after the UE 1 and the AAA server 8a mutually authenticate each other to create MSK and the created MSK is exchanged between the UE 1 and the I-PGW 5a. The following will describe an example of the system operation in the third embodiment of the present invention shown in FIG. 14 in comparison with the PDN GW reallocation procedure (the processing flow shown in FIG. 12) in the conventional technique.

In FIG. 14, since steps S10001 to S10009 in the processing flow of the third embodiment of the present invention are the same as steps S9001 to S9009 (not shown in FIG. 12) in the PDN GW reallocation procedure of the conventional technique, redundant description will be omitted.

In the following step S9010 in the PDN GW reallocation procedure (shown in FIG. 12) of the conventional technique, the AAA server 8a processes the EAP-Response message sent from the UE 1 via the I-PGW 5a, and sends, to the I-PGW 5a, a key (Master Session key: hereinafter called MSK) necessary to establish SA between the UE 1 and the I-PGW 5a, and the address of the T-PGW 5b as the destination to which the UE 1 switches over (step S9010 in FIG. 12). On the other hand, in the third embodiment of the present invention, an Authentication-Answer message with UE_BS_Identity further added together with the MSK and the address of the T-PGW 5b to be sent from the AAA server 8a to the I-PGW 5a in the conventional technique is sent to the (step S10010 in FIG. 14).

FIG. 18B is a diagram showing an example of the format of the Authentication-Answer message as an example of a response message to be sent from the AAA server 8a to the I-PGW 5a in step S10010 of FIG. 14. The AAA server 8a is provided with an MSK (key) field 4102 and a BS identifier field (UE_BS_Identity/T-PGW_BS_Identity) 4103 in addition to a conventional standard Authentication-Answer message 4101. The MSK (key) field 4102 is a field for sending the I-PGW 5a the key used between the UE 1 and the I-PGW 5a. The AAA server 8a may store the MSK in the MSK (key) field 4102 or in the Authentication-Answer message 4101 without using the MSK (key) field 4102. When the MSK is stored in the Authentication-Answer message 4101, the MSK (key) field 4102 may not be provided in the response message.

The BS identifier field 4103 can notify the PGW 5 of UE_BS_Identity or T-PGW_BS_Identity depending on the intended use. Further, BS_Identity may be described in the existing payload of a standard Authentication-Answer message and notified to the PGW 5. Note that the response message may be any message other than the Authentication-Answer message as long as it can transfer predetermined information.

Since subsequent steps S10011 to S10013 in the processing flow of the third embodiment of the present invention are the same as steps S9011 to S9013 (shown in FIG. 12) in the PDN GW reallocation procedure of the conventional technique, redundant description will be omitted.

Then, in the next step in the PDN GW reallocation procedure of the conventional technique, the address of the T-PGW 5b and the like are sent from the I-PGW 5a to the UE 1 (step S9014 in FIG. 12). On the other hand, in the third embodiment of the present invention, the address of the T-PGW 5b and the UE_BS_Identity notified from the AAA server 8a are notified to the UE 1 through the IKE_AUTH Response message in addition to the MSK conventionally sent from the AAA server 8a to the I-PGW 5a (step S10014 in FIG. 14).

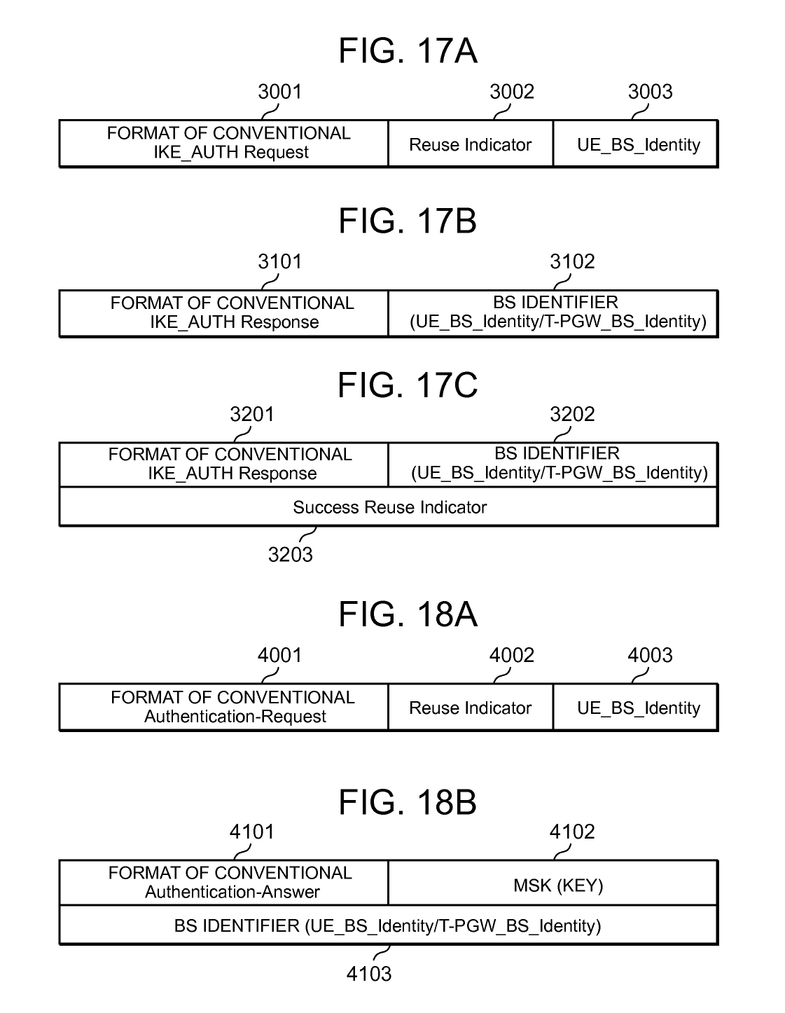

FIG. 17B is a diagram showing the format of the IKE_AUTH Response message as an example of a message sent from T-PGW 5b to the UE 1 in step S10014 of FIG. 14. The T-PGW 5b is provided with a BS identifier (UE_BS_Identity/T-PGW_BS_Identity) field 3102 in addition to a conventional standard IKE_AUTH Response message 3101 so that the T-PGW 5b can notify the UE 1 of respective values. In the BS identifier (BS_Identity) field 3102, the UE_BS_Identity or the T-PGW_BS_Identity can be notified to the PGW 5 depending on the intended use. Further, Notify Payload specified in the standard IKEv2 protocol (see Non-Patent Document 7 cited above) may be added to the standard IKE_AUTH Response message so that T-PGW_BS_Identity will be described and notified to the UE 1. Note that the response message may be any message other than the IKE_AUTH Response message as long as it can transfer predetermined information, but it is desired to send the massage at the same time as the transmission of the IKE_AUTH Response message or after the transmission of the IKE_AUTH Response message.

Here, the address of the T-PGW 5b is notified from the I-PGW 5a to the UE 1 (e.g., notification through IKE_AUTH Response message in step S10014) after MSK is exchanged between the UE 1 and the I-PGW 5a by exchanging IKE_AUTH messages (in steps S10012 and S10013 of FIG. 14), the address of the T-PGW 5b can also be notified to the UE 1 from the network side when the AAA server 8a succeeded in authentication of the UE 1 (i.e., upon completion of the authentication of the UE 1 by the AAA server 8a based on the challenge information received in step S10009). In this case, the address of the T-PGW 5b may be stored in any message (e.g., the message in step S10010 or S10012) and notified to the UE 1 after completion of processing the challenge information received in step S10009.

Subsequently, the UE 1 starts BS processing to establish SA between the UE 1 and the T-PGW 5b. The UE 1 and the T-PGW 5b exchange IKE_SA_INIT messages between the UE 1 and the T-PGW 5b to generate a shared key between the UE 1 and the T-PGW 5b (step S10101 in FIG. 14) in order to protect the IKE_AUTH messages for authenticating the UE 1.

Next, the UE 1 creates an IKE_AUTH Request message, encrypts it using the shared key between the UE 1 and the T-PGW 5b generated through the IKE_SA_INIT messages previously exchanged, and sends it to the T-PGW 5b. Here, reuse of the MSK (key) generated upon the previous establishment of SA between the UE 1 and the I-PGW 5a is requested so that mutual authentication between the UE 1 and the AAA server 8a required after this in the conventional technique can be omitted. Therefore, the UE 1 stores Reuse Indicator indicative of the reuse of the previously generated MSK in the IKE_AUTH Request message and sends the message to the T-PGW 5b (step S10102 in FIG. 14).

The Reuse Indicator may be generated by the I-PGW 5a or the AAA server 8a during bootstrap processing between the UE 1 and the I-PGW 5a and notified to the UE 1. Particularly when the AAA server 8a generates and notifies the Reuse Indicator to the UE 1, the AAA server 8a or the network system including the AAA server 8a can announce to the UE 1 that it supports or permits the reuse of the key, and this allows the UE 1 to request the reuse of the key with certainty and hence to switch to the connection with the desired T-PGW 5b more surely in a short time.

Further, although the AAA server 8a generates and notifies the Reuse Indicator, if the PGW 5 in the domain or the core network 4 does not support or permit it (e.g., for the reason that the UE 1 during roaming is not permitted or the like), the PGW 5 can remove the Reuse Indicator not to notify the UE 1 of it. For example, this can deal with a case where the reuse of the key is not supported or permitted in a network (VPLMN: Visited Public Land Mobile Network) in which the UE 1 exists even if supported or permitted in the home network (HPLMN: Home Public Land Mobile Network) of the UE 1.

Further, the UE 1 stores the UE_BS_Identity in the IKE_AUTH Request message (step S10102 in FIG. 14) to enable the AAA server 8a to identify, at the time of subsequent mutual authentication processing via the T-PGW 5b, that the BS processing comes from the UE 1 that has already completed mutual authentication with the AAA server 8a through the I-PGW 5a.

FIG. 17A is a diagram showing an example of the format of the IKE_AUTH Request message as an example of the message sent from the UE 1 to the T-PGW 5b in step S10102 of FIG. 14. The UE 1 is provided with a Reuse Indicator field 3002 and a BS identifier (UE_BS_Identity) field 3003 for the UE in addition to a conventional standard IKE_AUTH Request message 3001 so that respective values can be notified to the T-PGW 5b. Further, Notify Payload specified in the standard IKEv2 protocol (see Non-Patent Document 7 cited above) may be added to the standard IKE_AUTH Request message so that Reuse Indicator will be described and notified to the UE 1. Note that the message may be any message other than the IKE_AUTH Request message as long as it can transfer predetermined information.

The T-PGW 5b transfers the Reuse indicator and the UE_BS_Identity included in the IKE_AUTH Request message sent from the UE 1 to the AAA server 8a (FIG. 14, step S10103). The Reuse Indicator and the UE BS Identity may be such that the UE 1 notifies the T-PGW 5b of them through the IKE_SA_INIT message and the T-PGW 5b notifies the AAA server 8a of the parameters in parallel with the exchange of IKE SA INIT messages.

FIG. 18A is a diagram showing an example of the format of the Authentication-Request message as an example of the message sent from the T-PGW 5b to the AAA server 8a in step S10103 of FIG. 14. The T-PGW 5b is provided with a Reuse Indicator field 4002 and a BS identifier (UE_BS_Identity) field 4003 for the UE in addition to a conventional standard Authentication-Request message 4001 so that respective values can be notified to the AAA server 8a. Further, Reuse Indicator and UE_BS_Identity may be described in existing payload of the standard Authentication-Request message and notified to the AAA server 8a. The message may be any message other than the Authentication-Request message as long as it can transfer predetermined information.

The AAA server 8a receives the Reuse indicator transferred from the T-PGW 5b, determines that reuse of the MSK obtained when SA has previously been established between the UE 1 and the I-PGW 5a is requested, and notifies the T-PGW 5b of the MSK corresponding to the UE_BS_Identity held by the AAA server 8a. The UE_BS_Identity may be replaced by a parameter (e.g., User ID) capable of confirming that the UE 1 has once completed full authentication. T-PGW_BS_Identity corresponding to the UE_BS_Identity is also notified at the same time as the notification of the MSK (step S10104 in FIG. 14). The T-PGW_BS_Identity may be generated by the AAA server 8a itself, or if a database server (not shown) holding a BS_Identity list is placed on the network, a query may be sent to the database server to acquire and use the T-PGW BS_Identity corresponding to the UE BS Identity.

Here, it is considered that the T-PGW 5b notifies the AAA server 8a of its own information (e.g., the IP address or the identifier of the PGW 5) in step S10103 to deal with a case where the reuse of the MSK is permitted only for a switching connection to a different PGW 5 previously instructed (i.e., when the reuse of the MSK is not permitted for a connection from any PGW 5). This enables the AAA server 8a to confirm that the connection request is a request for a switching connection to the T-PGW 5b previously instructed to the UE 1, and hence permit the reuse of the MSK properly.

FIG. 18B is a diagram showing an example of the format of the Authentication-Answer message as an example of the message sent from the AAA server 8a to the T-PGW 5b in step S10104 of FIG. 14. The AAA server 8a is provided with an MSK (key) field 4102 and a BS identifier field (UE_BS_Identity/T-PGW_BS_Identity) 4103 in addition to a conventional standard Authentication-Answer message 4101. In step S10104, the MSK generated between the UE 1 and the I-PGW 5a is stored in the MSK (key) field 4102. This MSK may be stored in a field for storing the MSK in the standard Authentication-Answer message 4101. In this case, there is no need to newly provide the MSK (key) field 4102. The BS identifier field 4103 can notify the PGW 5 of the UE_BS_Identity and/or the T-PGW_BS_Identity depending on the intended use. Further, the BS_Identity may be described in existing payload of the standard Authentication-Answer message and notified to the T-PGW 5b. The response message may be any message other than the Authentication-Answer message as long as it can transfer predetermined information.

Subsequently, the T-PGW 5b stores, in the IKE AUTH Response message, an AUTH parameter value, which is generated using the MSK notified from the AAA server 8a (actually generated upon establishment of SA between the UE 1 and the I-PGW 5a), and T-PGW_BS_Identity for causing the UE 1 to identify properly that the AAA server 8a that authorized the reuse is the same node as that serving the UE 1 upon the previous connection with the I-PGW 5a, and sends the IKE AUTH Response message to the UE 1 (step S10105 in FIG. 14). Here, since the UE 1 already generates the MSK through steps S10012 to S10014, it is enough in step S10105 to convey only the success of the authentication (because it is a notification indicating that the reuse of the MSK is authorized as well as the success of the authentication).

FIG. 17B is a diagram showing an example of the format of the IKE_AUTH Response message as an example of the message sent from the T-PGW 5b to the UE 1 in step S10105 of FIG. 14. The T-PGW 5b is provided with a BS identifier (BS_Identity) field 3102 in addition to a conventional standard IKE_AUTH Response message 3101 so that respective values can be notified to the UE 1. Further, Notify Payload specified in the standard IKEv2 protocol (see Non-Patent Document 7 cited above) may be added to the standard IKE_AUTH Response message so that the T-PGW_BS_Identity will be described and notified to the UE 1. Note that the response message may be any message other than the IKE_AUTH Response message as long as it can transfer predetermined information.

The UE 1 that received the IKE AUTH Response message verifies a correlation between the UE_BS_Identity and the T-PGW_BS_Identity to perform BU/BA exchange with the T-PGW 5b if it can confirm that both are correlated properly (step S10201 in FIG. 14).

The above-described UE_BS_Identity and T-PGW_BS_Identity are useful for simplified mutual authentication between the UE 1 and the AAA server 8a. However, when such mutual authentication is unnecessary, or when mutual authentication can be performed separately, these BS_Identity identifiers can be omitted.

Further, when the AAA server 8a can keep its state for the UE 1 after sending the instruction to switch to the T-PGW 5b, the Reuse Indicator notified by the UE 1 can also be omitted. In this case, the AAA server 8a identifies the UE 1 based on the User ID or the like, extracts key data based on the state in which the AAA server 8a is kept for the UE 1, and notifies the T-PGW 5b of the key data. However, since it is also contemplated that some AAA servers 8a may release themselves from being in the state for the UE 1 after sending the switching instruction, it is useful to notify the Reuse Indicator from the UE 1 in order to ensure general versatility.

According to the above-mentioned operation, the key is reused in the manner mentioned above so that the number of messages for bootstrap processing when the UE 1 switches the connection to the T-PGW 5b and the time required for switching can be reduced, compared to the PDN GW reallocation procedure of the conventional technique, in which it is necessary to perform UE authentication between the UE 1 and the AAA server 8a twice for the I-PGW 5a and the T-PGW 5b (Full Authentication).

If the UE 1 has a past record of the establishment of SA with another PGW 5, switching between PGWs 5 can be requested to the UE 1 (i.e., notification of the address of a PGW 5 (T-PGW 5b) as the switching destination) before step S10014 described above (e.g., in step S10007 or the like of FIG. 14). For example, the UE 1 sends the IKE AUTH Request message in step S10003 by including therein the Reuse Indicator sent in step S10102. The I-PGW 5a that referred to this Reuse Indicator acquires, from the AAA server 8a, a key already established for the UE 1 according to the same procedure as step S10103 and S10104 in the processing steps S10004 to S10006 (at this time, the address of the switching destination PGW 5 is also acquired at the same time). Then, the I-PGW 5a sends the UE 1 an IKE_AUTH response message including the address of the switching destination PGW 5 (i.e., an equivalent message to the IKE_AUTH response message sent in step S10105 mentioned above) in step S10007 so that the address of the switching destination PGW 5 can be notified to the UE 1. This enables the UE 1 to reuse the key established in the past in order to acquire the address of the switching destination PGW 5 fast, and hence to switch the connection to a desired PGW 5 fast even if a PGW 5 originally undesired to connect is allocated.

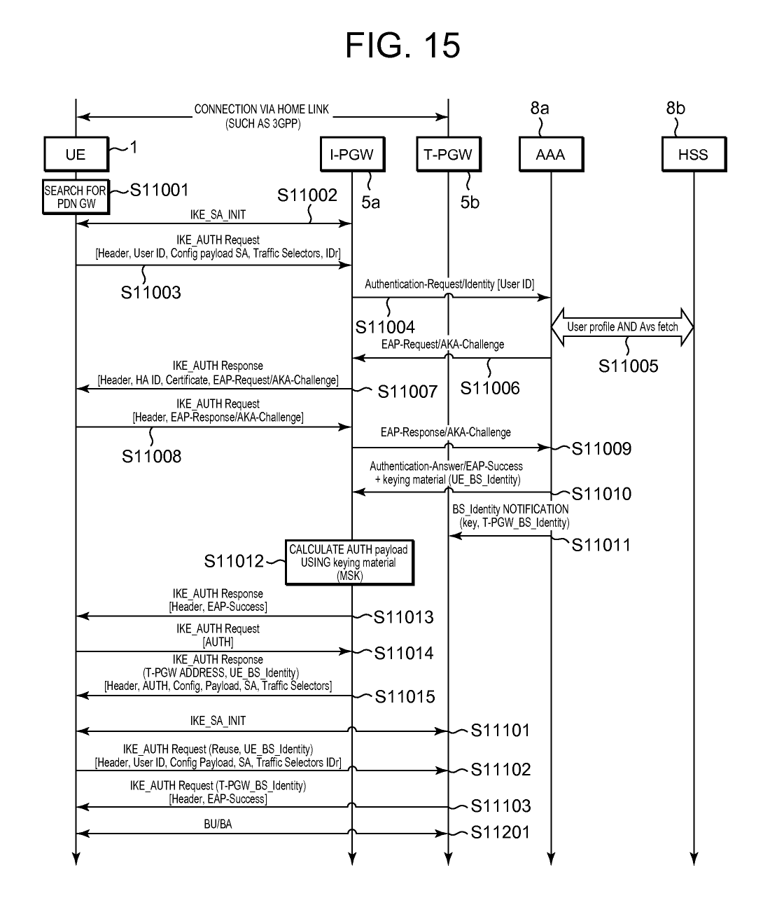

The AAA server 8a may also notify the T-PGW 5b of the MSK generated at the timing of being instructed to switch to the T-PGW 5b (in step S10010 of FIG. 14). Specifically, description will be made with reference to FIG. 15.

FIG. 15 is a second sequence diagram for describing an example of the system operation in the third embodiment of the present invention. Shown in FIG. 15 is an example of a processing sequence performed among at least the UE 1, I-PGW 5a with which the UE 1 does not originally intend to connect, the T-PGW 5b originally desired by the UE 1 to connect, the AAA server 8a as the UE authentication server for determining whether to permit the UE 1 to use each access network, and the HSS 8b as the user information data server.

Since steps S11001 to S11010 in a processing flow of FIG. 15 are the same as steps S10001 to S10010 in the processing flow of FIG. 14, redundant description will be omitted. The AAA server 8a can notify the T-PGW 5b of the MSK at the stage of step S11010. For example, as a technique in which the AAA server 8a notifies the T-PGW 5b of the MSK, the MSK generated in the process of establishing SA between the UE 1 and the I-PGW 5a and T-PGW_BS_Identity corresponding to the UE_BS_Identity are sent to the T-PGW 5b simultaneously with the processing for sending the I-PGW 5a the Authentication-Answer message with the UE_BS_Identity stored therein (step S11011 in FIG. 15).

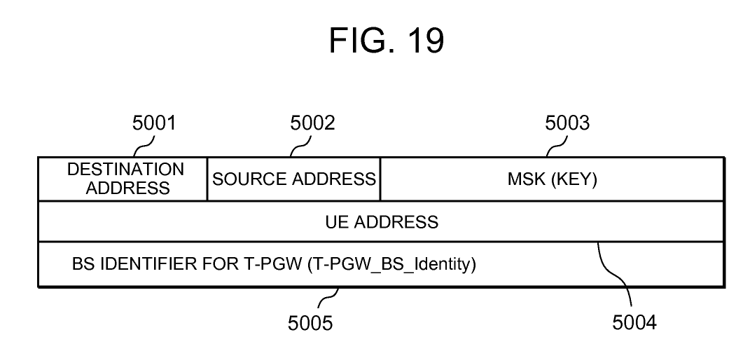

FIG. 19 is a diagram showing an example of the format of a BS_Identity notification message as an example of a message sent from the AAA server 8a to the T-PGW 5b in step S11011 of FIG. 15. The AAA server 8a describes the address of the T-PGW 5b in a destination address field 5001, its own address in a source address field 5002, the generated between the UE 1 and the I-PGW 5a in an MSK (key) field 5003, the address of the UE 1 (e.g., CoA of the UE 1) corresponding to the MSK in a UE address field 5004, and T-PGW_BS_Identity corresponding to the UE_BS_Identity in a T-PGW_BS_Identity field 5005, and sends the message to the T-PGW 5b. As the BS_Identity notification message, a conventional Authentication-Request/Identity message or the like may be extended and used. The User ID of the UE 1 may also be included in the BS_Identity notification message. This makes it easy for the T-PGW 5b to judge whether the UE 1 is a UE the full authentication of which has been completed when receiving the IKE_AUTH Request message from the UE 1, and hence enables the T-PGW 5b to check the UE 1 more surely.

Since the following steps S11012 to S11102 in the processing flow of FIG. 15 are the same as steps S10012 to S10102 in the processing flow of FIG. 14, redundant description will be omitted.

The T-PGW 5b that received the IKE_AUTH Request message with the Reuse Indicator and the UE_BS_Identity stored therein (corresponding to step S10102 in FIG. 15) sends an IKE_AUTH Response message storing the T-PGW_BS_Identity received from the AAA server 8a in step S11011 back to the UE 1 (step S11103 in FIG. 15). Note that the T-PGW 5b may check whether the UE_BS_Identity received in step S11102 properly corresponds to the T-PGW_BS_Identity received in step S11011 (such as to check the hash value or query the database managing the BS_Identity list on the network). Further, since the UE 1 already acquired the MSK in step S11013 from the IKE_AUTH Response message, the T-PGW 5b does not need to send in step S11103 an IKE_AUTH Response message with the MSK stored therein. However, for example, since there is a possibility that the UE 1 may not hold the MSK for some reason (e.g., the UE 1 may already discard the MSK), the T-PGW 5b may store the MSK in an IKE_AUTH Response message to be sent in step S11103 to notify the UE 1 of the MSK so that the UE 1 can grasp the MSK with certainty.

The format example of the IKE_AUTH Response message as an example of the response message sent from the T-PGW 5b to the UE 1 in step S11103 of FIG. 15 is shown in FIG. 17B. Since this is the same as the format example of the IKE_AUTH Response message in step S10105 of FIG. 14, redundant description will be omitted.

The UE 1 that received the IKE AUTH Response message verifies a correlation between the UE_BS_Identity and the T-PGW_BS_Identity to perform BU/BA exchange with the T-PGW 5b if it can confirm that both are correlated properly (step S11201 in FIG. 15). Thus, since the AAA server 8a notifies the T-PGW 5b of the MSK in advance, when the UE 1 switches its connection to the T-PGW 5b, a high-speed switching connection can be made compared with a case where the T-PGW 5b acquires the MSK from the AAA server 8a.

If the T-PGW 5b receives and processes the IKE_AUTH Request message from the UE 1 before the AAA server 8a notifies the T-PGW 5b of the MSK, the T-PGW 5b will request the AAA server 8a to perform full authentication on the UE 1 again, increasing the time required until the connection is established. To avoid this, the UE 1 may send the T-PGW 5b an IKE_AUTH Request message including the Reuse indicator as described with reference to FIG. 14 (step S11102 in FIG. 15) so that the T-PGW 5b will make a inquiry to the AAA server 8a if it has not acquired the MSK from the AAA server 8a yet. This can make the reuse of the MSK more reliably, achieving a speedup of the switching connection.

The above-mentioned UE_BS_Identity and T-PGW_BS_Identity are useful to perform simplified mutual authentication between the UE 1 and the AAA server 8a, and to enable the AAA server 8a to judge whether the connection request from the UE 1 sent this time results from switching the connection to the T-PGW 5b previously instructed or is for connection to a new PGW 5 in order to ensure the reuse of the MSK. However, these BS_Identity identifiers can be omitted when such mutual authentication is unnecessary, or when mutual authentication can be performed separately, or when it can be confirmed that the connection request results from switching to the T-PGW 5b by a method of causing the AAA8a to compare the APN (Access Point Name) or the like included in the connection request from the UE 1 with that notified by the previous connection request (via the I-PGW 5a).

Further, in an ideal state, since the T-PGW 5b can acquire a key sent from the AAA server 8a toward the UE 1 before receiving the IKE_AUTH Request message from the UE 1 and the T-PGW 5b can recognize reuse of the key at this point, the Reuse Indicator notified by the UE 1 can be omitted. However, it is useful to add the Reuse Indicator in order to urge the T-PGW 5b to perform processing based on a sequence for reusing the key, rather than processing based on the conventional sequence on the assumption that the notification from the AAA server 8a could get behind the arrival of the IKE_AUTH Request message from the UE 1 as mentioned above.

As described in the above second embodiment, the UE 1 may be notified of the address of the T-PGW 5b as the switching destination PGW 5 while being connecting with the I-PGW 5a (step S9107 in FIG. 13). However, in the second embodiment, the UE 1 performs steps S9108 to S9112 to release the state of the AAA server 8a. In this case, it can be considered that, if the authentication processing (MSK generation) performed by the AAA server 8a is completed substantially in this step interval to reuse the authentication data (MSK or the like) at the time of switching connection with the T-PGW 5b, the effect of reducing processing time can be more expected as a whole. Therefore, when the UE 1 according to the third embodiment is notified of the address of the switching destination PGW 5 while being connecting with the I-PGW 5a, the UE 1 can continue the authentication processing without making a request for releasing the state of the AAA server 8a in step S9108 of FIG. 13. In other words, although processing step S9108 and following steps in FIG. 13 are replaced by step S10008 and following steps in FIG. 14, since the address of the T-PGW 5b is already notified to the UE 1 in step S9107, there is no need to notify it again in step S10014 of FIG. 14.

Next, a configuration and processing flow of a mobile terminal (UE 1) according to the third embodiment of the present invention will be described. Since the configuration of the mobile terminal (UE 1) according to the third embodiment of the present invention is the same as the configuration of the mobile terminal (UE 1) according to the first and second embodiments of the present invention (see FIG. 3), redundant description will be omitted.

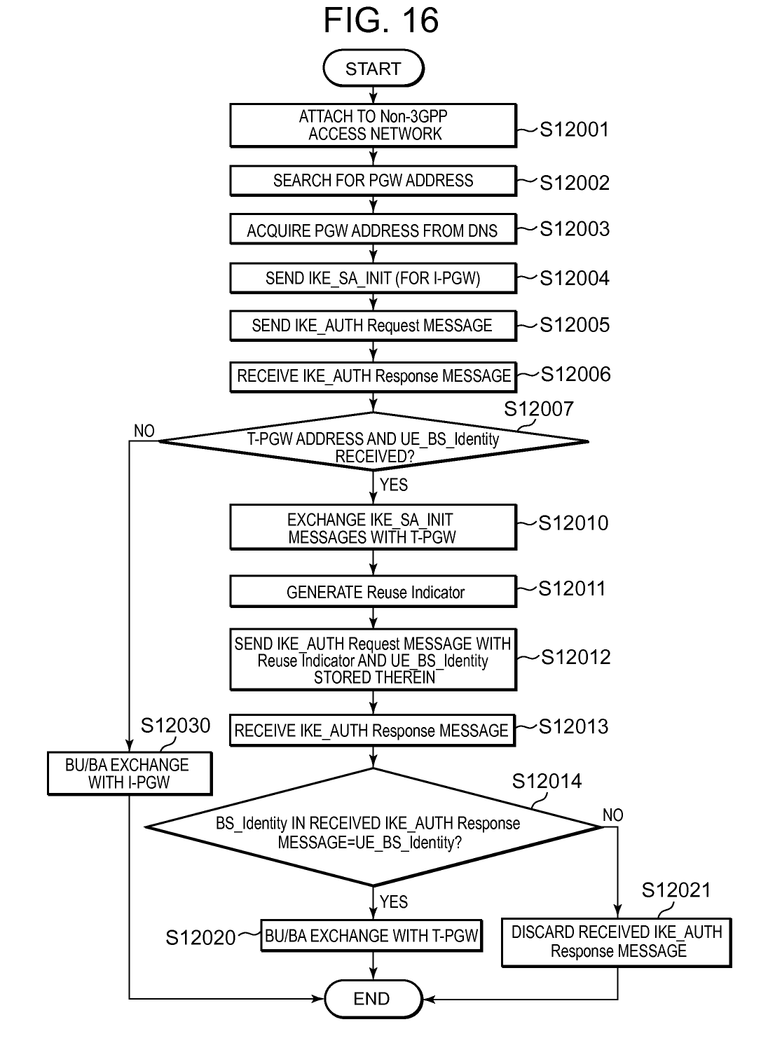

Referring next to FIG. 16, the processing flow of the UE 1 having the configuration shown in FIG. 3 will be described in detail, focusing on processing related to the connection control unit 106 for performing processing that is a characteristic feature of the present invention. FIG. 16 is a flowchart showing an example of the processing flow of the UE1 according to the third embodiment of the present invention. It is assumed that the UE 1 is already attached to the 3G access 2 (home link) through the first radio communication unit 101 and connected to the T-PGW 5b.

The connection control unit 106 according to the present invention first instructs the second radio communication unit 102 to start connection in order to start an attach procedure to the N3G access 3 (step S12001). The second radio communication unit 102 performs connection processing according to a connection procedure in the N3G access 3. Upon completion of the attachment to the N3G access 3, the connection control unit 106 instructs the DNS client processing unit 105 to start searching to search for a PGW 5 to be connected via the N3G access 3 (step S12002). At this time, the connection control unit 106 builds a home agent name (FQDN) by a standard method (e.g., the method described in Non-Patent Document 6) from the APN as the identifier of the destination network PDN, a HA-APN for identifying the PGW 5, or the like to acquire the address of the destination PGW 5, and notifies the DNS client processing unit 105 of the home agent name. The DNS client processing unit 105 sends a DNS query describing the notified home agent name to the DNS server 9 via the packet processing unit 103 and the second radio communication unit 102. As its response, the DNS client processing unit 105 receives a DNS response from the DNS server 9 via the second radio communication unit 102 and the packet processing unit 103, and transfer a PGW address acquired from the DNS response to the connection control unit 106 (step S12003).

The connection control unit 106 instructs the BS processing unit 104 to start normal BS processing on the PGW address acquired. The BS processing unit 104 starts IKE_SA_INIT processing, as a procedure for establishing IKE SA, on the PGW address (the address of the I-PGW 5a) notified from the connection control unit 106 (step S12004). When the IKE_SA_INIT processing is completed and IKE SA is established, the BS processing unit 104 sends an IKE_AUTH Request message (step S12005).

The IKE_AUTH Request message is sent from the BS processing unit 104 to the I-PGW 5a through the packet processing unit 103 and the second radio communication unit 102. The I-PGW 5a sends the UE 1 an IKE_AUTH Response message as a response to the IKE_AUTH Request message. The IKE_AUTH Response message received at the UE 1 is transferred to the BS processing unit 104 through the second radio communication unit 102 and the packet processing unit 103 (step S12006).

When SA between the UE 1 and the I-PGW 5a is established, it is reported to the UE 1 that switching from the I-PGW 5a to the T-PGW 5b is required. Specifically, it is checked whether the address of the T-PGW 5b as the destination PGW 5 and code of UE_BS_Identity for making data of authentication, which is completed by the AAA server 8a for the UE 1 through the I-PGW 5a, usable upon switching the connection to the T-PGW 5b have been received (step S12007).

When the UE 1 does not receive the address of the T-PGW 5b and the UE_BS_Identity, since it means that switching between PGWs 5 has not been requested, the UE 1 performs BU/BA exchange with the I-PGW 5a using the established SA (step S12030).

On the other hand, when the UE 1 receives the address of the T-PGW 5b and the UE_BS_Identity, the UE 1 starts switching the connection to the T-PGW 5b. In other words, the UE 1 starts to establish SA with the T-PGW 5b. First, the UE 1 exchanges IKE_SA_INIT messages with the T-PGW 5b to generate a shared key between the UE 1 and the T-PGW 5b that is necessary to protect the IKE_AUTH messages (step S12010).

Subsequently, in establishing SA with the T-PGW 5b, the UE 1 generates a Reuse Indicator indicative of reuse of the MSK generated in establishing SA with the I-PGW 5a to omit the full authentication conventionally performed in order to reduce the connection time (step 12011). Note that step S12010 and step S12011 may be executed in reverse order. The UE 1 stores the generated Reuse Indicator and the previously acquired UE_BS_Identity in an IKE_AUTH Request message, and sends the IKE_AUTH Request message to the T-PGW 5b (step S12012).

When receiving the IKE_AUTH Request message in which the Reuse Indicator and the UE_BS_Identity are stored, the T-PGW 5b forwards it to the AAA server 8a. When receiving the IKE_AUTH Request message forwarded from the T-PGW 5b, the AAA server 8a confirms that the Reuse Indicator and the UE_BS_Identity are stored, and notifies the T-PGW 5b of the MSK generated when the UE 1 is connected through the I-PGW 5a and T-PGW_BS_Identity corresponding to the UE_BS_Identity through an Authentication-Answer message, for example. The AAA server 8a may notify the T-PGW 5b of the MSK and the T-PGW_BS_Identity as a response to the IKE_AUTH Request message (corresponding to the first sequence shown in FIG. 14), or notify the T-PGW 5b of the MSK and the T-PGW_BS_Identity prior to the response to the IKE_AUTH Request message (corresponding to the second sequence shown in FIG. 15). The T-PGW 5b that received the MSK and the T-PGW_BS_Identity sends the UE 1 an IKE_AUTH Response message with the T-PGW_BS_Identity stored therein, and then the UE 1 receives the IKE_AUTH Response message (step S12013).

The UE 1 checks whether the BS_Identity stored in the IKE_AUTH Response message corresponds to the UE_BS_Identity (step S12014). After receiving the UE_BS_Identity in step S12007, the UE 1 may generate and hold T-PGW_BS_Identity corresponding to the UE_BS_Identity at any timing, or generate it at the timing of step S12014 (e.g., by using the hash function or the database server holding the BS_Identity list).

Here, if the T-PGW_BS_Identity sent from the T-PGW 5b matches the T-PGW_BS_Identity generated by the UE 1, the UE 1 performs BU/BA exchange with the T-PGW 5b and ends the processing (step S12020). On the other hand, if they do not match, the UE 1 discards the received IKE_AUTH Response message (step S12021).

Even if the AAA server 8a notifies the T-PGW 5b in advance of information such as the MSK or the like as shown in FIG. 15, it is desired that the UE 1 should send the T-PGW 5b the IKE_AUTH_Request message with the Reuse Indicator and the UE_BS_Identity stored therein. In this case, even if the T-PGW 5b does not recognize reuse of key data (MSK) (omission of full authentication) due to a delay or loss of the notification of the BS_Identity from the AAA server 8a to the T-PGW 5b (in step S11011 of FIG. 15), the MSK can be reused over the T-PGW 5b, and this makes the reduction in the time for switching the connection more reliable.

Further, when the AAA server 8a notifies the T-PGW 5b in advance of information such as the MSK or the like in the second sequence shown in FIG. 15, if the system guarantees that there is no delay or loss of the notification of the BS_Identity from the AAA server 8a to the T-PGW 5b (in step S11011 of FIG. 15), the User Identity or the address of the UE 1 can be used instead of the Reuse Indicator to eliminate the need for the UE 1 to generate the Reuse Indicator in step S12011 of FIG. 16 and store it in the IKE_AUTH_Request message in step S12012.

Furthermore, if the AAA server 8a can confirm that the connection request is intended to switch to the T-PGW 5b by a method such as to compare the APN (Access Point Name) or the like included in the connection request from the UE 1 with that notified through the previous connection request (via the I-PGW 5a), since the UE_BS_Identity is no longer necessary, the notification to the UE 1 in step S12007 of FIG. 16 will not be made. At this time, the UE 1 has only to perform standard BS processing on the T-PGW 5b (not shown in FIG. 16), so that the reuse of the MSK can be determined on the network side, thereby completing the switching connection to the T-PGW 5b in a short time.

Like in the above-mentioned first embodiment, various combinations of UE_BS_Identity and T-PGW_BS_Identity used in the third embodiment of the present invention are also possible. For example, in the third embodiment of the present invention, the UE_BS_Identity and T-PGW_BS_Identity corresponding to this UE_BS_Identity may be used to check the UE_BS_Identity against the T-PGW_BS_Identity, or either of the BS_Identity identifiers may be used, or no BS_Identity may be used. Further, for example, in the third embodiment of the present invention, information used as the UE_BS_Identity or T-PGW_BS_Identity can also be (but not limited to) a value (code) recognizable by the UE 1 and the PGW 5, such as a hash value generated based on a value shared between the UE 1 and the PGW 5, a value generated at random, or the address of the I-PGW 5a. Further, in the third embodiment of the present invention, the UE_BS_Identity or the T-PGW_BS_Identity may also be generated by the PGW 5, the AAA server 8a, or any other communication device.

Note that the MSK used in the third embodiment of the present invention may be the same as MSK defined in a RFC by the IETF (Internet Engineering Task Force) as the organization for standardization of Internet technologies, or may be provided separately.

### Fourth Embodiment

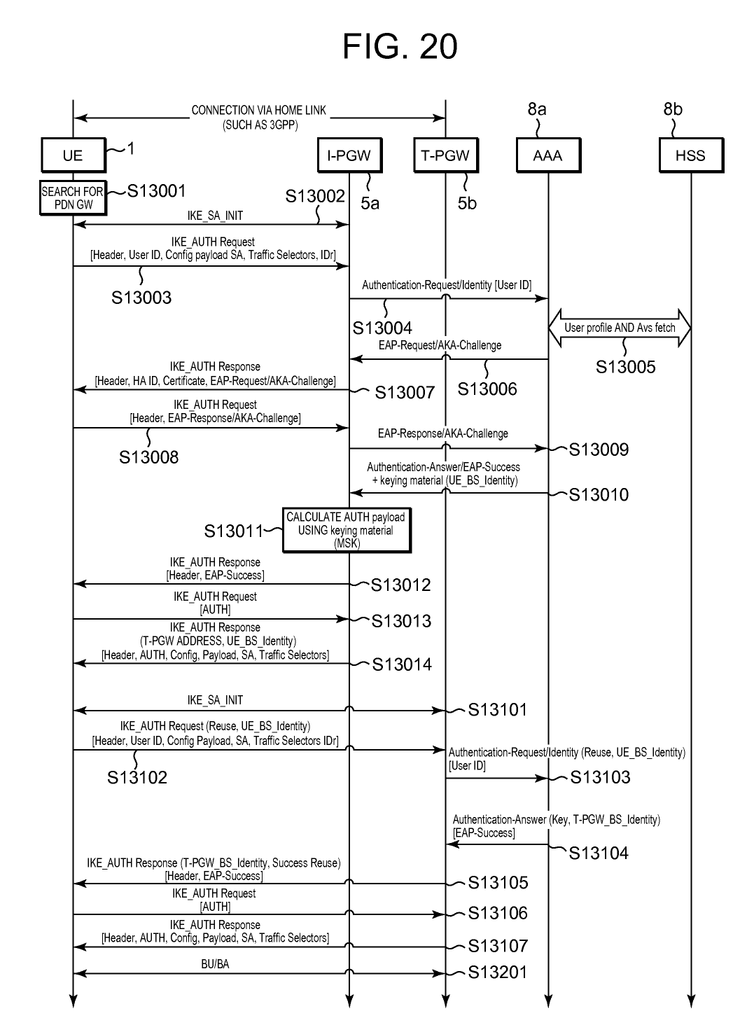

Next, an example of the system operation in a fourth embodiment of the present invention will be described with reference to FIG. 17C, and FIG. 20 to FIG. 25. FIG. 20 is a first sequence diagram for describing an example of the system operation in the fourth embodiment of the present invention. Shown in FIG. 20 is an example of a processing sequence performed among at least the UE 1, the I-PGW 5a with which the UE 1 does not originally intend to connect, the T-PGW 5b originally desired by the UE 1 to connect, the AAA server 8a as the UE authentication server for determining whether to permit the UE 1 to use each access network, and the HSS 8b as the user information data server.

In the fourth embodiment of the present invention, a method of switching PGWs will be described when the address of the T-PGW 5b is notified after completion of exchange of IKE_AUTH messages, i.e., after MSK is generated as a result of success in the mutual authentication between the UE 1 and the AAA server 8a (authentication of the UE 1 by the AAA server 8a), an AUTH parameter created by using the MSK is exchanged between the UE 1 and the I-PGW 5a, and they authenticate each other (for example, authentication of IKE_SA_INIT messages (the source UE 1 and the PGW 5) using the AUTH parameter stored in the IKE_AUTH message, or confirmation of the authentication method by checking for the correctness of the IKE_SA_INIT messages (the source UE 1 and the PGW 5), or confirmation of the key).

The example of the system operation in the fourth embodiment of the present invention shown in FIG. 20 will be described below in comparison with the PDN GW reallocation procedure (the processing flow shown in FIG. 12) as the conventional technique.

In FIG. 20, since steps S13001 to S13009 in a processing flow of the fourth embodiment of the present invention are the same as steps S9001 to S9009 (shown in FIG. 12) in the PDN GW reallocation procedure of the conventional technique, redundant description will be omitted.

In the next step S9010 in the PDN GW reallocation procedure (shown in FIG. 12) of the conventional technique, the AAA server 8a processes the EAP-Response message sent from the UE 1 via the I-PGW 5a (corresponding to the PGW 5 in FIG. 12), and sends the I-PGW 5a (corresponding to the PGW 5 in FIG. 12) a key (Master Session key, hereinafter called MSK) necessary to establish SA between the UE 1 and the I-PGW 5a (corresponding to the PGW 5 in FIG. 12) and the address of the T-PGW 5b as a destination to which the UE 1 switches over (step S9010 in FIG. 12). On the other hand, in the fourth embodiment of the present invention, UE_BS_Identity is further added to an Authentication-Answer message together with the MSK and the address of the T-PGW 5b conventionally sent from the AAA server 8a to the I-PGW 5a, and the Authentication-Answer message is sent to the I-PGW 5a (step S13010 in FIG. 20). This UE_BS_Identity is used to prove that the UE 1 has performed full authentication with the I-PGW 5a (for example, to check for the presence or absence of association with the T-PGW_BS_Identity held by the AAA server 8a, and if the UE_BS_Identity is encrypted, whether it can be decoded). However, the UE_BS_Identity may be omitted if it can be identified by using information specific to the UE 1 (e.g., IMSI (International Mobile Subscriber Identity) or the like).

In step S13010 of FIG. 20, since a response message sent from the AAA server 8a to the I-PGW 5a is the same as the message (shown in FIG. 18B) used in step S10010 of FIG. 14 in the third embodiment of the present invention, redundant description will be omitted. The response message may be any message other than the Authentication-Answer message as long as it can transfer predetermined information.

Further, since the subsequent steps S13011 to S13013 in the processing flow in the fourth embodiment of the present invention are the same as steps S9011 to S9013 (shown in FIG. 12) in the PDN GW reallocation procedure of the conventional technique, redundant description will be omitted.

In the next step in the PDN GW reallocation procedure of the conventional technique, the address of the T-PGW 5b and the like are sent from the I-PGW 5a to the UE 1 (step S9014 in FIG. 12). On the other hand, in the fourth embodiment of the present invention, the UE 1 is notified, through an IKE_AUTH Response message, of UE_BS_Identity notified from the AAA server 8a together with the address of the T-PGW 5b conventionally sent from the AAA server 8a to the I-PGW 5a (step S13014 in FIG. 20). If the I-PGW 5a did not receive the UE_BS_Identity from the AAA server 8a in step S13010, there is no need to store the UE_BS_Identity in the IKE_AUTH Response message.

Referring next to FIG. 17B, an example of the format of the IKE_AUTH Response message will be described as an example of a message sent from the T-PGW 5b to the UE 1 in step S13014 of FIG. 20.

The T-PGW 5b is provided with the BS identifier (BS_Identity) field 3102 in addition to the conventional standard IKE_AUTH Response message 3101 so that respective values can be notified to the UE 1. Further, Notify Payload specified in the standard IKEv2 protocol (see Non-Patent Document 7 cited above) may be added to the standard IKE_AUTH Response message so that the UE_BS_Identity or the like will be described and notified to the UE 1. Note that the response message may be any message other than the IKE_AUTH Response message as long as it can transfer predetermined information, but it is desired to send the message at the same time as the transmission of the IKE_AUTH Response message or after the transmission of the IKE_AUTH Response message.

Here, the address of the T-PGW 5b is notified from the I-PGW 5a to the UE 1 (for example, notification in step S13014 through the IKE_AUTH Response message) after mutual authentication between the UE 1 and the I-PGW 5a as a result of exchanging IKE_AUTH messages (step S13013 and S13014 in FIG. 20) (for example, authentication of IKE_SA_INIT messages (the source UE 1 and the PGW 5) using the AUTH parameter stored in the IKE_AUTH message, or confirmation of the authentication method by checking for the correctness of the IKE_SA_INIT messages (the source UE 1 and the PGW 5), or confirmation of the key). Alternatively, the address of the T-PGW 5b can also be notified to the UE 1 from the network side by storing the address of the T-PGW 5b in any message when the AAA server 8a succeeds in the authentication of the UE 1 (i.e., when the AAA server 8a completes the authentication of the UE 1 based on the challenge information received in step S13009). In this case, the address of the T-PGW 5b may be notified to the UE 1 by storing it in any message (for example, the message in step S13012) after completion of processing the challenge information received in step S13009.

Then, the UE 1 starts BS processing to establish SA between the UE 1 and the T-PGW 5b. The UE 1 and the T-PGW 5b exchange IKE_SA_INIT messages between the UE 1 and the T-PGW 5b to protect IKE_AUTH messages between the UE 1 and the T-PGW 5b to generate or acquire a shared key (e.g., SKEYSEED) between the UE 1 and the T-PGW 5b (step S13101 in FIG. 20) (see Non-Patent Document 7 cited above). After the shared key between the UE 1 and the T-PGW 5b is generated, the UE 1 and the T-PGW 5b use the shared key or the like to generate a key (e.g., SK_ei, SK_er) used to encrypt packets (see Non-Patent Document 7 and Non-Patent Document 8 cited above). As the method of generating a key or the like used to encrypt packets, any other method may be used if the key or the like used to encrypt packets using a method other than exchange of IKE_SA_INIT messages can be generated.

Next, the UE 1 creates an IKE_AUTH Request message, encrypts the IKE_AUTH Request message using the key previously generated between the UE 1 and the T-PGW 5b through exchange of IKE_SA_INIT messages, and sends it to the T-PGW 5b. Here, reuse of the MSK (key) previously generated upon establishment of SA between the UE 1 and the I-PGW 5a can be requested to omit mutual authentication between the UE 1 and the AAA server 8a (steps S13005 to S13009 in FIG. 20), generation of the MSK (step S13010 in FIG. 20), and the like required after that in the conventional technique. Therefore, the UE 1 sends the T-PGW 5b an IKE_AUTH Request message with the Reuse Indicator indicative of reuse of the MSK previously generated and the UE_BS_Identity received from the I-PGW 5a therein (step S13102 in FIG. 20).

The Reuse indicator may also be generated by the I-PGW 5a or the AAA server 8a in the process of bootstrapping between the UE 1 and the I-PGW 5a and notified to the UE 1. Especially, when the AAA server 8a generates the Reuse indicator and notifies the UE 1 of it, the AAA server 8a or the network system including the AAA server 8a can announce to the UE 1 that it supports or permits the reuse of the key. This enables the UE 1 to make a request for reuse of the key with certainty, and hence to switch the connection to the desired T-PGW 5b more reliably in a short time.

Further, when the AAA server 8a generates and notifies the Reuse Indicator but the PGW 5 in the domain or the core network 4 does not support or permit it (e.g., for the reason that the UE 1 during roaming is not permitted or the like), the PGW 5 can remove the Reuse Indicator not to notify the UE 1 of it. For example, this can deal with a case where the reuse of the key is not supported or permitted in a network (VPLMN: Visited Public Land Mobile Network) in which the UE 1 exists even if supported or permitted in the home network (HPLMN: Home Public Land Mobile Network) of the UE 1.

Further, the UE_BS_Identity is stored in the IKE_AUTH Request message so that the AAA server 8a can identify, during subsequent BS processing via the T-PGW 5b, that this is BS processing from the UE 1 that has already completed mutual authentication with the AAA server 8a via the PGW 5a. If the purpose of Reuse Indicator can be achieved by using the UE_BS_Identity, the Reuse Indicator may be omitted. To the contrary, if the purpose of UE_BS_Identity can be achieved by using the Reuse Indicator, the UE_BS_Identity may be omitted.

Since the message sent from the UE 1 to the T-PGW 5b in step S13102 of FIG. 20 is the same as the message used in step 10102 of FIG. 14 in the third embodiment of the present invention (the format example of the IKE_AUTH Request message shown in FIG. 17A), redundant description will be omitted. Further, Notify Payload specified in the standard IKEv2 protocol (see Non-Patent Document 7 cited above) may be added to the standard IKE_AUTH Request message so that Reuse Indicator and the UE_BS_Identity will be described and notified to the UE 1. Note that the message may be any message other than the IKE_AUTH Request message as long as it can transfer predetermined information.

The T-PGW 5b transfers, to the AAA server 8a, the Reuse Indicator and the UE_BS_Identity included in the IKE_AUTH Request message sent from the UE 1 (step S13103 in FIG. 20). The Reuse Indicator and the UE_BS_Identity may be notified from the UE 1 to the T-PGW 5b through the IKE_SA_INIT message, and the T-PGW 5b may notify the AAA server 8a of the parameter in parallel with exchange of the IKE_SA_INIT messages.

Since the message sent in step S13103 of FIG. 20 from the T-PGW 5b to the AAA server 8a is the same as the message (the format example of the Authentication-Request message shown in FIG. 18A) used in step S10103 of FIG. 14 in the third embodiment of the present invention, redundant description will be omitted. Further, the Reuse Indicator and the UE_BS_Identity may be described in the existing payload of a standard Authentication-Request message and notified to the AAA server 8a. Note that the message may be any message other than the Authentication-Request message as long as it can transfer predetermined information.

The AAA server 8a receives the Reuse indicator transferred from the T-PGW 5b, determines that reuse of the MSK obtained when SA has previously been established between the UE 1 and the I-PGW 5a is requested, and notifies the T-PGW 5b of the MSK corresponding to the UE_BS_Identity held by the AAA server 8a. As mentioned above, the UE_BS_Identity may be replaced by a parameter (e.g., IMSI) capable of confirming that the UE 1 has once completed full authentication. T-PGW_BS_Identity corresponding to the UE_BS_Identity is also notified at the same time as the notification of the MSK (step S13104 in FIG. 20). The T-PGW_BS_Identity may be generated by the AAA server 8a itself, or if a database server (not shown) holding a BS_Identity list is placed on the network, a query may be sent to the database server to acquire and use the T-PGW BS_Identity corresponding to the UE BS Identity.

Here, it is considered that the T-PGW 5b notifies the AAA server 8a of its own information (e.g., the IP address or the identifier of the PGW 5) in step S13103 to deal with a case where the reuse of the MSK is permitted only for a switching connection to a different PGW 5 previously instructed (i.e., when the reuse of the MSK is not permitted for a connection from any PGW 5). This enables the AAA server 8a to that the connection request is a request for a switching connection to the T-PGW 5b previously instructed to the UE 1, and hence permit the reuse of the MSK properly.

Since the message sent in step S13104 of FIG. 20 from the AAA server 8a to the T-PGW 5b is the same as the message (the format example of the Authentication-Answer message shown in FIG. 18B) used in step S10104 of FIG. 14 in the third embodiment of the present invention, redundant description will be omitted. Note that the response message may be any message other than the Authentication-Answer message as long as it can transfer predetermined information.

Subsequently, the T-PGW 5b notifies the UE 1 of the T-PGW_BS_Identity received from the AAA server 8a, success in the authentication (authentication of the UE 1 by the AAA server 8a), and that the reuse of the MSK is authorized (step S13105 in FIG. 20).

Referring next to FIG. 17C, an example of the format of the IKE_AUTH Response message will be described as an example of a message sent from the T-PGW 5b to the UE 1 in step S13105 of FIG. 20. FIG. 17C is a diagram showing an example of the format of an IKE_AUTH Response message sent in step S13105 of FIG. 20. The T-PGW 5b is provided with a BS identifier (UE_BS_Identity/T-PGW_BS_Identity) field 3202 and a Success Reuse Indicator field 3203 in addition to a conventional standard IKE_AUTH Response message 3201 so that respective values can be notified to the UE 1. The T-PGW 5b may also add Notify Payload specified in the standard IKEv2 protocol (see Non-Patent Document 7 cited above) to the standard IKE_AUTH Response message so that the reuse of the MSK and the T-PGW_BS_Identity will be indicated and notified to the UE 1. Alternatively, EAP Success in the standard IKEv2 protocol may be used in the standard IKE_AUTH Response message to notify the UE 1 of the reuse of the MSK. Note that the response message may be any message other than the IKE_AUTH Response message as long as the UE 1 can confirm the reuse of the MSK.

This T-PGW_BS_Identity is used to allow the UE 1 to identify correctly that the AAA server 8a that authorized the reuse of the MSK is the same node as that authenticated the UE 1 upon the previous connection with the I-PGW 5a. For example, this also has an effect to be able to distinguish the T-PGW 5b from a false T-PGW 5b pretending to be the T-PGW 5b to try unauthorized access to the UE 1 without accessing the AAA server 8a.

Through the IKE_AUTH Response message sent from the T-PGW 5b, the UE 1 confirms that the reuse of the MSK is authorized (for example, determination from a value stored in the Success Reuse Indicator field 3203). The UE 1 generates an AUTH parameter using the MSK generated in step S13013 of FIG. 20. Then the UE 1 stores the generated AUTH parameter in an IKE_AUTH Request message, and sends the IKE_AUTH Request message to the T-PGW 5b (step S13106 in FIG. 20). When the UE 1 does not hold or cannot use the MSK generated when establishing SA with the I-PGW 5a, the UE 1 may make an inquiry to the AAA server 8a to acquire the MSK, or generate the same MSK again.

The T-PGW 5b authenticates the UE 1 that sent the IKE_AUTH Request message (for example, authentication of an IKE_SA_INIT message (the UE 1 as the source) using the AUTH parameter stored in the IKE_AUTH Request message, or confirmation of the authentication method by checking for the correctness of the IKE_SA_INIT message (the UE 1 as the source), or confirmation of the key). When the authentication of the UE 1 (the source of the IKE_SA_INIT message) is successful, the T-PGW 5b stores, in an IKE_AUTH Response message, an AUTH parameter created by using the MSK received from the AAA server 8a, and sends it to the UE 1 (step S13107 in FIG. 20).

The T-PGW 5b creates, in step S13107, the AUTH parameter using the MSK sent from the AAA server 8a, but if it can hold the MSK, the T-PGW 5b may create the AUTH parameter at any timing after step S13104 (after receiving the MSK), for example.

The UE 1 authenticates the T-PGW 5b that sent the IKE_AUTH Response message (for example, authentication of an IKE_SA_INIT message (the T-PGW 5b as the source) using the AUTH parameter stored in the IKE_AUTH Response message, or confirmation of the authentication method by checking for the correctness of the IKE_SA_INIT message (the T-PGW 5b as the source), or confirmation of the key). Note that the AUTH parameter created by the UE 1 in step S13106 or key information (e.g., the shared key or public key of the correspondent) acquired in step S13101 may be used to authenticate this T-PGW 5b (the source of the IKE_SA_INIT message).

When the UE 1 succeeded in the authentication of the T-PGW 5b (for example, authentication of an IKE_SA_INIT message (the T-PGW 5b as the source) using the AUTH parameter stored in the IKE_AUTH Response message, or confirmation of the authentication method by checking for the correctness of the IKE_SA_INIT message (the T-PGW 5b as the source), or confirmation of the key), SA is established between the UE 1 and the T-PGW 5b. Through this IKE_AUTH Response message, information necessary for SA to be established between the UE 1 and the T-PGW 5b is sent.

Further, the T-PGW 5b may create the AUTH parameter using the MSK in step S13105 and notify the UE 1 of it so that the UE 1 will first authenticate the T-PGW 5b (for example, authentication of an IKE_SA_INIT message (the T-PGW 5b as the source) using the AUTH parameter stored in the IKE_AUTH Response message, or confirmation of the authentication method by checking for the correctness of the IKE_SA_INIT message (the T-PGW 5b as the source), or confirmation of the key), and then notify the T-PGW 5b of the AUTH parameter.

In regard to the mutual authentication between the UE 1 and the T-PGW 5b (for example, authentication of IKE_SA_INIT messages (the source UE 1 and the PGW 5) using the AUTH parameter stored in the IKE_AUTH message, or confirmation of the authentication method by checking for the correctness of the IKE_SA_INIT messages (the source UE 1 and the PGW 5), or confirmation of the key), either of them may be authenticated if SA can be established when either the UE 1 or the T-PGW 5b performs authentication (for example, authentication of an IKE_SA_INIT message (the source UE 1 or the PGW 5) using the AUTH parameter stored in the IKE_AUTH message, or confirmation of the authentication method by checking for the correctness of the IKE_SA_INIT message (the source UE 1 or the PGW 5), or confirmation of the key), or for the purpose of reducing the processing load on the UE 1 or the T-PGW 5b. Further, if the UE 1 and the T-PGW 5b can authenticate each other using any parameter other than the AUTH parameter, the parameter other than the AUTH parameter may be used.

Subsequently, the UE 1 that received the IKE_AUTH_Response message performs BU/BA exchange with the T-PGW 5b (step S13201 in FIG. 20).

The above-mentioned UE_BS_Identity and T-PGW_BS_Identity described above are useful to perform simplified mutual authentication between the UE 1 and the AAA server 8a. However, when such mutual authentication is unnecessary, or when mutual authentication can be performed separately, these BS_Identity identifiers can be omitted.

Further, when the AAA server 8a can keep its state for the UE 1 after the switching instruction to the T-PGW 5b, the Reuse Indicator notified by the UE 1 can also be omitted. In this case, the AAA server 8a can identify the UE 1 based on fixed information on the UE 1 (e.g., IMSI), extract key data (e.g., MSK) based on the state kept for the UE 1, and notify T-PGW 5b of the key data. However, since it is also contemplated that some AAA servers 8a may release themselves from being in the state for the UE 1 after the switching instruction, it is useful to notify the Reuse Indicator from the UE 1 in order to ensure general versatility.

According to the above-mentioned operation, the key is reused in the manner mentioned above so that the number of messages for bootstrap processing when the UE 1 switches the connection to the T-PGW 5b and the time required for switching can be reduced, compared to the PDN GW reallocation procedure of the conventional technique, in which it is necessary to perform UE authentication between the UE 1 and the AAA server 8a twice for the I-PGW 5a and the T-PGW 5b (Full Authentication).

If the UE 1 has a past record of the establishment of SA with another PGW 5, switching between PGWs 5 can be requested to the UE 1 (i.e., notification of the address of a switching destination PGW 5 (T-PGW 5b)) can also be made before step S13014 described above (e.g., in step S13007 of FIG. 20 or the like). For example, the UE 1 sends the IKE AUTH Request message of step S13003 with the Reuse Indicator to be sent in step S13102 included therein. The I-PGW 5a that referred to this Reuse Indicator acquires a key already established for the UE 1 from the AAA server 8a in processing steps S13004 to S13006 in the same procedure as steps S13103 and S13104 (at this time, the address of the switching destination PGW 5 is also acquired at the same time). Then, the I-PGW 5a sends the UE 1 an IKE_AUTH response message with the address of the switching destination PGW 5 included in step S13007 (i.e., a message equivalent to the IKE_AUTH response message to be sent in step S13105 mentioned above) so that it can notify the UE 1 of the address of the switching destination PGW 5. This enables the UE 1 to reuse the key established before to acquire the address of the switching destination PGW 5 at high speed, and hence to switch the connection to the desired the PGW 5 at high speed even when a PGW 5 originally desired not to connect is allocated.

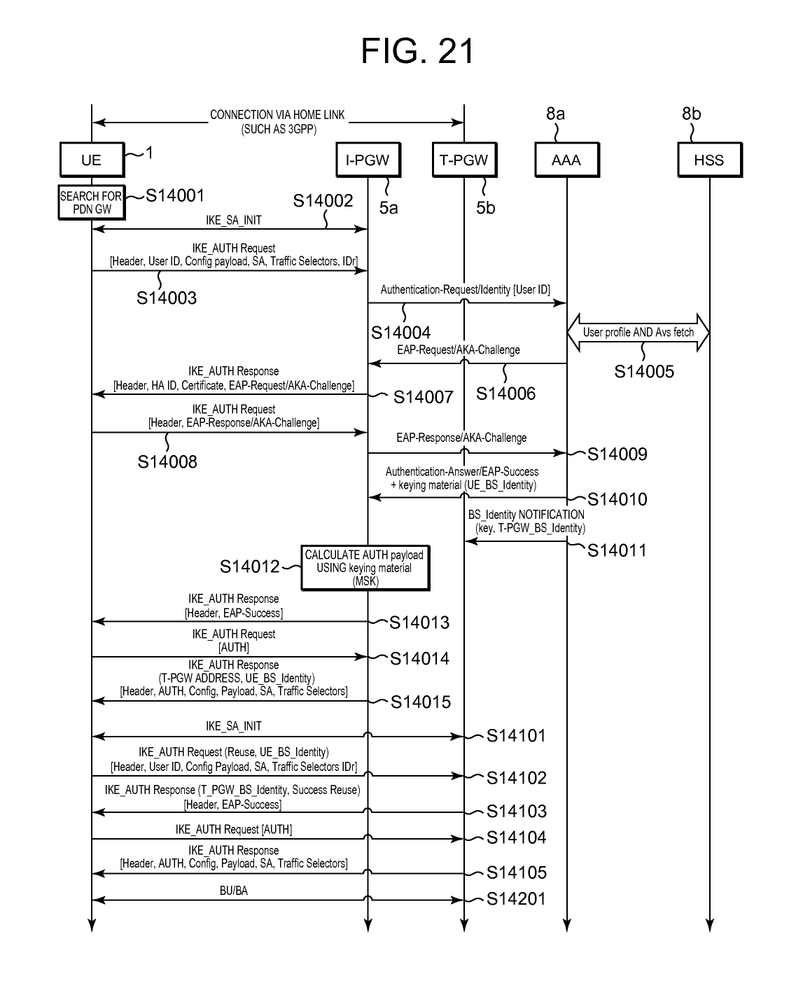

Further, the AAA server 8a may notify the T-PGW 5b of the MSK generated at the timing of giving instruction on switching to the T-PGW 5b (in step S13010 of FIG. 20). This will be specifically described with reference to FIG. 21.

FIG. 21 is a second sequence diagram for describing the system operation in the fourth embodiment of the present invention. Shown in FIG. 21 is an example of a processing sequence performed among at least the UE 1, the I-PGW 5a with which the UE 1 does not originally intend to connect, the T-PGW 5b originally desired by the UE 1 to connect, the AAA server 8a as the UE authentication server for determining whether to permit the UE 1 to use each access network, and the HSS 8b as the user information data server.

Since steps S14001 to S14010 in the processing flow of FIG. 21 are the same as steps S13001 to S13010 in the processing flow of FIG. 20, redundant description will be omitted. The AAA server 8a can notify the T-PGW 5b of the MSK at the stage of transmission in this step S14010. For example, as a technique in which the AAA server 8a notifies the T-PGW 5b of the MSK, the MSK generated in the process of establishing SA between the UE 1 and the I-PGW 5a and T-PGW_BS_Identity corresponding to the UE_BS_Identity are sent to the T-PGW 5b simultaneously with the processing for sending the I-PGW 5a the Authentication-Answer message with the UE_BS_Identity stored therein (step S14011 in FIG. 21).

Since the message sent in step S14011 of FIG. 21 from the AAA server 8a to the T-PGW 5b is the same as the message (the format example of the BS_Identity notification message shown in FIG. 19) used in step S11011 of FIG. 15 in the third embodiment of the present invention, redundant description will be omitted. As the BS_Identity notification message, a conventional Authentication-Request/Identity message or the like may be extended and used. Fixed information on the UE 1 (e.g., IMSI) may also be included in the BS_Identity notification message. This makes it easy for the T-PGW 5b to judge whether the UE 1 is a UE the full authentication of which has been completed when receiving the IKE_AUTH Request message from the UE 1, and hence enables the T-PGW 5b to check the UE 1 more surely. When the T-PGW 5 can judge the completion of full authentication from the fixed information on the UE 1 alone and check the UE 1, the UE address field 5004 used in this IKE_AUTH Response message may be omitted.

Since the following steps S14012 to S14102 in the processing flow of FIG. 21 are the same as steps S13011 to S13102 in the processing flow of FIG. 20, redundant description will be omitted.

The T-PGW 5b that received the IKE_AUTH Request message with the Reuse Indicator and the UE_BS_Identity stored therein (step S14102 in FIG. 21) sends an IKE_AUTH Response message storing the T-PGW_BS_Identity received from the AAA server 8a in step S14011 and a parameter indicative of permission of the reuse of the MSK between the UE 1 and the T-PGW 5b (e.g., a value in the Success Reuse Indicator field 3203) back to the UE 1 (step S14103 in FIG. 21). Note that the T-PGW 5b may check whether the UE_BS_Identity received in step S14102 properly corresponds to the T-PGW_BS_Identity received in step S14011 (such as to check the hash value or query the database managing the BS_Identity list on the network). Further, since the UE 1 has the MSK generated upon establishment of SA with the I-PGW 5a, the T-PGW 5b does not need to notify the UE 1 of the MSK by storing the MSK by storing the MSK in the IKE_AUTH Response message sent in step S14103. However, for example, since there is a possibility that the UE 1 may not hold the MSK for some reason (e.g., the UE 1 may already discard the MSK), the T-PGW 5b may store the MSK in the IKE_AUTH Response message sent in step S14103 to notify the UE 1 of the MSK so that the UE 1 can grasp the MSK with certainty. Further, a material for generating the MSK may also be notified instead of the MSK.

The format example shown in FIG. 17C can be used as the format of the IKE_AUTH Response message sent in step S14103 of FIG. 21. The T-PGW 5b is provided with the BS identifier (UE_BS_Identity/T-PGW_BS_Identity) field 3202 and the Success Reuse Indicator field 3203 in addition to the conventional standard IKE_AUTH Response message 3201 so that respective values can be notified to the UE 1. The T-PGW 5b may also add Notify Payload specified in the standard IKEv2 protocol (see Non-Patent Document 7 cited above) to the standard IKE_AUTH Response message so that the reuse of the MSK and the T-PGW_BS_Identity will be indicated and notified to the UE 1. Alternatively, EAP Success in the standard IKEv2 protocol may be used in the standard IKE_AUTH Response message to notify the UE 1 of the reuse of the MSK. Note that the response message may be any message other than the IKE_AUTH Response message as long as the UE 1 can confirm the reuse of the MSK. When the MSK is sent from the T-PGW 5b to the UE 1, an MSK field (not shown) may be provided in this message.

From the value stored in the Success Reuse Indicator field 3203 of the IKE_AUTH Response message, for example, the UE 1 that received the IKE_AUTH Response message determines whether the MSK generated upon establishment of SA with the I-PGW 5a can be reused. Here, when the UE 1 determines that the MSK can be reused, an AUTH parameter is created using the MSK generated upon establishment of SA with the I-PGW 5a. The UE 1 sends the T-PGW 5b an IKE_AUTH Request message with the created AUTH parameter stored therein (step S14104 in FIG. 21). Note that since the UE 1 has notified the I-PGW 5a of the AUTH parameter before (in step S14014), the AUTH parameter created then may be reused.

The T-PGW 5b that received the IKE_AUTH Request message creates an AUTH parameter using the MSK received in step S14011 from the AAA server 8a. Then, the T-PGW 5b authenticates the UE 1 from which the IKE_AUTH Request message was sent (for example, authentication of an IKE_SA_INIT message (the UE 1 as the source) using the AUTH parameter stored in the IKE_AUTH Request message, or confirmation of the authentication method by checking for the correctness of the IKE_SA_INIT message (the UE 1 as the source), or confirmation of the key).

When the T-PGW 5b has succeeded in authentication of the UE 1 (for example, when it can authenticate the IKE_SA_INIT message (the UE 1 as the source) using the AUTH parameter stored in the IKE_AUTH Request message, or confirm the authentication method by checking for the correctness of the IKE_SA_INIT message (the UE 1 as the source), or confirm the key), the T-PGW 5b sends an IKE_AUTH Response message to the UE 1 (step S14105 in FIG. 21).

The T-PGW 5b stores the previously created AUTH parameter previously in the IKE_AUTH Response message after authentication of the UE 1 (for example, authentication of the IKE_SA_INIT message (the UE 1 as the source) using the AUTH parameter stored in the IKE_AUTH Request message, or confirmation of the authentication method by checking for the correctness of the IKE_SA_INIT message (the UE 1 as the source), or confirmation of the key).

If the T-PGW 5b can authenticate the UE 1 without using the MSK sent from the AAA server 8a (for example, when it can authenticate the IKE_SA_INIT message (the UE 1 as the source) using the AUTH parameter stored in the IKE_AUTH Request message, or confirm the authentication method by checking for the correctness of the IKE_SA_INIT message (the UE 1 as the source), or confirm the key), an authentication method without using the MSK may be employed. Although the T-PGW 5b creates in step S14105 the AUTH parameter to be stored in this IKE_AUTH Response message, it may create the AUTH parameter at any timing after receiving the MSK in step S14011 from the AAA server 8a. Further, when the T-PGW 5b authenticates the UE 1 (for example, when it authenticates the IKE_SA_INIT message (the UE 1 as the source) using the AUTH parameter stored in the IKE_AUTH Request message, or confirms the authentication method by checking for the correctness of the IKE_SA_INIT message (the UE 1 as the source), or confirms the key), the T-PGW 5b uses the AUTH parameter previously generated, but if it can make the confirmation without using this AUTH parameter, the correctness may be confirmed using any other method.

Subsequently, the UE 1 that received the IKE_AUTH Response message authenticates the T-PGW 5b from which the IKE_AUTH Response message was sent (for example, authentication of an IKE_SA_INIT message (the T-PGW 5b as the source) using the AUTH parameter stored in the IKE_AUTH Response message, or confirmation of the authentication method by checking for the correctness of the IKE_SA_INIT message (the T-PGW 5b as the source), or confirmation of the key). Note that the UE 1 may also use the AUTH parameter used upon authentication of the T-PGW 5b in step S14104, or key information (e.g., the shared key or public key of the correspondent) acquired in step S14101.

The authentication of the T-PGW 5b by the UE 1 (for example, authentication of an IKE_SA_INIT message (the T-PGW 5b as the source) using the AUTH parameter stored in the IKE_AUTH Response message, or confirmation of the authentication method by checking for the correctness of the IKE_SA_INIT message (the T-PGW 5b as the source), or confirmation of the key) may be omitted if SA can be established only by the authentication of the UE 1 by the T-PGW 5b (for example, authentication of an IKE_SA_INIT message (the UE 1 as the source) using the AUTH parameter stored in the IKE_AUTH Request message, or confirmation of the authentication method by checking for the correctness of the IKE_SA_INIT message (the UE 1 as the source), or confirmation of the key), or for the purpose of reducing the processing load on the UE 1. Further, when the UE 1 can authenticate the T-PGW 5b without using the MSK held by the UE 1 (for example, when authentication can be performed by using the presence or absence of association between the UE_BS_Identity held by the UE 1 and the T-PGW_BS_Identity held by the T-PGW 5b), an authentication method without using the MSK may be employed.

When succeeding in the authentication of the T-PGW 5b (the source of the IKE_SA_INIT message), the UE 1 performs BU/BA exchange with the T-PGW 5b (step S14201 in FIG. 21).

Thus, since the AAA server 8a notifies the T-PGW 5b of the MSK in advance, when the UE 1 switches its connection to the T-PGW 5b, a high-speed switching connection can be made compared with a case where the T-PGW 5b acquires the MSK from the AAA server 8a.

If the T-PGW 5b receives and processes the IKE_AUTH Request message from the UE 1 before the AAA server 8a notifies the T-PGW 5b of the MSK, the T-PGW 5b will request the AAA server 8a to perform full authentication on the UE 1 again, increasing the time required until the connection is established. To avoid this, the UE 1 may send the T-PGW 5b an IKE_AUTH Request message including the Reuse indicator as described with reference to FIG. 14 (step S14102 in FIG. 21) so that the T-PGW 5b will make an inquiry to the AAA server 8a if it has not acquired the MSK from the AAA server 8a yet. This can make the reuse of the MSK more reliably, achieving a speedup of the switching connection.

The above-mentioned UE_BS_Identity and T-PGW_BS_Identity are useful to perform simplified mutual authentication between the UE 1 and the AAA server 8a (for example, to prevent a false UE 1 pretending to be the UE 1 from trying unauthorized access to acquire information on SA between the UE 1 and the T-PGW 5b), and to enable the AAA server 8a to judge whether the connection request from the UE 1 sent this time results from switching the connection to the T-PGW 5b previously instructed or is for connection to a new PGW 5 in order to ensure the reuse of the MSK. However, these BS_Identity identifiers can be omitted when such mutual authentication is unnecessary, or when mutual authentication can be performed separately, or when it can be confirmed that the connection request results from switching to the T-PGW 5b by a method of causing the AAA8a to compare the APN (Access Point Name) or the like included in the connection request from the UE 1 with that notified by the previous connection request (via the I-PGW 5a).

The above-mentioned UE_BS_Identity and T-PGW_BS_Identity are also useful when multiple PDN GW reallocations occur. For example, suppose that PDN GW reallocation occurs while the UE 1 is performing an attach procedure with a PGW (I-PGW 5a) found first, and the UE 1 receives the address of a PGW 5 (I′-PGW) from the I-PGW 5a. Suppose, however, that the l′-PGW with which the UE 1 tries to establish SA again is a PGW 5 different from the T-PGW 5b with which the UE 1 is connecting in the 3G access 2. In this case, although the UE 1 reuses the MSK to establish SA with the l′-PGW, there is a possibility that the address of the PGW 5 (T-PGW 5b) is notified again from the AAA server 8a. When this UE 1 performs an attach procedure with the T-PGW 5b, the UE 1 may reuse the MSK generated when SA has been established with the I-PGW 5a, or the MSK generated when SA is established between the UE 1 and the l′-PGW. The UE 1 may also use the UE_BS_Identity and the T-PGW_BS_Identity to indicate which MSK is to be reused.

Further, in an ideal state, since the T-PGW 5b can acquire a key sent from the AAA server 8a toward the UE 1 before receiving the IKE_AUTH Request message from the UE 1 and the T-PGW 5b can recognize reuse of the key at this point, the Reuse Indicator notified by the UE 1 can be omitted. However, it is useful to add the Reuse Indicator in order to urge the T-PGW 5b to perform processing based on a sequence for reusing the key, rather than processing based on the conventional sequence on the assumption that the notification from the AAA server 8a could get behind the arrival of the IKE_AUTH Request message from the UE 1 as mentioned above.

As described in the aforementioned second embodiment, the UE 1 may be notified of the address of the T-PGW 5b as the switching destination PGW 5 while being connecting with the I-PGW 5a (step S9107 in FIG. 13). However, in the second embodiment, the UE 1 performs steps S9108 to S9112 to release the state of the AAA server 8a. In this case, it can be considered that, if the authentication processing (MSK generation) performed by the AAA server 8a is completed substantially in this step interval to reuse the authentication data (MSK or the like) at the time of switching connection with the T-PGW 5b, the effect of reducing processing time can be more expected as a whole. Therefore, when the UE 1 according to the fourth embodiment is notified of the address of the switching destination PGW 5 while being connecting with the I-PGW 5a, the UE 1 may also continue the authentication processing without requesting making the request for release of the state of the AAA server 8a in step S13008 of FIG. 20 (or step S14008 of FIG. 21). In other words, although processing step S9108 and following steps in FIG. 13 are replaced by step S13008 of FIG. 20 (or step S14008 of FIG. 21) and following steps, since the address of the T-PGW 5b is already notified to the UE 1 in step S13007 (or step S14007), there is no need to notify it again in step S13014 of FIG. 20 (or step S14015 of FIG. 21).

In the fourth embodiment of the present invention, the reuse of the MSK generated upon establishing SA between the UE 1 and the I-PGW 5a can reduce the number of messages necessary to establish SA between the UE 1 and the T-PGW 5b. Further, the time required to exchange the messages and perform processing can be reduced.

The UE 1 can reuse the shared key (e.g., SKEYSEED) (see Non-Patent Document 7 cited above) generated between the UE 1 and the PGW 5 in addition to the reuse of the MSK so that the step of generating/acquiring the shared key or the like (e.g., corresponding to step S13101 of FIG. 20) when PDN GW reallocation occurs can be omitted. For example, suppose that PDN GW reallocation occurs, the UE 1 establishes SA with the I-PGW 5a (steps S13001 to step S13014 in FIG. 20), and the UE 1 tries to establish SA with the T-PGW 5b received from the I-PGW 5a. At this time, the UE 1 can reuse the shared key (e.g., SKEYSEED) generated when establishing SA with the I-PGW 5a to omit the step of generating the shared key between the UE 1 and the T-PGW 5b. Further, in the case of an ideal state (a state in which the T-PGW 5b permits reuse of the shared key), the UE 1 has only to notify the T-PGW 5b of a message indicative of the reuse of the shared key so that the other messages can be omitted.

Although the shared key (e.g., SKEYSEED) or the MSK between the UE 1 and the PGW 5 is generated for each PGW 5, a key (SK_ei, SK_er, or the like) used to encrypt packets may be reused in like manner to omit the step of generating any key. In this case, switching between the generation of a new key or the reuse of the key can increase the security level, and hence reduce the possibility of information leakage to a node trying to intercept key information between the UE 1 and the PGW 5.

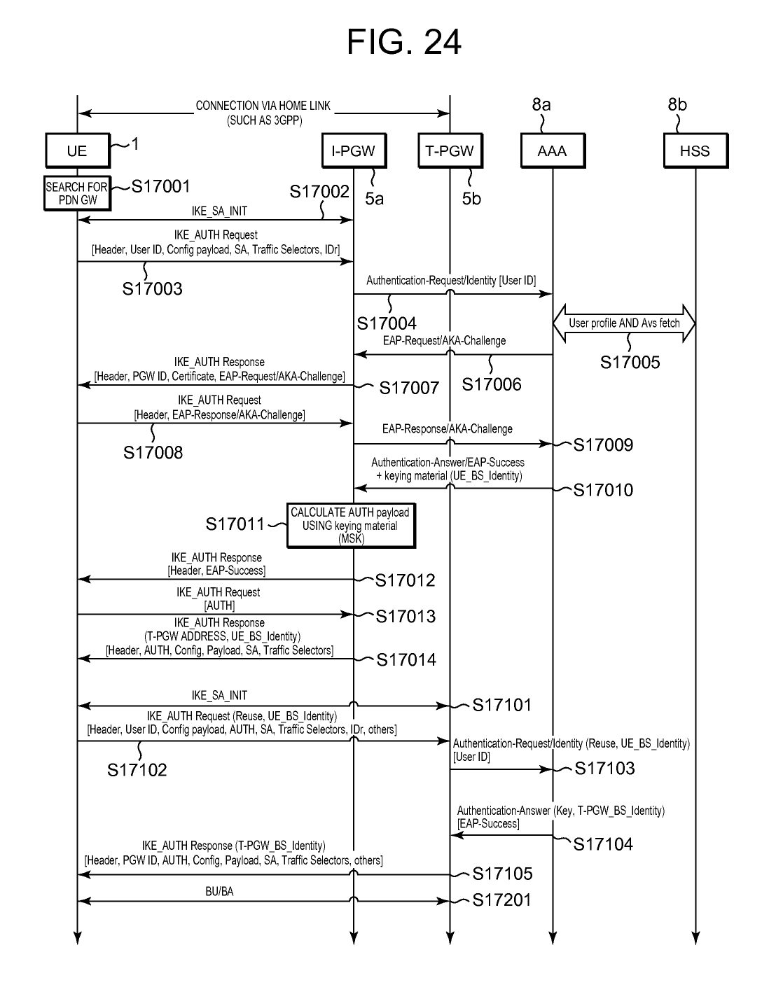

In addition, the UE 1 may store, in the IKE_AUTH Request message (step S13102 in FIG. 20) indicative of the reuse of the MSK, an AUTH parameter created using the MSK generated upon establishing SA with the I-PGW 5a, and notify the T-PGW 5b of the AUTH parameter. This will be specifically described with reference to FIG. 24.

FIG. 24 is a third sequence diagram for describing an example of the system operation in the fourth embodiment of the present invention. Shown in FIG. 24 is an example of a processing sequence performed among at least the UE 1, the I-PGW 5a with which the UE 1 does not originally intend to connect, the T-PGW 5b originally desired by the UE 1 to connect, the AAA server 8a as the UE authentication server for determining whether to permit the UE 1 to use each access network, and the HSS 8b as the user information data server.

Since steps S17001 to S17101 in the processing flow of FIG. 24 are the same as step S13001 to S13101 in the processing flow of FIG. 20, redundant description will be omitted.

Subsequently, the UE 1 sends the T-PGW 5b an IKE_AUTH Request message including the Reuse Indicator indicative of the reuse of the MSK and the like. At this time, the UE 1 also stores an AUTH parameter created using the MSK generated upon establishing SA with the I-PGW 5a, and notifies the T-PGW 5b of the AUTH parameter (step S17102 in FIG. 24).

When confirming that the AUTH parameter is stored in the IKE_AUTH Request message, the T-PGW 5b determines that the UE 1 indicates an SA establishment method using a normal IKEv2 protocol without using EAP (Extended Authentication Protocol) (see Non-Patent Document 7 cited above). Further, when the UE 1 determines that a value indicating, in the Reuse Indicator field 3002 stored in the IKE_AUTH Request message, the reuse of the MSK generated when the UE 1 established SA with the I-PGW 5a, or a parameter corresponding to the value indicative of the reuse of the MSK somewhere other than the Reuse Indicator field 3002) is stored, the T-PGW 5b sends the AAA server 8a an Authentication-Request message with the Reuse Indicator and the UE_BS_Identity received in step S17102 (step S17103 in FIG. 24). If the T-PGW 5b can confirm that the UE 1 notifies the T-PGW 5b of an IKE_AUTH Request message with the AUTH parameter stored therein, for example, without using the Reuse Indicator to indicate the reuse of the MSK, the Reuse Indicator can be omitted. Further, if the AAA server 8a can use information specific to the UE 1 (e.g., IMSI) to acquire the MSK generated when the UE 1 established SA with the I-PGW 5a, the UE_BS_Identity can also be omitted.

Since step S17104 in the processing flow of FIG. 24 is the same as step S13104 in the processing flow of FIG. 20, redundant description will be omitted.

The T-PGW 5b that received the MSK in step S17104 from the AAA server 8a authenticates the UE 1 from which the IKE_AUTH Request message with the AUTH parameter stored therein was sent (for example, authentication of an IKE_SA_INIT message (the UE 1 as the source) using the AUTH parameter stored in the IKE_AUTH Request message, or confirmation of the authentication method by checking for the correctness of the IKE_SA_INIT message (the UE 1 as the source), or confirmation of the key). If the T-PGW 5b can authenticate the UE 1 without using the MSK received from the AAA server 8a, the MSK does not need using. In this case, processing for authentication of the UE 1 may also be performed after step S17102. When authenticating the UE 1, the T-PGW 5b may use the MSK received from the AAA server 8a or an AUTH parameter calculated using the MSK received.

After completion of the authentication of the UE 1, the T-PGW 5b calculates an AUTH parameter using the MSK received from the AAA server 8a, stores it in an IKE_AUTH Response message, and sends the IKE_AUTH Response message to the UE 1 (step S17105 in FIG. 24). Upon authenticating the UE 1, if an AUTH parameter generated using the MSK received from the AAA server 8a, the AUTH parameter may be calculated before authenticating the UE 1. Further, the T-PGW 5b also stores, in the IKE_AUTH Response message, the T-PGW_BS_Identity received together with the MSK in step S17104, and sends it to the UE 1.

The UE 1 that received the IKE_AUTH Response message with the AUTH parameter and the T-PGW_BS_Identity stored therein authenticates the T-PGW 5b (for example, authentication of an IKE_SA_INIT message (the T-PGW 5b as the source) using the AUTH parameter stored in the IKE_AUTH Response message, or confirmation of the authentication method by checking for the correctness of the IKE_SA_INIT message (the T-PGW 5b as the source), or confirmation of the key). After authenticating the T-PGW 5b, the UE 1 performs BU/BA exchange with the T-PGW 5b (step S17201 in FIG. 24).

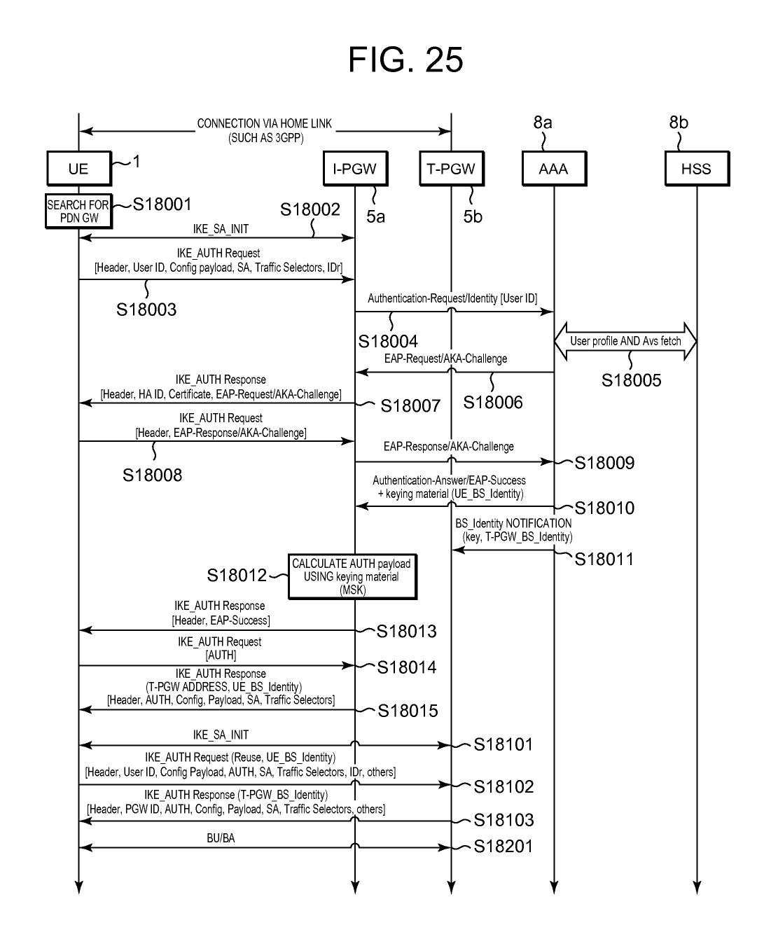

Further, like in the second sequence (FIG. 21) according to the fourth embodiment of the present invention, the same holds true with regard to a case where the AAA server 8a notifies the T-PGW 5b of the MSK, generated upon establishment of SA between the UE 1 and the I-PGW 5a, and the T-PGW_BS_Identity (step S14011 in FIG. 21) at the same time as a notification of the IP address of the T-PGW 5b to the I-PGW 5a (step S14010 in FIG. 21). This will be described in detail with reference to FIG. 25.

FIG. 25 is a fourth sequence diagram for describing an example of the system operation in the fourth embodiment of the present invention. Shown in FIG. 25 is an example of a processing sequence performed among at least the UE 1, the I-PGW 5a with which the UE 1 does not originally intend to connect, the T-PGW 5b originally desired by the UE 1 to connect, the AAA server 8a as the UE authentication server for determining whether to permit the UE 1 to use each access network, and the HSS 8b as the user information data server.

Since steps S18001 to S18101 in the processing flow of FIG. 25 are the same as steps S14001 to S14101 in the processing flow of FIG. 21, redundant description will be omitted.

Subsequently, the UE 1 sends the T-PGW 5b an IKE_AUTH Request message including the Reuse Indicator indicative of the reuse of the MSK and the like. At this time, the UE 1 also stores an AUTH parameter created using the MSK generated upon establishing SA with the I-PGW 5a, and notifies the T-PGW 5b of the AUTH parameter (step S18102 in FIG. 25). If the T-PGW 5b can confirm that the UE 1 notifies the T-PGW 5b of an IKE_AUTH Request message with the AUTH parameter stored therein, for example, without using the Reuse Indicator to indicate the reuse of the MSK, the Reuse Indicator can be omitted. Further, by using information specific to the UE 1 (e.g., IMSI), if the T-PGW 5b can confirm that the UE 1 indicates the reuse of the MSK generated when establishing SA with the I-PGW 5a, the UE_BS_Identity can also be omitted.

The T-PGW 5b that received the IKE_AUTH Request message including the AUTH parameter and the like performs authentication of the UE 1 (for example, authentication of an IKE_SA_INIT message (the UE 1 as the source) using the AUTH parameter stored in the IKE_AUTH Request message, or confirmation of the authentication method by checking for the correctness of the IKE_SA_INIT message (the UE 1 as the source), or confirmation of the key). Upon authentication of the UE 1, the T-PGW 5b may use the MSK received from the AAA server 8a or an AUTH parameter calculated using the MSK received. Upon authentication of the UE 1, if the T-PGW 5b can authenticate the UE 1 using something other than the MSK received from the AAA server 8a, T-PGW 5b may authenticate the UE 1 using that other than the MSK.

When succeeding in the authentication of the UE 1, the T-PGW 5b creates an AUTH parameter using the MSK received from the AAA server 8a. Note that if the T-PGW 5b uses the AUTH parameter generated using the MSK received from the AAA server 8a to authenticate the UE 1, the AUTH parameter may be calculated before the authentication of the UE 1. Then, the T-PGW 5b an IKE_AUTH Response message with the created AUTH parameter, parameters required to establish SA between the UE 1 and the T-PGW 5b, and the like stored therein (step S18103 in FIG. 25). If the UE 1 can recognize the T-PGW 5b without the T-PGW_BS_Identity parameter (for example, when the AUTH parameter stored in the IKE_AUTH Response message can be decoded), the T-PGW 5b can omit the T-PGW_BS_Identity.

The UE 1 that received the IKE_AUTH Response message with the AUTH parameter and the like stored therein performs authentication of the T-PGW 5b (for example, authentication of an IKE_SA_NIT message (the T-PGW 5b as the source) using the AUTH parameter stored in the IKE_AUTH Response message, or confirmation of the authentication method by checking for the correctness of the IKE_SA_INIT message (the T-PGW 5b as the source), or confirmation of the key). When succeeding in the authentication of the T-PGW 5b, the UE 1 performs BU/BA exchange with the T-PGW 5b (step S18201 in FIG. 25).

As shown in the processing flow of FIG. 24 or FIG. 25, since the UE 1 sends, in step S17102 or step S18102, the T-PGW 5b the AUTH parameter created using the MSK generated when SA was established with the I-PGW 5a, the T-PGW 5b can determine that the UE 1 desires to establish SA with the T-PGW 5b using a normal IKEv2 protocol rather than BS processing using EAP. Further, since the Reuse Indicator or a parameter corresponding to the Reuse Indicator is received, the T-PGW 5b can confirm that the UE 1 desires the reuse of the MSK generated when SA was established with the I-PGW 5a, and this enables the T-PGW 5b to send the UE 1 the AUTH parameter created using the MSK received from the AAA server 8a. As a result, the UE 1 and the T-PGW 5b can establish SA without messages required in the processing flow of FIG. 20 or FIG. 21 (e.g., steps S13106 to S13107 in FIG. 20 or steps S14104 to S14105 in FIG. 21).

Next, the configuration and processing flow of a mobile terminal (UE 1) according to the fourth embodiment of the present invention will be described. Since the configuration of the mobile terminal (UE 1) according to the fourth embodiment of the present invention is the same as the configuration of the mobile terminal (UE 1) according to the first to third embodiments of the present invention, redundant description will be omitted.

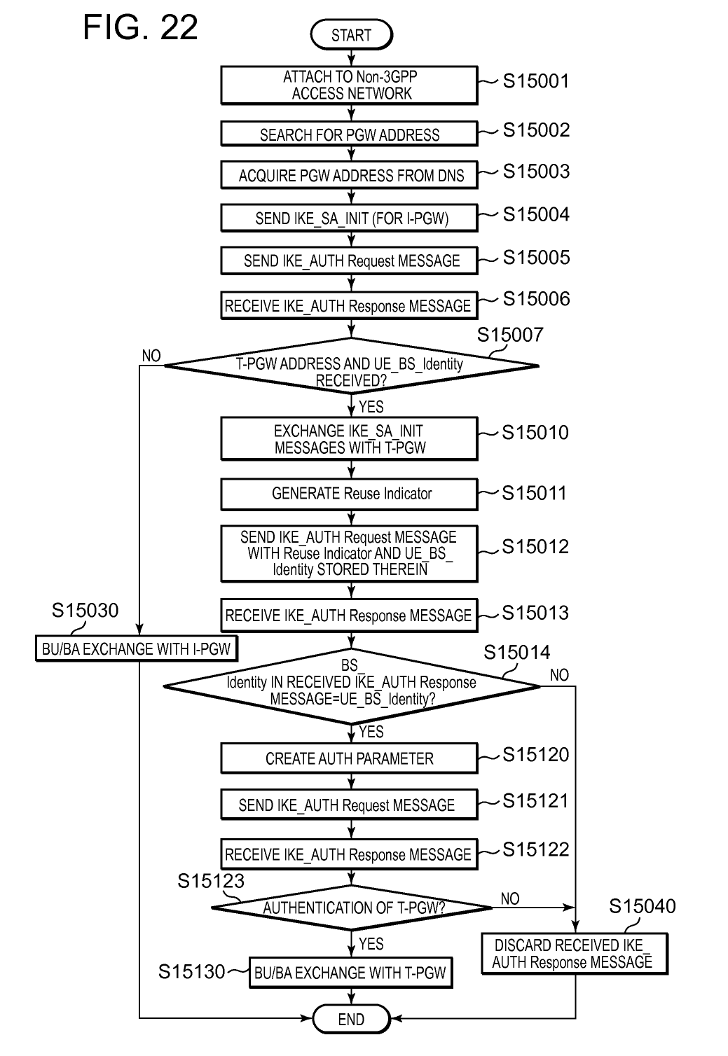

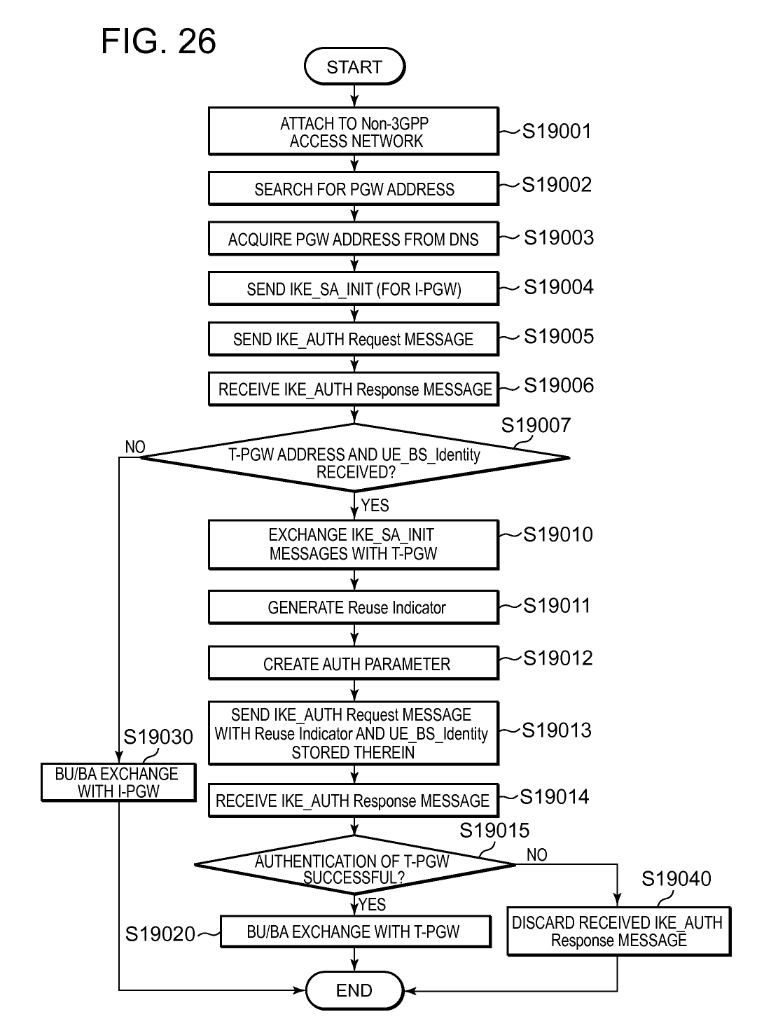

Referring to FIG. 22 and FIG. 26, the processing flow of the UE 1 having the configuration shown in FIG. 3 will be described in detail, focusing on processing related to the connection control unit 106 for performing processing that is a characteristic feature of the present invention. FIG. 22 and FIG. 26 are flowcharts showing examples of the processing flows of the UE1 according to the fourth embodiment of the present invention. It is assumed that the UE 1 is already attached to the 3G access 2 (home link) through the first radio communication unit 101 and connected to the T-PGW 5b.

Since steps S15001 to S15013 in the processing flow of the UE 1 in FIG. 22 are the same as steps S12001 to S12013 in the processing flow of the UE 1 in FIG. 16, redundant description will be omitted.

The UE 1 checks whether the T-PGW_BS_Identity sent from the T-PGW 5b matches the T-PGW_BS_Identity generated/acquired by the UE 1, or whether there is association therebetween (step S15014). Then, the UE 1 checks whether permission of the reuse of the MSK is indicated (for example, whether EAP Success is stored in the IKE_AUTH Response message (step S13105 in FIG. 20 or the like) (step S15105). If they match or the reuse of the MSK is permitted on condition that there is association therebetween, the UE 1 uses the MSK generated when SA was established with the I-PGW 5a to create an AUTH parameter to be sent to the T-PGW 5b (step S15120). On the other hand, if they do not match, the UE 1 discards the received IKE_AUTH Response message (step S15040 in FIG. 22).

Subsequently, the UE 1 sends the T-PGW 5b an IKE_AUTH Request message with the AUTH parameter created in step S15120 stored therein (step S15121 in FIG. 22). Then, the UE 1 receives an IKE_AUTH Response message sent from the T-PGW 5b (step S15122 in FIG. 22).

The UE 1 authenticates the T-PGW 5b from which the IKE_AUTH Response message is sent in step S15122 (for example, authentication of an IKE_SA_INIT message (the T-PGW 5b as the source) using the AUTH parameter stored in the IKE_AUTH Response message, or confirmation of the authentication method by checking for the correctness of the IKE_SA_INIT message (the T-PGW 5b as the source), or confirmation of the key) (step S15123 in FIG. 22). When succeeding in the authentication of the T-PGW 5b (for example, the authentication of the IKE_SA_INIT message using the AUTH parameter stored in the IKE_AUTH Response message, or the confirmation of the authentication method by checking for the correctness of the IKE_SA_INIT message (the T-PGW 5b as the source), or the confirmation of the key), the UE 1 performs BU/BA exchange with the T-PGW 5b (step S15130 in FIG. 22). If failing in the authentication, the UE 1 discards the IKE_AUTH Response message received from the T-PGW 5b (step S15040 in FIG. 22).

Note that BU/BA exchange with the T-PGW 5b can be performed by omitting step S15123 when the UE 1 can trust the T-PGW 5b (for example, when the T-PGW_BS_Identity is stored), or when there is no need to authenticate the T-PGW 5b (for example, when the authentication of the IKE_SA_INIT message (the T-PGW 5b as the source) using the AUTH parameter stored in the IKE_AUTH Response message, or the confirmation of the authentication method by checking for the correctness of the IKE_SA_INIT message (the T-PGW 5b as the source), or the confirmation of the key is known or can be omitted). Further, step S15123 may be omitted if mutual confirmation can be made only by the authentication of the UE 1 by the T-PGW 5b (for example, the authentication of the IKE_SA_INIT message (the UE 1 as the source) using the AUTH parameter stored in the IKE_AUTH Request message, or the confirmation of the authentication method by checking for the correctness of the IKE_SA_INIT message (the UE 1 as the source), or the confirmation of the key).

When the address of the T-PGW 5b and the UE_BS_Identity are not stored in the IKE_AUTH Response message received by the UE 1 in step S15006, since it means that no request is made for switching between PGWs 5, the UE 1 performs BU/BA exchange with the I-PGW 5a using the established SA (step S15030 in FIG. 22).

When the UE 1 notifies the T-PGW 5b of the AUTH parameter in the third and fourth sequences according to the fourth embodiment of the present invention (e.g., step S17102 in FIG. 24 and step S18102 in FIG. 25), the UE 1 generates not only the Reuse Indicator but also an AUTH parameter using the MSK generated upon establishment of SA with the I-PGW 5a after exchanging IKE_SA_INIT messages with the T-PGW 5b as shown in FIG. 26 (in step S19010 of FIG. 26). Note that step S19011 and step S19012 may be executed in reverse order.

Subsequently, the UE 1 sends the T-PGW 5b an IKE_AUTH Request message with the generated Reuse Indicator and AUTH parameter stored therein (step S19013 in FIG. 26). After receiving an IKE_AUTH Response message (step S19014 in FIG. 26), the UE 1 authenticates the T-PGW 5b (step S19015 in FIG. 26).

After that, the UE 1 performs BU/BA exchange with the T-PGW 5b (step S19020 in FIG. 26).

Next, a configuration and processing flow of the PGW 5 according to the fourth embodiment of the present invention will be described. Since the configuration of the PGW 5 according to the fourth embodiment of the present invention is the same as the configuration of the PGW 5 according to the first to third embodiments of the present invention (see FIG. 8), redundant description will be omitted.

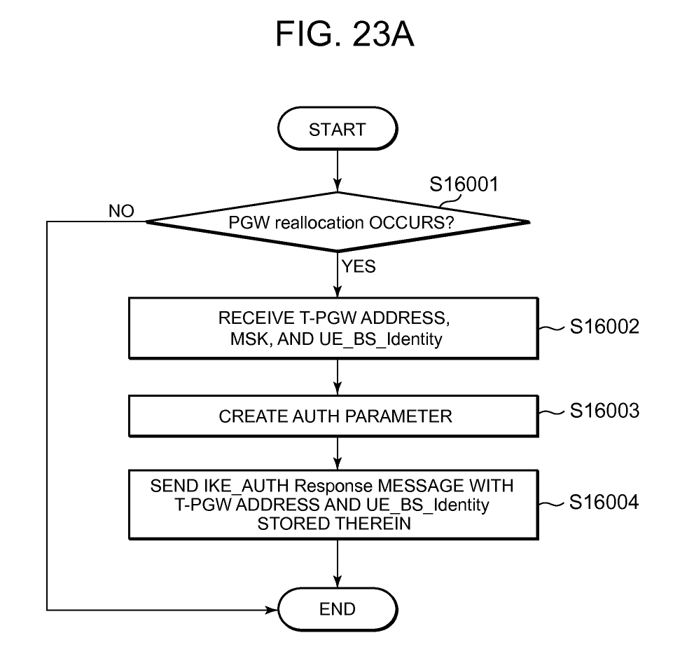

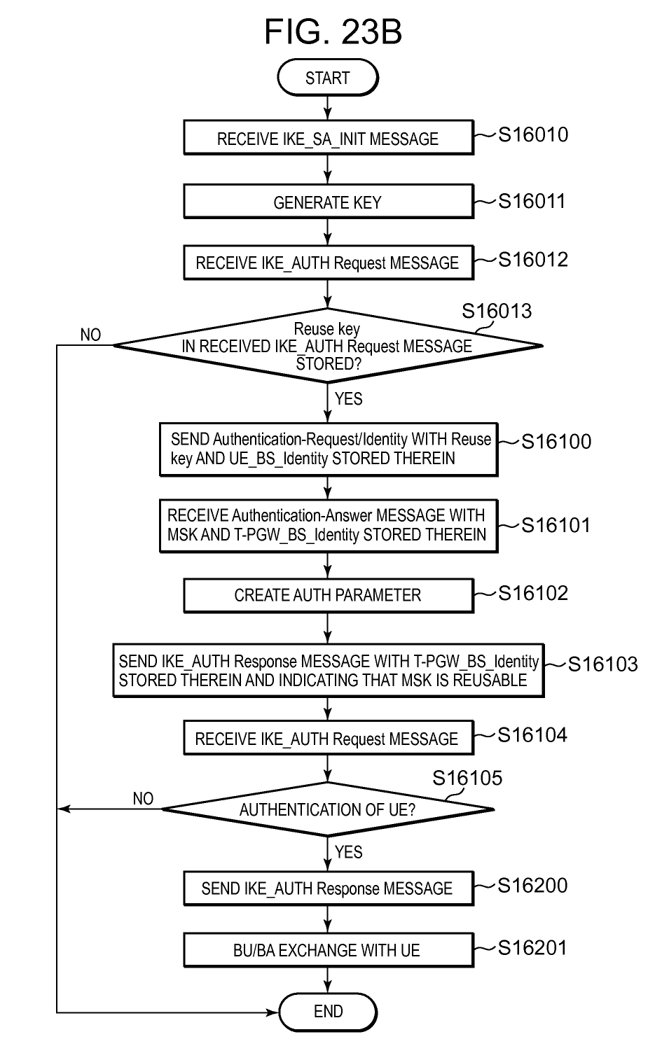

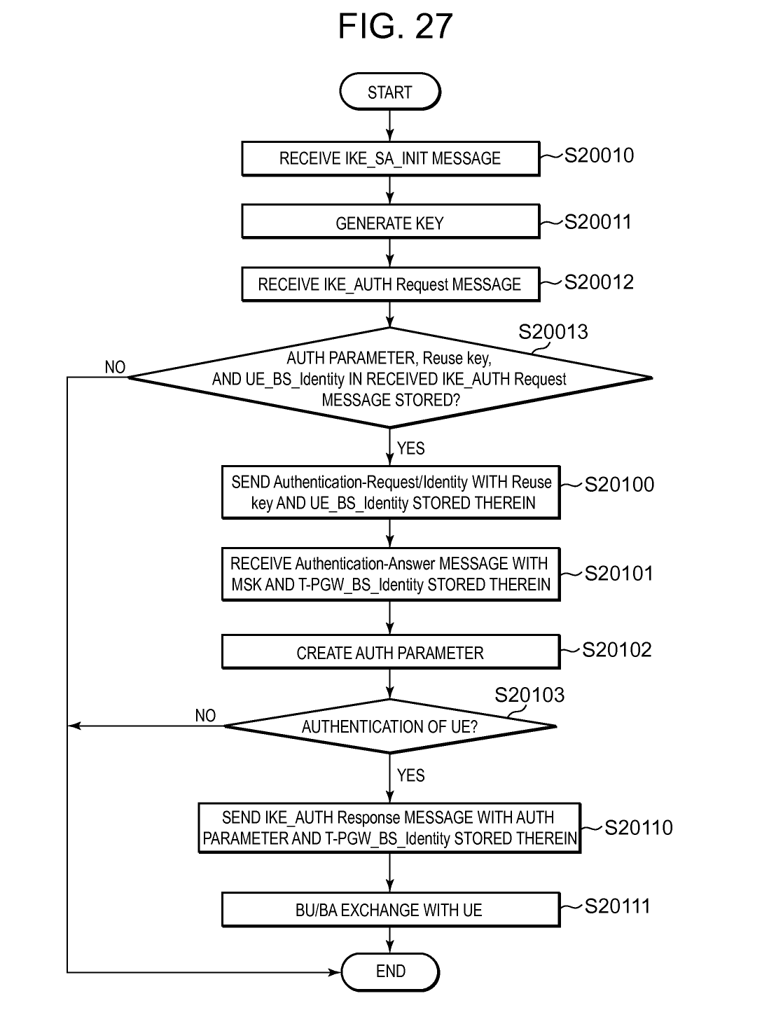

Referring to FIG. 23A, FIG. 23B, and FIG. 27, the processing flow of the PGW 5 having the configuration shown in FIG. 8 will be described in detail, focusing on processing related to the connection control unit 205 for performing processing that is a characteristic feature of the present invention. It is assumed that the PGW 5 is already attached to the 3G access 2 (home link) through the communication unit 201. It is also assumed that the PGW 5 to which the UE 1 tries the initial attach procedure is the I-PGW 5a.

FIG. 23A is a flowchart showing an example of a processing flow of the PGW 5 as the I-PGW 5a according to the fourth embodiment of the present invention. The PGW 5 according to the present invention waits for BS processing (e.g., step S13002 or step S13003 in FIG. 20) from the UE 1 to establish SA with the UE 1. The UE 1 starts the attach procedure with the I-PGW 5a according to a connection procedure.

For example, when the UE 1 is attached to the N3G access 3 and allocated, from the DNS or the like, a PGW 5 (I-PGW 5a) different from the PGW 5 (T-PGW 5b) desired by the UE 1 to connect, a PDN GW reallocation occurs according to the determination of the network side (e.g., the AAA server 8a or the PGW 5) while the UE 1 is performing the attach procedure with the I-PGW 5a (an instruction to switch between PGWs 5 (e.g., the address of the T-PGW 5b or the like) is notified to the UE 1) (step S16001 in FIG. 23A).

In the PDN GW reallocation of a conventional technique, the AAA server 8a decides on the PDN GW reallocation in step S9010 (or a previous step) of FIG. 14 and notifies the PGW of the address of the T-PGW 5b (see Non-Patent Document 2 cited above). Therefore, in the fourth embodiment of the present invention, it is also assumed for convenience of explanation that the AAA server 8a decides on the PDN GW reallocation.

When the AAA server 8a decides on the PDN GW reallocation, the I-PGW 5a receives, from the AAA server 8a, the address of the T-PGW 5b as the switching destination from the PGW 5, the MSK used between the UE 1 and the I-PGW 5a, and a certificate to certify that the AAA server 8a has once performed full authentication of the UE 1 (e.g., UE_BS_Identity or the like) (step S16002 in FIG. 23A). Here, it is assumed for convenience of explanation that the certificate to certify that the AAA server 8a has once performed full authentication of the UE 1 is the UE_BS_Identity.

Subsequently, the I-PGW 5a creates an AUTH parameter using the MSK received from the AAA server 8a in order to authenticate the UE 1 (for example, authentication of an IKE_SA_INIT message (the UE 1 as the source) using the AUTH parameter stored in the IKE_AUTH Request message, or confirmation of the authentication method by checking for the correctness of the IKE_SA_INIT message (the UE 1 as the source), or confirmation of the key) or in order for the UE 1 to authenticate the I-PGW 5a (for example, authentication of an IKE_SA_INIT message (the T-PGW 5b as the source) using the AUTH parameter stored in the IKE_AUTH Response message, or confirmation of the authentication method by checking for the correctness of the IKE_SA_INIT message (the T-PGW 5b as the source) (step S16003 in FIG. 23A).

When succeeding in the authentication of the UE 1 (for example, the authentication of the IKE_SA_INIT message (the UE 1 as the source) using the AUTH parameter stored in the IKE_AUTH Request message, or the confirmation of the authentication method by checking for the correctness of the IKE_SA_INIT message (the UE 1 as the source), or the confirmation of the key), the I-PGW 5b sends the UE 1 an IKE_AUTH Response message with the address of the T-PGW 5b and the UE_BS_Identity stored therein (step S16004 in FIG. 23A).

On the other hand, FIG. 23B is a flowchart showing an example of a processing flow of the PGW 5 as the T-PGW 5b according to the fourth embodiment of the present invention. The UE 1 that received the address of the T-PGW 5b detects that a PDN GW reallocation has occurred. Then, the UE 1 sends an IKE_SA_INIT message to start the attach procedure with the T-PGW 5b.

The T-PGW 5b receives the IKE_SA_INIT message sent from the UE 1 (step S16010 in FIG. 23B). Then, the T-PGW 5b uses Nonces stored in the IKE_SA_INIT message or a shared key (e.g., SKEYSEED) generated/acquired by Diffie-Hellman key exchange performed during exchange of IKE_SA_INIT messages to generate a key (e.g., SK_ei or SK_er) or the like to encrypt packets used between the UE 1 and the T-PGW 5b (step S16011 in FIG. 23B). At this time, a parameter (e.g., each other's public key) for authenticating the AUTH parameter stored in the IKE_AUTH message may also be exchanged. The generation of keys used between the UE 1 and the T-PGW 5b includes, but not limited to, keys shared between Nonces or by Diffie-Hellman key exchange.

After completion of the exchange of IKE_SA_INIT messages, the T-PGW 5b receives an IKE_AUTH Request message sent from the UE 1 (step S16012 in FIG. 23B). The T-PGW 5b checks whether a value (e.g., Reuse key) indicative of the reuse of the MSK and stored in the Reuse Indicator field 3002 of the IKE_AUTH Request message received from the UE 1, or a value equivalent to the value indicative of the reuse of the MSK is stored (step S16013 in FIG. 23B).

At this time, if the value indicative of the reuse of the MSK such as the Reuse key (or its equivalent) is not stored, normal BS processing is started. If the T-PGW 5b can confirm that the UE 1 desires the reuse of the MSK only by the UE_BS_Identity for certifying that full authentication has been performed, this Reuse Indicator field will not be used.

On the other hand, if the value indicative of the reuse of the MSK such as the Reuse key (or its equivalent) is stored, an Authentication-Request/Identity message with the Reuse key received in step S16012 and the UE_BS_Identity stored therein is sent to the AAA server 8a (step S16100 in FIG. 23B). The AAA server 8a sends the T-PGW 5b the MSK corresponding to the UE_BS_Identity sent from the T-PGW 5b and T-PGW_BS_Identity. Only when the key (e.g., SK_e or SK_i) used for encryption of data from the I-PGW 5a is transferred to the AAA server 8a and the network side determines that the key used for encryption of data or the like can also reused between the UE 1 and the T-PGW 5b, the key information (e.g., SK_e or SK_i) can also be sent to the T-PGW 5b at the same time.

The T-PGW 5b receives, from the AAA server 8a, the Authentication_Answer message with the MSK, the T-PGW_BS_Identity, and the like stored therein (step S16101 in FIG. 23B). Then, the T-PGW 5b creates an AUTH parameter using the MSK received from the AAA server 8a (step S16102 in FIG. 23B). The T-PGW 5b sends the UE 1 an IKE_AUTH Response message with the T-PGW_BS_Identity stored therein not only to indicate that the reuse of the MSK is possible but also for the purpose of preventing masquerade as the T-PGW 5b (step S16103 in FIG. 23B).

After confirming that the reuse of the MSK is possible, the UE 1 creates an AUTH parameter using the MSK held by the UE 1. Then, the UE 1 sends the T-PGW 5b an IKE_AUTH Request message with the AUTH parameter stored therein. The T-PGW 5b receives the IKE_AUTH Request message from the UE 1 (step S16104 in FIG. 23B).

Then, the T-PGW 5b authenticates the UE 1 from which the IKE_AUTH Request message was sent (for example, authentication of an IKE_SA_INIT message (the UE 1 as the source) using the AUTH parameter stored in the IKE_AUTH Request message, or confirmation of the authentication method by checking for the correctness of the IKE_SA_INIT message (the UE 1 as the source), or confirmation of the key) (step S16105 in FIG. 23B). At this time, for comparison, the T-PGW 5b may also use the AUTH parameter created in step S16102. The T-PGW 5b creates the AUTH parameter in step S16102, but it may be generated immediately before the authentication of the UE 1 (for example, the authentication of the IKE_SA_INIT message (the UE 1 as the source) using the AUTH parameter stored in the IKE_AUTH Request message, or the confirmation of the authentication method by checking for the correctness of the IKE_SA_INIT message (the UE 1 as the source), or the confirmation of the key). Further, if the AUTH parameter generated by the T-PGW 5b is not used to authenticate the UE 1, this AUTH parameter may be generated immediately before step S16200 in which the T-PGW 5b sends the AUTH parameter to the UE 1.

When the T-PGW 5b succeeds in the authentication of the UE 1 (for example, the authentication of the IKE_SA_INIT message (the UE 1 as the source) using the AUTH parameter stored in the IKE_AUTH Request message, or the confirmation of the authentication method by checking for the correctness of the IKE_SA_INIT message (the UE 1 as the source), or the confirmation of the key), the T-PGW 5b sends the UE 1 an IKE_AUTH Response message including the AUTH parameter created in step S16102 and the like (step S16200 in FIG. 23B). Then, the T-PGW 5b performs BU/BA exchange with the UE 1 (step S16201 in FIG. 23B). If the T-PGW 5b fails in the authentication of the UE, the BS processing is ended.

When the T-PGW 5b is notified of the AUTH parameter from the UE 1 through the IKE_AUTH Request message immediately after the exchange of IKE_SA_INIT messages in the third and fourth sequences according to the fourth embodiment of the present invention (e.g., step S17102 in FIG. 24 or step S18102 in FIG. 25), the T-PGW 5b checks whether the AUTH parameter is stored in the IKE_AUTH Request message sent from the UE 1 (step S20013 in FIG. 27).

If the AUTH parameter is stored in the IKE_AUTH Request message, the T-PGW 5b sends the AAA server 8a an Authentication-Request message with the Reuse key and UE_BS_Identity sent from the UE 1 stored therein (step S20100 in FIG. 27).

Then, the T-PGW 5b receives, from the AAA server 8a, an Authentication-Response message with the MSK and T-PGW_BS_Identity stored therein (step S20101 in FIG. 27).

The T-PGW 5b creates an AUTH parameter using the MSK received (step S20102 in FIG. 27).

Then, the T-PGW 5b authenticates the UE 1 (step S20103 in FIG. 27). When authenticating the UE 1, the T-PGW 5b may authenticate the UE 1 using the MSK received in step S20101 or the AUTH parameter generated in step S20102 (for example, a comparison between the AUTH parameter sent from the UE 1 and the AUTH parameter generated by the T-PGW 5b). If the T-PGW 5b does not use the AUTH parameter generated by the T-PGW 5b when authenticating the UE 1, the order of step S20102 and step S20103 may be replaced with each other.

When the T-PGW 5b completes the authentication of the UE 1, the T-PGW 5b sends the UE 1 an IKE_AUTH Response message with the generated AUTH parameter and the T-PGW_BS_Identity stored therein (step S20110 in FIG. 27).

Then, the T-PGW 5b performs BU/BA exchange with the UE 1 (step S20111 in FIG. 27).

Even when the UE 1 is allocated a PGW 5 (corresponding to the I-PGW 5a) different from the already established PGW 5 (corresponding to T-PGW 5b), the processing is performed based on the fourth embodiment of the present invention so that the switching connection to the T-PGW 5b can be completed in a short time compared with the PDN GW reallocation procedure of the conventional technique. In other words, since the UE 1 and the T-PGW 5b reuse the MSK created upon establishment of SA between the UE 1 and the I-PGW 5a to establish SA between the UE 1 and the T-PGW 5b, the UE 1 can establish the connection with a desired PGW 5 (corresponding to the T-PGW 5b) in a short time.

The MSK used in the fourth embodiment of the present invention may be the same as MSK defined in a RFC by the IETF (Internet Engineering Task Force) as the organization for standardization of Internet technologies, or may be provided separately.

Further, as shown in FIG. 21, even when the AAA server 8a notifies the T-PGW 5b of information such as the MSK in advance, it is desired that the UE 1 should send the T-PGW 5b an IKE_AUTH_Request message with the Reuse Indicator and the UE_BS_Identity stored therein. In this case, even if the T-PGW 5b does not recognize reuse of key data (MSK) (omission of full authentication) due to a delay or loss of the notification of the BS_Identity from the AAA server 8a to the T-PGW 5b (step S14011 in FIG. 21), the MSK can be reused over the T-PGW 5b, and this makes the reduction in the time for switching the connection more reliable.

Further, when the AAA server 8a notifies the T-PGW 5b in advance of information such as the MSK or the like in the second sequence shown in FIG. 21, if the system guarantees that there is no delay or loss of the notification of the BS_Identity from the AAA server 8a to the T-PGW 5b (step S14011 in FIG. 21), the User Identity or the address of the UE 1 can be used instead of the Reuse Indicator to eliminate the need for the UE 1 to generate the Reuse Indicator in step S15011 of FIG. 22 and store it in the IKE_AUTH_Request message in step S15012.

Furthermore, if the AAA server 8a can confirm that the connection request is intended to switch to the T-PGW 5b by a method such as to compare the APN (Access Point Name) or the like included in the connection request from the UE 1 with that notified through the previous connection request (via the I-PGW 5a), since the UE_BS_Identity is no longer necessary, the notification to the UE 1 in step S15007 of FIG. 22 will not be made. At this time, the UE 1 has only to perform standard BS processing on the T-PGW 5b (not shown in FIG. 22), so that the reuse of the MSK can be determined on the network side, thereby completing the switching connection to the T-PGW 5b in a short time.

Like in the aforementioned first embodiment, various combinations of UE_BS_Identity and T-PGW_BS_Identity used in the fourth embodiment of the present invention are also possible. For example, in the fourth embodiment of the present invention, the UE_BS_Identity and T-PGW_BS_Identity corresponding to this UE_BS_Identity may be used to check the UE_BS_Identity against the T-PGW_BS_Identity, or either of the BS_Identity identifiers may be used, or no BS_Identity may be used. Further, for example, in the fourth embodiment of the present invention, information used as the UE_BS_Identity or T-PGW_BS_Identity can also be (but not limited to) a value (code) recognizable by the UE 1 and the PGW 5, such as a hash value generated based on a value shared between the UE 1 and the PGW 5, a value generated at random, or the address of the I-PGW 5a. Further, in the fourth embodiment of the present invention, the UE_BS_Identity or the T-PGW_BS_Identity may also be generated by the PGW 5, the AAA server 8a, or any other communication device.

Each functional block used in the explanations of each embodiment of the present embodiment, described above, can be realized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the IC (Integrated Circuit), a system LSI, a super LSI, or an ultra LSI.

The method of forming the integrated circuit is not limited to LSI and can be actualized by a dedicated circuit or a general-purpose processor. An FPGA (Field Programmable Gate Array) that can be programmed after LSI manufacturing or a reconfigurable processor of which connections and settings of the circuit cells within the LSI can be reconfigured can be used.

Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

The gateway connection method, the gateway connection control system, and the mobile terminal of the present invention can unify PGWs 5 managing CoAs of a mobile terminal using multiple CoAs securely and quickly. As a result, the mobile terminal has the advantage of being able to enjoy the benefits of communication using multiple CoAs securely and quickly, and is applicable to a technique for accessing, by a mobile terminal having multiple communication interfaces, predetermined gateways through different access networks using these multiple communication interfaces.

1-27. (canceled)

28. A gateway connection method for connecting a mobile terminal to a desired gateway in a communication system including the mobile terminal attachable to a plurality of access networks through a plurality of communication interfaces, and a plurality of gateways accommodating the mobile terminal to perform mobility management, the method comprising:
a step of detecting by the mobile terminal, that an address of a second gateway is acquired from a DNS server when attaching to a different access network after connecting with a first gateway via a home link;
a step of starting by the mobile terminal, connection processing to the second gateway in response to the result of the detection step, and exchanging with the second gateway, key information created by performing mutual authentication with an authentication server;
a step of notifying by the second gateway, the mobile terminal of an address of the first gateway after completion of exchange of the key information;
a step of starting by the mobile terminal, connection processing to the first gateway;
a step of acquiring by the first gateway, from the authentication server, the key information created by the mutual authentication; and
a step of reusing by the mobile terminal, the key information created by the mutual authentication to connect to the first gateway.

29. (canceled)

30. The gateway connection method according to claim 28, wherein in the step of reusing by the mobile terminal, the key information created by the mutual authentication to connect to the first gateway, connection confirmation is made between the mobile terminal and the first gateway using the key information.

31. The gateway connection method according to claim 28, wherein in the step of notifying by the second gateway, the mobile terminal of the address of the first gateway, the mobile terminal can determine, through a message from the second gateway, that reuse of the key information created by the mutual authentication upon connection to the first gateway is possible.

32. (canceled)

33. The gateway connection method according to claim 28, wherein in the step of starting by the mobile terminal, connection processing to the first gateway, reuse of the key information is requested.

34. The gateway connection method according to claim 28, wherein in the step of acquiring by the first gateway, the key information from the authentication server, the authentication server notifies the first gateway of the key information in response to a request from the first gateway.

35. The gateway connection method according to claim 28, wherein in the step of acquiring by the first gateway, the key information from the authentication server, the authentication server notifies the first gateway of the key information after succeeding in authentication of the mobile terminal by the mutual authentication.

36. (canceled)

37. (canceled)

38. A gateway connection control system including a mobile terminal attachable to a plurality of access networks through a plurality of communication interfaces, and a plurality of gateways accommodating the mobile terminal to perform mobility management, wherein
the mobile terminal detects that an address of a second gateway is acquired from a DNS server when attaching to a different access network after connecting with a first gateway via a home link,
the mobile terminal starts connection processing to the second gateway in response to the result of the detection step and exchanges, with the second gateway, key information created by performing mutual authentication with authentication server,
the second gateway notifies the mobile terminal of an address of the first gateway after completion of exchange of the key information,
the mobile terminal starts connection processing to the first gateway,
the first gateway acquires, from the authentication server, the key information created by the mutual authentication, and
the mobile terminal reuses the key information created by the mutual authentication to connect to the first gateway.

39. (canceled)

40. The gateway connection control system according to claim 38, wherein when the mobile terminal reuses the key information created by the mutual authentication to connect to the first gateway, connection confirmation is made between the mobile terminal and the first gateway using the key information.

41. The gateway connection control system according to claim 38, wherein when the second gateway notifies the mobile terminal of the address of the first gateway, the mobile terminal can determine, through a message from the second gateway, that reuse of the key information created by the mutual authentication upon connection to the first gateway is possible.

42. (canceled)

43. The gateway connection control system according to claim 38, wherein when the mobile terminal starts connection processing to the first gateway, reuse of the key information is requested.

44. The gateway connection control system according to claim 38, wherein when the first gateway acquires the key information from the authentication server, the authentication server notifies the first gateway of the key information in response to a request from the first gateway.

45. The gateway connection control system according to claim 38, wherein when the first gateway acquires the key information from the authentication server, the authentication server notifies of the first gateway of the key information after succeeding in authentication of the mobile terminal by the mutual authentication.

46. (canceled)

47. (canceled)

48. A mobile terminal attachable to a plurality of access networks through a plurality of communication interfaces and capable of connecting to a desired gateway among a plurality of gateways when connecting a communication system including the plurality of gateways accommodating the mobile terminal to perform mobility management, the mobile terminal comprising:
means for detecting that an address of a second gateway is acquired from a DNS server when attaching to a different access network after connecting with a first gateway via a home link;
means for starting connection processing to the second gateway and exchanging, with the second gateway, key information created by performing mutual authentication with authentication server;
means for receiving an address of the first gateway from the second gateway after completion of exchange of the key information to start connection processing to the first gateway; and
means for reusing the key information created by the mutual authentication to connect to the first gateway.

49. (canceled)

50. The mobile terminal according to claim 48, wherein when connecting to the first gateway by reusing the key information created by the mutual authentication, connection confirmation is made between the mobile terminal and the first gateway using the key information.

51. The mobile terminal according to claim 48, wherein when the second gateway notifies the mobile terminal of the address of the first gateway, the mobile terminal can determine, through a message from the second gateway, that reuse of the key information created by the mutual authentication upon connection to the first gateway is possible.

52. The mobile terminal according to claim 48, wherein when starting connection processing to the first gateway, the mobile terminal exchanges messages with the first gateway so that it can determined that reuse of the key information is possible.

53. The mobile terminal according to claim 48, wherein when starting connection processing to the first gateway, reuse of the key information is requested.

54. The mobile terminal according to claim 48, wherein
when the address of the first gateway is notified from the second gateway, first code is notified to the mobile terminal, and when connection processing to the first gateway is performed, second code is notified from the first gateway to the mobile terminal, and
the first code received from the second gateway is compared with the second code received from the first gateway, and if both match, the mobile terminal performs address registration processing to the first gateway.

55. The mobile terminal according to claim 48, wherein
when connection processing to the first gateway is performed, predetermined code is notified from the first gateway to the mobile terminal, and
if the received predetermined code matches a predetermined value, the mobile terminal performs address registration processing to the first gateway.
